(19) United States
(12) Patent Application Publication
(10) Pub. No.: US 2007/0150375 A1
(43) Pub. Date: Jun. 28, 2007

(54) METHOD AND APPARATUS FOR EFFICIENT MEAL DELIVERY

(76) Inventor: Ping Yang, Chino Hills, CA (US)

Correspondence Address: SHELDON MAK ROSE & ANDERSON PC, 225 SOUTH LAKE AVENUE, 9TH FLOOR, PASADENA, CA, 91101, US

(21) Appl. No.: 11/682,829

(22) Filed: Mar. 6, 2007

Related U.S. Application Data
(63) Continuation-in-part of application No. 10/798,965, filed on Mar. 10, 2004.
Application No. 10/798,965 is a continuation-in-part of application No. 10/681,685, filed on Oct. 8, 2003.
Application No. 10/798,965 is a continuation-in-part of application No. 10/055,144, filed on Jan. 22, 2002, now abandoned.
Application No. 10/798,965 is a continuation-in-part of application No. 09/733,873, filed on Dec. 8, 2000, now Pat. No. 7,110,958.
(60) Provisional application No. 60/453,053, filed on Mar. 8, 2003.
(60) Provisional application No. 60/453,664, filed on Mar. 11, 2003.
(60) Provisional application No. 60/458,156, filed on Mar. 27, 2003.
(60) Provisional application No. 60/465,314, filed on Apr. 25, 2003.
(60) Provisional application No. 60/472,310, filed on May 21, 2003.
(60) Provisional application No. 60/483,783, filed on Jun. 28, 2003.
(60) Provisional application No. 60/263,530, filed on Jan. 22, 2001.
(60) Provisional application No. 60/301,761, filed on Jun. 28, 2001.
(60) Provisional application No. 60/879,774, filed on Jan. 10, 2007.
(60) Provisional application No. 60/779,539, filed on Mar. 6, 2006.
(60) Provisional application No. 60/782,763, filed on Mar. 16, 2006.
(60) Provisional application No. 60/789,173, filed on Apr. 4, 2006.
(60) Provisional application No. 60/794,964, filed on Apr. 25, 2006.
(60) Provisional application No. 60/799,105, filed on May 10, 2006.
(60) Provisional application No. 60/808,811, filed on May 26, 2006.
(60) Provisional application No. 60/810,531, filed on Jun. 1, 2006.
(60) Provisional application No. 60/811,622, filed on Jun. 7, 2006.
(60) Provisional application No. 60/833,325, filed on Jul. 26, 2006.
(60) Provisional application No. 60/834,768, filed on Jul. 31, 2006.
(60) Provisional application No. 60/852,883, filed on Oct. 19, 2006.

(51) Int. Cl. G06Q 30/00

(52) U.S. Cl. 705/26

(57) ABSTRACT

A method and system for accepting order and scheduling delivery of meals to buyers. A Mobile Pickup Station (MPS) server is placed within a computer network and lists a number of participating restaurants on its web site. A buyer logs onto the MPS web site to order food from a participating restaurant. The server passes the order to the participating restaurant for production. An optimal pickup location is selected and the order is picked up from the participating restaurant and is delivered to the pickup location for pickup. A temperature-controlled truck enclosing the buyer order is dispatched to the pickup location. The truck is then stationed at the pickup location for a determined period of time waiting for buyers to pick up their orders.

### CROSS-REFERENCE TO RELATED APPLICATIONS

This application is a continuation-in-part of U.S. patent application Ser. No. 10/798,965 filed Mar. 10, 2004, which is a continuation-in-part of U.S. patent application Ser. No. 10/681,685 filed Oct. 8, 2003, which is a continuation-in-part of U.S. patent application Ser. No. 10/055,144 filed Jan. 22, 2002 (now abandoned), which is a continuation-in-part of U.S. patent application Ser. No. 09/733,873 filed Dec. 8, 2000. The application Ser. No. 10/055,144 claims the benefit of U.S. Provisional Patent Application No. 60/263,530 filed on Jan. 22, 2001, and U.S. Provisional Patent Application 60/301,761 filed Jun. 28, 2001. The application Ser. No. 10/681,685 claims the benefit of U.S. Provisional Patent Application No. 60/453,053 filed Mar. 8, 2003, U.S. Provisional Application No. 60/453,664 filed Mar. 11, 2003, U.S. Provisional Application No. 60/458,156 filed Mar. 27, 2003, U.S. Provisional Application No. 60/465,314 filed Apr. 25, 2003, U.S. Provisional Application No. 60/472,310 filed May 21, 2003 and U.S. Provisional Application No. 60/483,783 filed Jun. 28, 2003. The present Application claims the benefit of U.S. Provisional Patent Application No. 60/779,539 filed Mar. 6, 2006, U.S. Provisional Patent Application 60/782,763 filed Mar. 16, 2006, U.S. Provisional Patent Application No. 60/789,173 filed Apr. 4, 2006, U.S. Provisional Application No. 60/794,964 filed Apr. 25, 2006, U.S. Provisional Application No. 60/799,105 filed May 10, 2006, U.S. Provisional Application No. 60/808,811 filed May 26, 2006, U.S. Provisional Application No. 60/810,531 filed Jun. 1, 2006, U.S. Provisional Application No. 60/811,622 filed Jun. 7, 2006, U.S. Provisional Application No. 60/833,325 filed Jul. 26, 2006, U.S. Provisional Application No. 60/834,768 filed Jul. 31, 2006, U.S. Provisional Application No. 60/852,883 filed Oct. 19, 2006 and U.S. Provisional Application No. 60/879,774 filed Jan. 10, 2007. The entire disclosure of each of the foregoing patent applications is incorporated by reference as if set forth in full herein. Any disclaimer that may have occurred during the prosecution of the above-referenced application(s) is hereby expressly rescinded.

### BACKGROUND OF THE INVENTION

This invention relates generally to the field of delivering of merchandise and more specifically to the delivery of meal orders (e.g. breakfasts, lunches, or dinners).

More and more consumers find that they do not have the time to cook, but desire enjoying the relaxation of eating at home. Frequently, the necessity of bringing food home for family members to eat prompts consumers to purchase food from food providers. However, it is troublesome for a consumer to go to food providers to pick up the food ordered. As a result, meal services that deliver purchased foods to consumers' physical addresses have started to grow.

The meal delivery service is big business. There are two types of Meal Delivery Services (MDS) currently in the market: A) Non-Producing Meal Delivery service (NPMD). A NPMD does not produce its own meals, but delivers the meals produced by an affiliated food service provider to a buyer. Example: DiningIn.com (www.Diningin.com), Restaurant-On-The-Run (www.rotr.com), or LAbite.com (www.LAbite.com). B) Producing Meal Delivery service (PMD). In this type of delivery service, the deliverer produces its own food and delivers the food it produces to a buyer. Example: Domino Pizza.

The operation of a conventional Non-Producing Meal Delivery entity (NPMD) may be described as follows: a NPMD entity operates a web site. The web site contains a number of icons. Each icon represents a restaurant that is affiliated with the entity. A buyer goes to the entity's web site and selects a desired restaurant by clicking on the restaurant's icon. The buyer then receives a menu of the restaurant and can order food items from the restaurant by using the menu. The NPMD entity then passes the order to the selected restaurant for production. The NPMD entity then sends a driver to the restaurant to pick up the order. The driver then delivers the order to the buyer's designated address, e.g. home or office address. The NPMD that receives and delivers the order, charges the restaurant a commission. The commission is typically 30% of the sales amount generated and delivered by the NPMD entity.

Problems exist with the conventional Non-Producing Meal Delivery model. For example, in the model, orders are delivered to buyers door-to-door. The costs of delivery are high. Although a NPMD can plan a delivery route so that multiple orders can be delivered in one delivery route to save delivery costs, the strategy does not always work because there are only limited numbers of locations the entity can deliver in the delivery route. This is because if the NPMD entity delivers to too many locations in one delivery route, the delivery route becomes very long and the buyers at the end of the route may receive their meal orders late. Since people usually eat their meals within a certain period of time, the buyers at the end of the delivery route may be impatient when the food is delivered late. Because of the high delivery costs, a NPMD has to charge a buyer a delivery fee (typically $6.00) to survive. In addition, a typical NPMD entity asks a buyer to tip its deliverer (e.g. driver). The tip (typically 10% to 15% of sales) is to compensate for the low wages, usually minimum wage, a NPMD pays to its driver.

In addition, a NPMD entity finds it necessary to set up a minimum order requirement. Under the minimum order requirement, an order from a buyer is accepted and delivered only when the total price of the order is equal to or above the minimum order amount. A typical minimum order in the conventional Non-Producing Meal Delivery industry is $15.00 to $20.00 which may be about 2-3 times the average list price of the items sold on the menu.

The delivery fee and tips a buyer has to pay makes the effective cost of a delivered meal very high. For example, an order with listed price of $15.00 may cost a buyer $23.00, including tip and delivery fee, when the buyer receives the order. The minimum order requirement limits the entity's customer base. For example, a single person who only wants to order a $6.00 meal for him or herself is excluded from this service if the minimum order were $20.00.

There is a need for a NPMD entity to increase its customer base by eliminating minimum order requirements. Moreover, there is a need for a consumer to receive a meal with low effective cost and convenient delivery.

The present invention provides an efficient and low cost delivery method for delivering meals and satisfies such a need.

In the present invention, a novel delivery method is disclosed. The delivery method may be used by a Non-Producing Meal Delivery entity or by a Producing Meal Delivery entity.

### SUMMARY OF THE PRESENT INVENTION

The present invention improves the conventional meal delivery process. In one embodiment, a buyer's meal order is delivered to a selected pickup location. The location of the selected pickup location is communicated to the buyer and the buyer may come to the pickup location to pick up the buyer's order.

In one embodiment of the present invention, an entity operates a web site. The web site contains a number of icons. Each icon represents a restaurant that is affiliated with the operating entity (termed the MPS entity). A buyer may log on to the entity's web site and may click on the icon of a desired restaurant to receive a menu of the restaurant. The buyer may order food items from the restaurant by clicking on items presented on the menu. A pick-up location from where the buyer may pick up the order is selected. The pick-up location may be selected by the buyer or by the MPS entity. The MPS entity passes the order to the selected restaurant for production. The MPS entity then sends a Mobile Pickup Station (a MPS, e.g. a truck) to the restaurant and other affiliated restaurants to pick up all buyer orders. After collecting all orders, the MPS may go back to a MPS warehouse for processing and distributing of buyer orders. The MPS entity aggregates orders with the same selected pick-up location. The MPS entity then loads these orders to a MPS. The MPS is dispatched to the pick-up location. The MPS stays at the pickup location for a pre-determined period of time waiting for buyers to pick up their orders.

The present methods include a method for scheduling and delivering a product, such as a meal or other food product, to a buyer in response to orders received from the buyer. The orders are transmitted to a seller for production of the product, and the product is then received from the seller and distributed by an entity, generally referred to herein as an MPS entity. The MPS entity determines a plurality of pickup locations in view of delivery area identifiers received from the buyers and uses such delivery area identifiers to select pickup locations for each of the buyer from among the plurality of pickup locations. The product is then loaded onto mobile pick up stations, which are dispatched to the pickup locations selected by the buyers such that the mobile pickup station containing the product ordered by a buyer is dispatched to the pickup location selected by that buyer. The mobile pick up station is then stationed at the pickup location for a predetermined period of time (the station time) during which the buyer can pick up the order from the mobile pick up station.

In one embodiment, the station time can be determined by selecting a period of time, determining a number of potential buyers passing by the pickup location during the selected period of time, and then determining whether the cost of stationing the mobile pick up station at the pickup location during the period of time exceeds the amount of profit that can be made by providing products to buyers during the period of time. The period of time is excluded from the station time at the pickup location if a cost-benefit analysis indicates that the cost of stationing a mobile pick up station during the period of time exceeds the amount of profit that can be made by providing products to buyers during that period of time. Such an analysis can thereby be used to determine the end of the station time. The number of buyers projected to pass by a pickup location during a period of time, which should relate to the number of orders that will be picked up, can be estimated by calculating a Customer Pass-by Distribution.

In another embodiment, the station time can be determined by determining a number of potential buyers passing by the pickup location during the selected period of time and determining the carrying capacity of the mobile pick up station to be used at the pickup location. If the number of customers that are projected to arrive at the pickup location to pick up orders during the period of time is less than the carrying capacity of the mobile pick up station, then the selected period of time is included in the station time, thereby allowing the end of the station time to be determined. Alternatively, the station time can be determined by using the number of potential buyers passing by a pickup location over a period of time to determine a projected number of orders for products that will be picked up during the period of time, and then determining whether the cost of stationing the mobile pick up station at the pickup location during the period of time exceeds the amount of profit that can be made by providing the orders to buyers during the period of time.

The foregoing methods can further comprise receiving a delivery date that the buyer wants to obtain the product, receiving a specification of the buyer's preferred product (i.e., a food product) from the buyer, using the delivery date and the specification to select a product for the buyer for the date the buyer wants to obtain the product, and then delivering the product to the buyer on the delivery date. The product is preferably delivered such that the delivery personnel of the delivering entity do not receive a tip, i.e. such that compensation to such delivery personnel for the delivery of the product is only from the seller of the product, in order to minimize customer costs, even if the order contains only one unit of the lowest-priced item sold by through the delivering entity.

In order to facilitate the delivery of products according to the present methods, a shipping label that includes information identifying the buyer, such as vehicle license plate information, can be attached to an order, and the order can be loaded onto a cell in a mobile pick up station. The cell address can then be relayed to user of the mobile pickup station and can be retrieved by the user so that he or she can identify the order in the mobile pickup station, retrieve the order, and deliver it to the appropriate customer. In this embodiment, when the food product is a perishable food product, a piece of liquid absorbing material is preferably placed on top of the food in the container, the material preferably being food grade and pre-soaked with liquid, and the container is then sealed with the material inside the container.

In a further aspect of the present methods, the pick up location for a buyer to use can be selected by determining parking availability at each of a group of pickup locations, determining a volume of the packaging of the order and/or the number of meals comprising the order, and determining a pickup location from the group of pickup locations based on the parking availability of a pickup location and the package volume of and/or the number of meals comprising the buyer's order. Alternatively, a pick up location can be selected by using a buyer's home address to determine the highways around the buyer's home, identifying exits on such highways, determining a plurality of routes that connect the exits with the buyer's home address, selecting the shortest route from the plurality of routes, identifying the exit with the shortest route, identifying the area between the exit and the buyer's home address, and then selecting a pickup location within the area.

In a further aspect of the present methods, a buyer can be identified as a member of a group which is itself identified by a group code, and the step of selecting the pick up location can comprise identifying the buyer's group code, identifying other group members having the same group code, changing the other group members' pickup locations to the buyer's pickup location; delivering the other group members' orders to the buyer's pickup location; and authorizing the buyer to pick up the other group members' orders. Selecting pickup locations can further comprise grouping pickup locations by area, i.e. by proximity to each other or to a reference point, selecting a first pick up location in the group for a buyer to use, and opening a second pickup location in the group for a second buyer to use when the carrying capacity of the first pickup location is full.

In yet a further aspect of the present methods, the methods can comprise selecting a plurality of affiliated food providers, determining one or more criteria for placing the food providers into groups, grouping food providers according to the criteria, receiving an order from a buyer, determining within the plurality of food providers those food providers having the ability to produce the order, and passing the order to a food provider in the group. The order would only be passed on to a food provider outside the group to fulfill if the food provider in the group cannot produce the order.

It will be understood by those of skill in the art that a number of the steps of the methods disclosed herein, such as those requiring the analysis of information, can be accomplished through the use of an appropriately programmed computer. Likewise, those steps involving communication can be accomplished though any number of communication methods or technologies, through the use of the internet.

### BRIEF DESCRIPTION OF THE DRAWINGS

FIG. 1 and FIG. 2 are flowcharts showing the process from user's commuting route selection to user pickup at a mobile pickup station;

FIG. 3 is a flowchart showing an exemplary process to select available pickup points;

FIG. 4 is a flowchart showing third-party buying coupled with a mobile pickup station delivery service;

FIG. 5 shows selection of mobile pickup point with two users;

FIG. 6 shows selection of mobile pickup point with a new user joining in;

FIG. 7 shows the searching method by using the user's commuting route and a channel;

FIG. 8 shows the user's input of the occurrence rate for a desired product;

FIG. 9 shows a mobile pickup station with a panel in an upright position.

FIG. 10 shows the overlapping of user channels and a server's selection of available pickup points.

FIG. 11 shows a first model of the arrangement of shipping third party products to a mobile pickup station warehouse.

FIG. 12 shows a second model of the arrangement of shipping third party products to a mobile pickup station warehouse;

FIG. 13 shows a third model of the arrangement of shipping third party products to a mobile pickup station warehouse;

FIG. 14 shows a sample meal plan of the MPS entity and menus of two conventional Non-Producing Meal Delivery entities.

FIG. 15 is a flowchart presentation of the searching method by using user commuting route and a channel;

FIG. 16 is a network diagram depicting an embodiment of an MPS using the Internet as a communication medium;

FIG. 17 is a diagram of computer architecture of a general purpose computer capable of hosting a mobile pickup station server;

FIGS. 18, 19, 20 are flowcharts of locker station operations in accordance with exemplary embodiments of the present invention;

FIG. 21a and FIG. 21b are an elevation and side view showing the construction of a locker station in accordance with an exemplary embodiment of the present invention;

FIG. 22 shows an MPS shipping sticker with an order ID and bar code in accordance with an exemplary embodiment of the present invention;

FIG. 23 is a diagram presentation of multiple territories with covered routes in accordance with an exemplary embodiment of the present invention;

FIG. 24 is a diagram presentation of building a channel with two distance-defined channel width methods and one time-defined channel width method; and

FIG. 25 is a diagram presentation of building a channel using an optional time-defined channel width method.

FIG. 26 is a diagram showing pick-up point selection.

FIG. 27 is a diagram showing boundaries of selection of available pick up points.

FIG. 28 is a diagram showing an example of Customer Pass-by Distribution or Customer Arrival Distribution.

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Definitions

As used herein, the following terms and variations thereof have the meanings given below, unless a different meaning is clearly intended by the context in which such term is used.

“Brand-Name Food Provider” or “BFP” is a third party food provider not affiliated with a Mobile Pickup Station, MPS entity, or other entity which is involved in procuring and/or delivering food in the present methods.

“Dispatch Time” is the time a MPS station or other vehicle for carrying dishes in the present methods is dispatched from its warehouse or other point at which it may be stationed and sent to a pickup point.

“Dish” is a food preparation comprising one or more food ingredients.

“Flavor” is the sensory impression of a food determined by the senses of taste and smell of an individual. Flavors include salty, sweet, spicy, flavors associated with a preparation method (e.g., grilled), and flavors associated with a particular ingredient (e.g., cherry or orange).

“Meal” means one or more dishes provided together to a buyer. In a preferred embodiment, a meal includes a plurality of dishes. Meals also preferably include different types of dishes, e.g. dishes comprising primarily fruits or vegetables, dishes comprising primarily meat, fish, or other non-vegetable protein source, and/or dishes comprising bread, rice, potatoes, or other carbohydrate sources.

“Order” is a request for an item, such as a meal or dish, which is placed in connection with the purchase of the item. An order can be placed either in advance of or concurrently with such purchase, and normally comprises a binding agreement to purchase the item.

“Order Due Time” is the time by which a BFP will have completed producing all orders for which it is responsible in the present methods and have them ready for pickup.

“Delivery date” is a calendar day and, unless the context herein indicates otherwise, a time during the calendar day when an item is to be delivered for pick up by a buyer. The time can be either a specified point in time or can be a specified period of time, e.g. between 5:00 P.M. and 7:00 P.M.

“Reputation” is a rating or ranking of an individual or entity in comparison to other individuals or entities with respect to a predetermined criterion or set of criteria. The reputation of a food provider can be based, for example, on a rating given by a third party with respect to the quality of the food provided by the food provider. Alternatively, a food provider's reputation can be based on information gathered by a provider of the present food procurement service, such as a rating of the food provider with respect to timeliness, food quality, or other criteria with which the service provider has had experience with the food provider, or on information gathered by a third party, such as from surveys of customers of the food provider and/or through inspections by the third party.

“Value,” with respect to the value of food provided by a food provider, means the cost (to a buyer) of a dish or meal offered by the food provider at a restaurant or other outlet at which the food provider provides food to buyers, and not offered through the present meal delivery method.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### DESCRIPTION

Referring to the drawings where like numerals of reference designate like elements throughout, it will be noted that the present invention is referred to herein as a Mobile Pickup Station (MPS) delivery system. A MPS delivery system uses pickup stations in the form of vehicles, lockers or moveable kiosks used in conjunction with the Internet to provide maximum convenience for a buyer to pick up products. A mobile pickup station may be stationed along a buyer's travel route or frequent commuting route so that a buyer can conveniently pick up products at these stations when traveling or traveling via the buyer's usual commute route without spending extra time traveling to a seller's store to pick up products.

Most people commute to work via the same commuting route every day. Others, while not working, travel to the same place repeatedly. Even the time people start and end their commuting and the time spent on commuting is about the same day after day. In one embodiment, the mobile pickup station system arranges to ship products a buyer ordered to a location that is close to the buyer's daily commuting route. Under such an arrangement, a buyer can pick up the products while conducting the buyer's daily commuting without spending extra time to travel to a seller's store for pick up and therefore making it convenient for the buyer to receive products. This pickup location will be referred to as the mobile pickup point (or mobile pickup location).

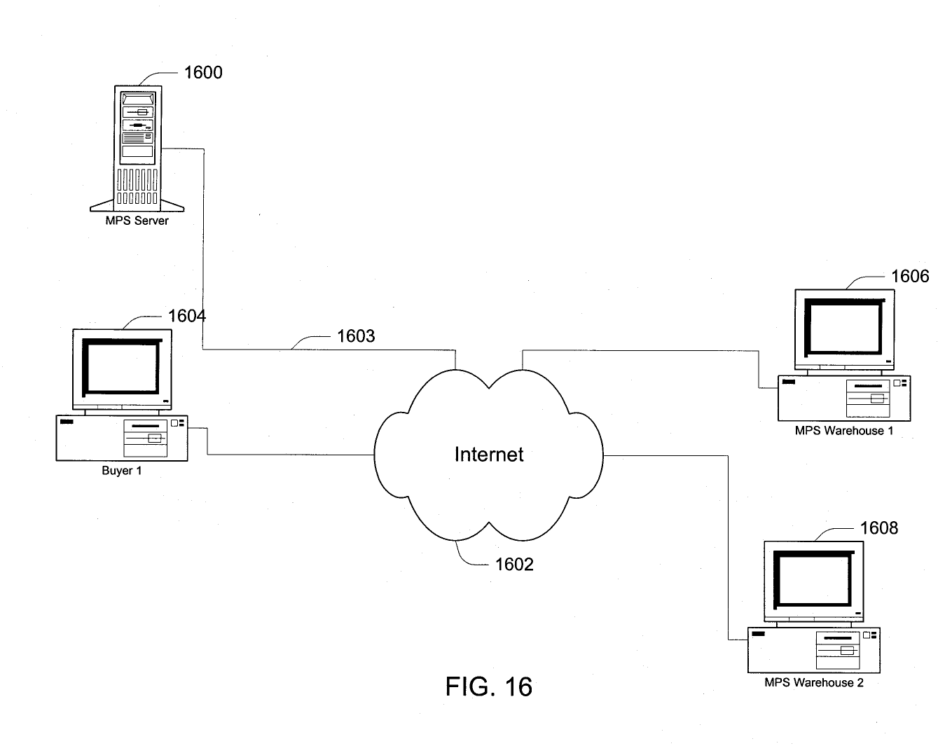

FIG. 16 is a network diagram showing an embodiment of an MPS server using the Internet. A MPS server 1600 is operatively coupled to the Internet 1602 via a communications link 1603 adapted for communications using the Transmission Control Protocol/Internet Protocol (TCP/IP) suite of networking protocols such as Hyper Text Transfer Protocol (HTTP) for hypertext document transfer and Simple Mail Transfer Protocol (SMTP) for the transfer of electronic (email) messages.

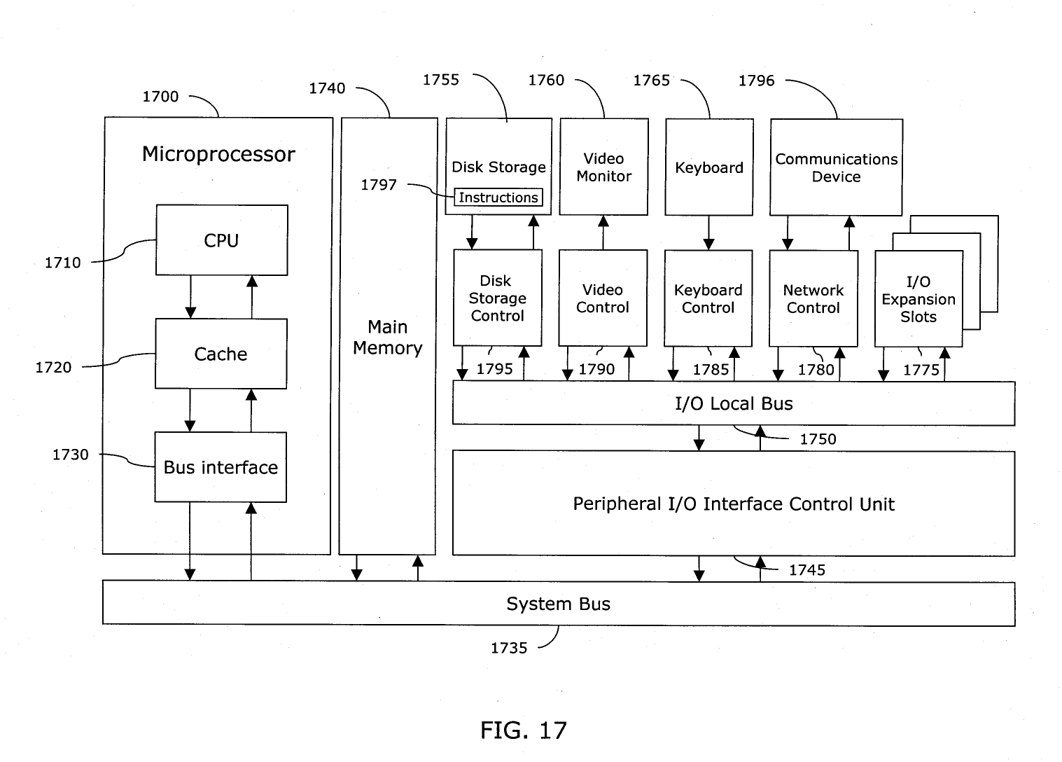

FIG. 17 is a hardware architecture diagram of a general purpose computer suitable for use as a MPS server host. Microprocessor 1700, comprised of a Central Processing Unit (CPU) 1710, memory cache 1720, and bus interface 1730, is operatively coupled via system bus 1735 to main memory 1740 and I/O control unit 1745. The I/O interface control unit is operatively coupled via I/O local bus 1750 to disk storage controller 1795, video controller 1790, keyboard controller 1785, and communications device 1780. The communications device is adapted to allow software objects hosted by the general purpose computer to communicate via a network with other software objects. The disk storage controller is operatively coupled to disk storage device 1755. The video controller is operatively coupled to video monitor 1760. The keyboard controller is operatively coupled to keyboard 1765. The network controller is operatively coupled to communications device 1796. The communications device provides a communications link adapted for communications over the Internet.

Computer program instructions 1797 implementing a MPS server are stored on the disk storage device until the microprocessor retrieves the computer program instructions and stores them in the main memory. The microprocessor then executes the computer program instructions stored in the main memory to implement a MPS server.

Referring again to FIG. 16, a buyer uses a computer 1604 running an Internet browser to access the MPS server via the Internet. The buyer's computer is operatively coupled to the Internet via a communications link adapted for communications using TCP/IP based networking protocols such as HTTP for hypertext document transfer. The MPS server provides scheduling services for at least one regionally distributed MPS warehouse. Each MPS warehouse communicates with the MPS via the Internet using computers as exemplified by MPS warehouse computers 1606 and 1608. Each MPS warehouse computer is operatively coupled to the Internet via a communications link adapted for communications using TCP/IP based networking protocols such as HTTP for hypertext document transfer and SMTP for the transfer of email messages.

In operation, a buyer may access the MPS server via the Internet and may use the delivery scheduling services of the MPS server to define a pickup point for use by the buyer. The MPS server may determine which MPS warehouse is used to dispatch a MPS to the defined pick up point with the buyer's products.

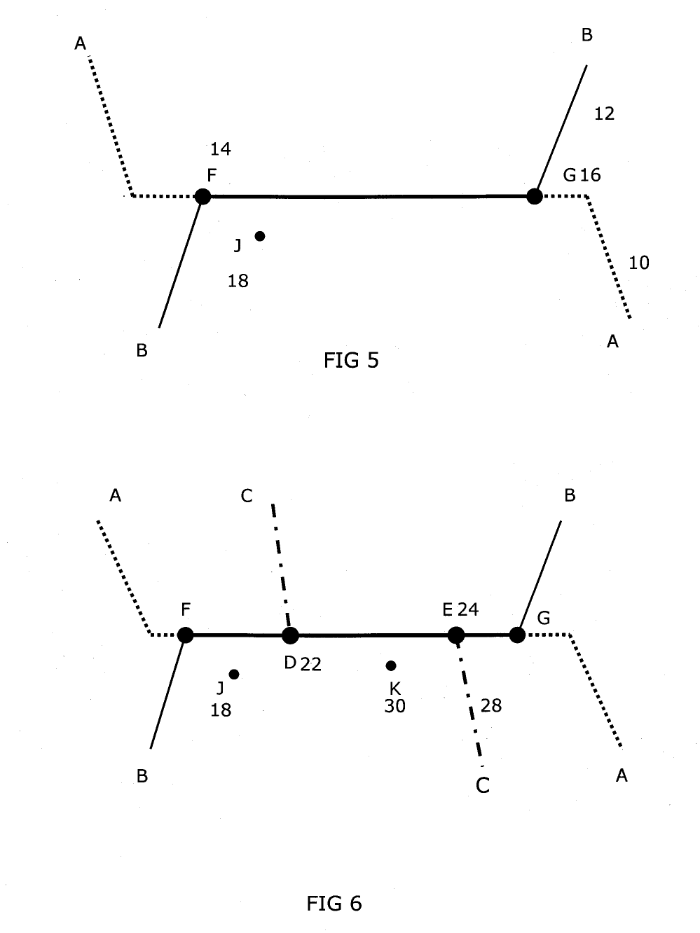

Referring now to FIG. 5, user A and user B use the Internet for shopping and ordering products at the server's website. User A and user B may identify their daily preferred commute route as route AA 10 and route BB 12, respectively. A MPS system may store this route information in its permanent memory if a user, e.g. user A, wants to set his/her route as the default route. The MPS system may identify route segment FG 14 as a commuting route segment that is commonly used by user A and user B. A MPS system may achieve maximum convenience for both user A and user B by sending a MPS station, which carries products ordered by user A and user B and stations at a place (e.g. point J 18) along a route segment (e.g. segment FG) that is common to the commuting routes of user A and user B and waits for user A and user B to pick up their ordered products. A MPS system includes all necessary entities such as seller, buyer (user), server, shipper, communications network, etc. to make the MPS service work.

A MPS is a vehicle, a locker or a moveable kiosk that has the capacity to carry different types of products. For instance, in addition to the ability to carry general nonperishable products, a MPS may be equipped with an electricity generator that may power a refrigerator and/or heater to preserve food products it carries within a temperature range that meets government requirements. In one MPS in accordance with an embodiment of the present invention, the MPS is connected to a power source, such as a solar power panel or a conventional electrical connection, to receive power to cool or heat the products it carries. In another MPS, in accordance with an embodiment of the present invention, one or more operators or attendants stay with the MPS station to operate it; for example to pass products to a buyer/user when the buyer/user comes to the station to pick up product ordered, to receive products from the user when he comes to the station to drop off products, or to prepare products to its ready condition and give it to user, etc.

In another embodiment of the present invention, a MPS may be equipped with a computer, a wireless transmitter and/or receiver so that it can communicate with a MPS server, get access to the Internet, get access to a MPS Intranet, or communicate with users or other parties.

In another MPS, in accordance with an embodiment of the present invention, the moveable kiosk has a plurality of lockers and the buyer or user is given an ID code and/or a password to open the locker to take the products he ordered. In this case, it would not be necessary to have an operator or attendant at the side of the kiosk to serve the buyer/user.

A pick up point can be anywhere as long as it can accommodate the parking of a mobile pick up station. An exemplary MPS mobile pickup point (e.g. point J) is a place that is close to the overlapped user route (e.g. route segment FG), is easy to get access to from the user route and is convenient for the user to park or to walk to. It may be the parking lot of a shopping mall, a gas station or a wide street with the capacity to park a MPS.

A mobile pickup point may also be a place where the MPS system can station a moveable kiosk, such as a subway station or at a street crossing, etc. A MPS station can be stationed at a pickup point for a pre-determined period of time (the “Station Time”) during which it waits for users to pick up their orders. The pre-determined station time is announced to users in advance. If the MPS station is a vehicle, an operator drives the station to the designated pickup point and stays there. If the MPS station is a moveable kiosk, a truck may drop the kiosk off at the designated pick up point and pick it up, and return the MPS to a MPS warehouse when the station's station time is up for reloading.

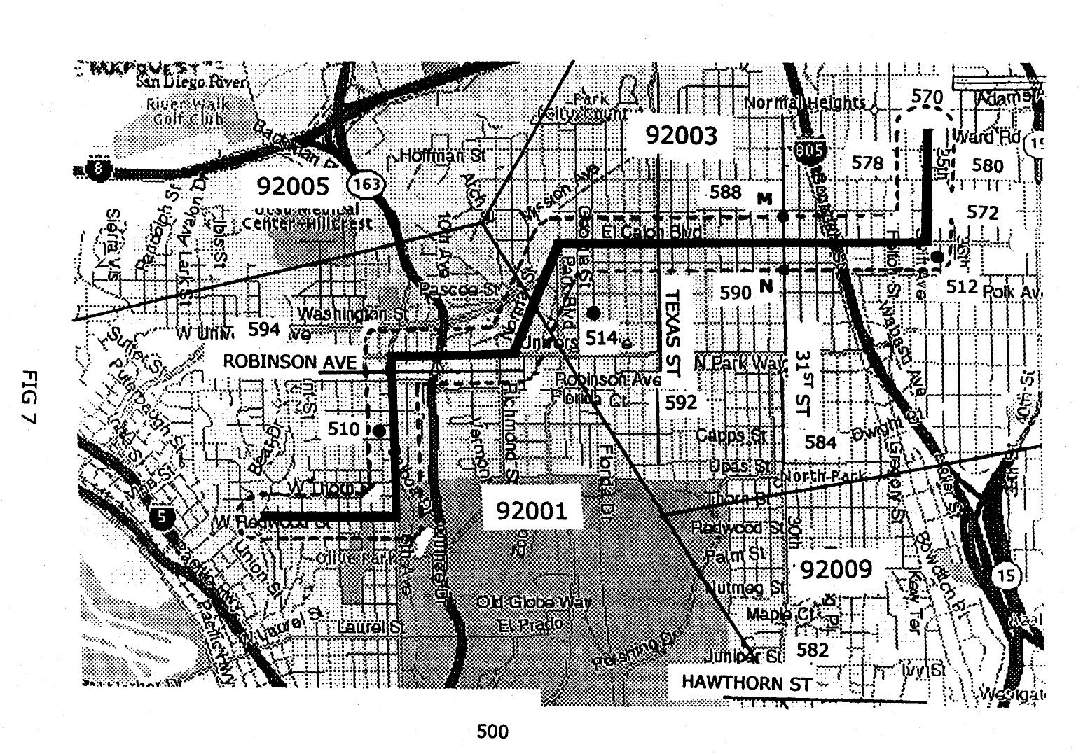

Referring to FIG. 6, assume user C joins a MPS system serving user A and user B. Further assume user C takes commuting route segment CC 28. Because pick up point J 18 is not within user C's commute route CC, the MPS system, in order to achieve maximum convenience to all users A, B, and C, must select a different pick up point to accommodate A, B, and C simultaneously. Point K 30, which is along route segment DE 22 and is common to all route segments AA, BB, and CC, can thus be selected as a pick up point to serve users A, B, and C.

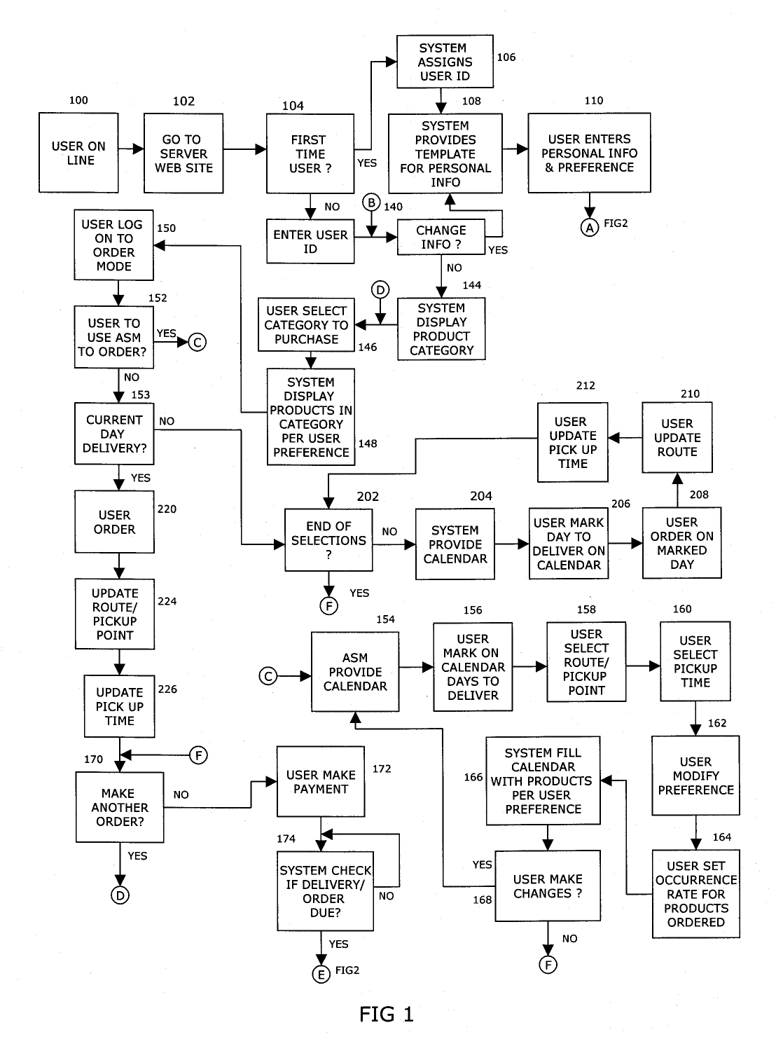

Referring to FIG. 1, a user/buyer uses at step 100 the Internet to access a Website using a Personal Computer (PC), a laptop, a Palm Pilot, a web-accessing cellular phone, or any other means of Internet access. The user/buyer is the person who purchases a product and/or MPS service from the Website. In the case where the Website is maintained by a transportation business entity providing MPS delivery services without selling any physical products, the buyer is the one who uses MPS services to have their products delivered.

The buyer goes to the Website hosted by a MPS server at step 102. An MPS server is a server maintained by a business entity that operates a MPS system. The business entity, which may be a retail or wholesale business entity with a fleet of MPS stations, sells products to a buyer. It may be a transportation business entity, which operates a fleet of MPSs, and delivers products for its customers or it may be another type of business entities that operate a fleet of MPSs. For easy referencing, the word “server” may also mean the business entity that operates a MPS system.

The server may ask if the buyer is a first time buyer at step 104. If the buyer is not a first time user, the buyer may enter user ID and/or password to log-on to the server website and goes to step 140. If the buyer is a first time buyer, the system may assign the buyer an ID and a password for his/her use at step 106. The server provides a template for the buyer to enter his/her personal information at step 108.

The buyer may enter personal information such as name, home or office addresses, phone number, age, credit card number, etc. at step 110. At this stage, the server may ask the buyer to enter the buyer's preference of purchases. As herein used, purchase means purchase of products and/or services. This preference is a tool the server may use later to screen products and display preferred products to the buyer. For example, if the server is maintained by a food manufacturing company, e.g., a food catering business, the preference questions listed may be: Does the buyer like hot and spicy food? Should the food be slightly hot, medium hot, or very hot? Does the buyer care for red meat in the food? The maximum calorie and fat count in the food? What is the preference of ethnic foods? Italian food, Japanese food or other food? Also, the preference questions may contain specific dollar limitations the buyer wants to spend on meals (or orders). The dollar limitations may be the maximum dollar amount the buyer wants to spend on a meal or maybe the budget of spending for a specific period of time such as a week, a month, etc. The preference information may be input by the buyer via a template provided by the server. Alternatively, the server may project it by using other personal information such as: buyer's last name (an indication of ethnic group the buyer belongs to), buyer's gender, buyer's address (to determine the area the buyer is living in), etc. The server may collect the buyer's order history and analyzes this information to project the buyer's purchasing preferences.

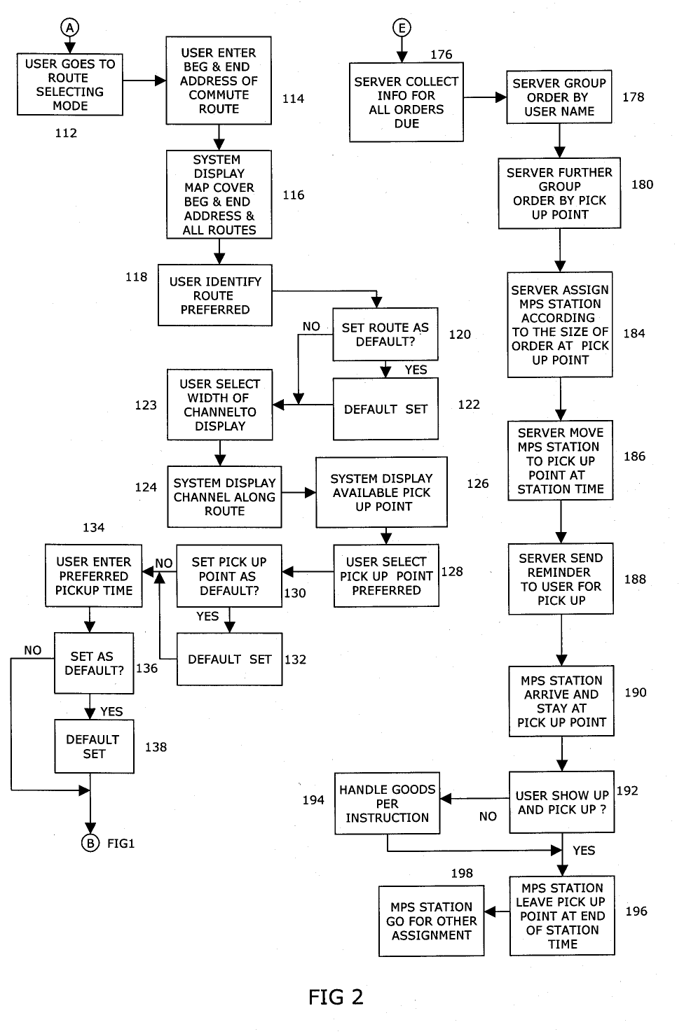

Referring to FIG. 2, the buyer then goes to a route selecting mode at step 112 to choose a commuting route. In this mode, a template is presented to the buyer to enter the beginning and the end addresses of the buyer's commuting route at step 114. In another embodiment of a MPS in accordance with the present invention, in defining beginning and end route information, the buyer/user is allowed to enter the zip codes or the telephone numbers at the beginning and end of the route. The system can then identify the general area of the beginning and the ending of the route and display a map that covers the general area of the beginning and end of the route with all possible routes available to the user. Well-known landmarks, city names, county names or the cross streets with city information at each end of the user route may be used to identify the general area of the route in a similar fashion. When the system allows the user to enter their telephone number at each end of the user route, the system may use the area codes and the prefixes of the telephone numbers to identify the general area of the beginning and end of buyer/user's commute route and may display the map. When the map that covers the general area is displayed, the server may display all available pick up points covered by the map for the user's selections. In the present invention, landmark means the description of a well-known location, it may be a shopping mall, city hall or even highway exits, etc.

Referring to FIG. 7, in one embodiment of a MPS server, a MPS server displays a map 500 that covers the beginning and the ending address of the buyer's commute route. The map may display all streets and freeways between those two ends. The buyer may click or depress and drag the mouse across the map to define a chosen route 570. In another embodiment of the present invention, a buyer is prompted to enter a distance from the buyer's chosen route that the buyer is willing to travel to pick up a product. The distance from the buyer's chosen route that the buyer is willing to travel is herein termed a channel width. The channel width is used by the MPS server to define channel boundaries 578 and 580 around the chosen route. This channel width combined with the buyer's chosen route creates a channel 572. As described herein, the server may present available pick up points along the user route for the user's selection. When available pick up points are presented along the user route, the server may display the channel to the user for the following purposes: the user/buyer may know the distance or location each available pick up point relative to the user route (i.e., the buyer may use this channel as a distance reference) or the buyer may indicate to a MPS server that this channel width is the distance the buyer is willing to travel away from the buyer's commute route. In the latter case, the server may only display those available pick up points that fall within user channel.

In another embodiment, there are two methods to determine the distance-defined channel 32 width, 1) the straight-line distance method and 2) the road-traveling distance method. “Straight-line distance” is defined as the straight line distance between any two points. To define straight-line distance channel boundaries, the server may select a point on a user-chosen route. The point selected may be any point on the user-chosen route. The server then uses the point as center and uses the selected channel width as a radius to form a circle. The points on the circle that are the furthest away from the user route are straight-line channel boundaries. A channel is then a collection of channel boundaries.

Because of the difference in road conditions, the road-traveling distance (the driving distance on the road through a path connecting any two points) and the straight-line distance between any two points may not be the same. For example, when a user gets out of his/her commute route to pick up an order, the road that leads the user to the pickup point may be curved. The road-traveling distance (or road-driving distance) from the point the user exits his/her commute route to the pickup point may be far greater than the straight-line distance between these two points.

A preferred road-traveling distance is the distance a user is willing to travel on the road away from the user-selected commute route. For example, a preferred road-traveling distance of two miles means the user is willing to drive two miles away from his selected commute route to pick up an order.

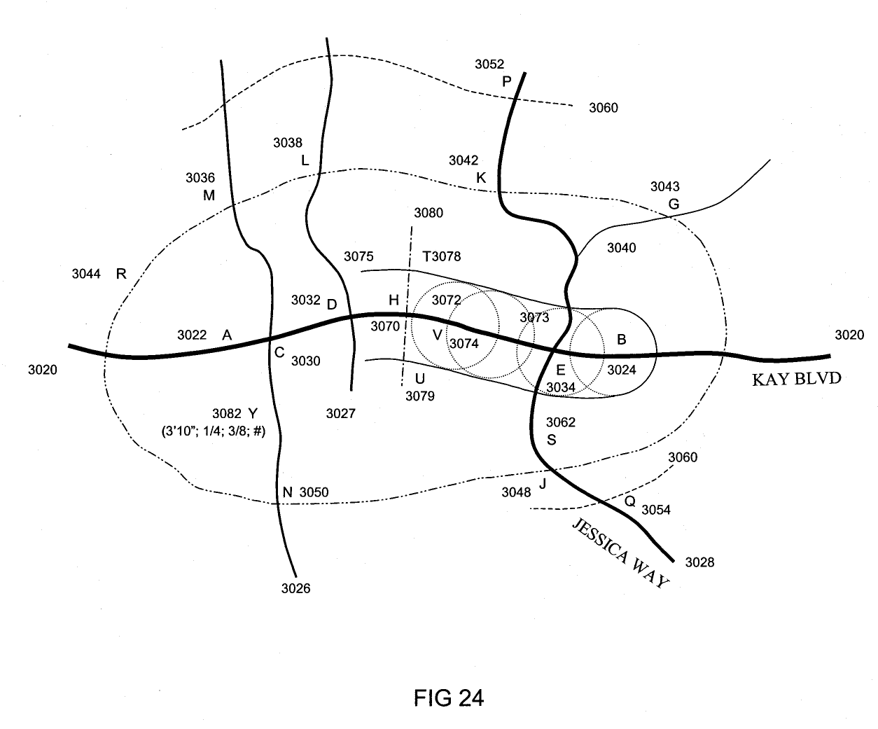

When using road-traveling distance to build a channel, the server may first find all exits and paths a user may use to travel away from the user route. The server may then use the preferred traveling distance selected by the user (or set by server default) along all the drive away paths to determine the channel boundary. Referring now to FIG. 24 as illustration, assume user Allison's selected traveling route is Kay Blvd 3020 between point A 3022 and point B 3024. Assuming also that between A and B, there are several exits, e.g., C 3030, D 3032, and E 3034, user Allison may use to travel away from her selected route 3020. Assuming Jessica Way 3028 (with exit E 3034) is one of the paths (e.g., 3026, 3027, and 3028) user Allison may use to drive away from her travel route, Kay Blvd. If user Allison selects a road-traveling distance channel width of ½ miles, the server may then set the channel boundaries along Jessica Way 3028 at K 3042 and J 3048, which may be ½ mile driving distance away from exit E 3034. The collection of J, K and other similar points, such as L 3038, M 3036, and N 3050, forms a road-traveling distance channel R 3044. The channel R 3044 is then defined by the road-driving channel width of ½ mile. Note that Jessica Way may curve and the straight-line distance from the exit E 3034 to the boundary K 3042 may be a lot shorter than ½ mile. In case Jessica Way may branch out by crossing with other streets, such as street 3040, the branch-out street 3040 and the original path forms an extra path. The ½ mile road-traveling channel boundary along this extra path is set at G 3043, a point with ½ mile road-traveling distance away from the original exit E. When building straight-line distance channel, the server may select any points, such as V 3074, B 3024 that are within the user-selected traveling route AB as centers, and use the selected channel width as radius to draw circles, such as 3072, 3073. The server then draws an envelope 3075 that surrounds and attaches to the farthest points out from user route of all circles. This envelope is the channel that is defined by the selected straight-line channel width. In FIG. 24, 3075 shows a portion of the channel. As an alternative to determine the straight-line channel boundaries, the server may select any points such as H 3070 on user-selected route and draw a line 3080 vertical to the user route at point H. The server then selects points along 3080 that are at the selected channel width away from H 3070. The points selected T 3078 and U 3079 are straight-line channel boundaries. The collection of channel boundaries defines the channel.

The system may allow the user to select either a straight-line distance method or a road-traveling distance method or both to build a channel.

In another embodiment to define a route, the server may allow the buyer to click on the map (or to enter the names) of some or all the streets or highways the buyer prefers to travel. The MPS server may then connect those streets or highways together with the shortest distance and further connect the buyer's beginning and ending addresses to build a chosen route.

The buyer may use the following procedures to click and build his/her chosen route on a map 500. The buyer starts with his/her beginning address, e.g., his/her home address, at this time the MPS server registers a reference point, which is the buyer's home address on the buyer's home street. The buyer then clicks on the map a second street the buyer will travel. The intersection of the second street and the buyer's home street become a second reference point.

The system may register the route between the first and the second reference points as a portion of buyer's chosen route. The buyer may then click a third street the buyer will travel. The intersection of the second and the third street becomes a third reference point. The MPS server then registers the route between the second and the third reference points as a portion of the buyer's chosen route. The buyer keeps on going with the process until the buyer reaches the buyer's end address, which would be the buyer's final reference point. The MPS server registers a final route portion and the whole route may thus be identified as the buyer's chosen route.

Alternatively, the buyer may start a route selecting process by clicking on the map on one of the streets within the buyer's commuting route and then clicking on the map the streets the buyer travels on before and after that street. The system then uses the intersections of these streets to establish reference points for the MPS server to construct the buyer's route. In the case where the buyer forgets or neglects to click to identify any of the traveled street(s) within his/her route, the system searches street(s) that represent the shortest traveling distance between the clicked streets and connects those clicked streets. The same method can be used to connect the clicked streets to the buyer's beginning and/or end points of route. For example, if the buyer clicks the second and the fourth traveling streets, creating a set of sub-routes and forgets to click the third traveling street in the route, the system then generates a route by connecting the second and the fourth street with street(s) with a sub-route that represents the shortest distance between the two sub-routes to complete a whole route.

In another embodiment of the present invention, the user enters telephone numbers, zip codes, city names, county names or landmarks to identify the beginning and end of a route, and then the system displays a map that covers the general area of the route. The system may also display all available pick up points covered by the general area for the user's selection. An available pick up point may be displayed on a map. The map may be displayed to the user. An available pickup point may be displayed through a list or a drop down menu. Here, the user may select the user's preferred pick up point without building the user's preferred traveling route. However, if the user wants to establish a route within the general area, the user may then enter his/her beginning and the ending travel address or use his/her mouse to point the cursor at the places he wishes to travel, and click on it. The system may then register those addresses or clicked points as reference points to establish the route. This method can be used to establish the beginning and end of a user route.

Because zip code, telephone number, city name or other similar location identifier represents an area instead of a point, the server system may use the center of the area, a well-known landmark in the area or other location in the area to establish reference point, in case a reference point in the area is needed (for example: to establish a route, etc).

In another embodiment of a route selection system in accordance with the present invention, the system may present the buyer with a default route with the shortest travel distance to connect the beginning and end of the user route when the beginning and the end of the route are determined. Major highways and/or major streets may be incorporated into the default route.

In another embodiment of the present invention, there is another option of building a default route. In this embodiment, the MPS server may display a route to the user that takes the least expected time to travel through. A Least Expected Travel Time Route (LTTR) may be built as follows. A street or road of a city or a region consists of a number of blocks (or sections). A section is defined as a portion of the street or road that consists of several blocks. The MPS server may measure the expected time (or average time, hereafter termed expected time) a driver spends in traveling through each block or section in the region. By using this information, the server may be able to obtain the expected traveling speed (or average traveling speed) at which an average person travels through a section or block. The MPS server may collect this information by hiring drivers who drive through each block and/or section in the region on different days and at different times in a day. The drivers record the time spent and the speed traveled when driving through each block or section. For example, the server may hire drivers to drive through each block or section in a city from Monday through Sunday and from 5:00 a.m. to 8:00 p.m. each day. The drivers then record the speeds traveled and amounts of time taken to travel through each block (and/or section) in the city by day and by the time of day. Because of stop signs, signal lights, and possible construction work involved in the streets, the drivers may record the time it takes to wait at each stop sign, signal light, and construction site. The drivers may also record the time it takes to finish a section of the street. These records are stored in the MPS server system. Collection and analysis of these data will enable the server to identify the expected time a traveler spends traveling through a block or a section, each day and at different times of the day.

When a user logs on to the route selecting mode and enters the beginning and ending route identifiers and the time and day of the traveling, the system may find a route that takes the least expected time to complete, the LTTR, and present it to the user. The system may find the LTTR by building all the routes that connect to the beginning and the end route identifiers input by the user. The system then computes, for all the routes, the expected time to complete a route. The expected traveling time to complete a route is the total of expected time spent at all blocks (or sections), at all stop signs, signal lights, and construction sites, etc. in a route for the time and day the user specifies. The route with the least expected time to complete is the LTTR and may be presented to the user.

Instead of having the driver record the time and speed when traveling through each block, section, stop sign, signal light, etc., an MPS server may utilize a radio signal transmitter installed on the driver's car. By tracking the signals transmitted from the driver's car, the MPS server may record the time the driver spends on waiting at each stop sign, traffic light, etc. The server may also measure the speed and time the driver travels through each block, section, etc.

In another embodiment of the invention, another option to measure the time and speed when traveling through each block (or section) of a street is provided. In this embodiment, a MPS server may use satellite images to determine the time and speed a car travels through a block or a section of a street. For example, a satellite image collected by the server on Jan. 3, 2003, 08:31:30, may show a car at one spot on a street. A few minutes later, another image shows the same car at a different spot on the same or different street. Collection and analysis of these images will enable the server to determine the expected time a traveler spends traveling through a particular block or section, the expected time a traveler spends on waiting at a particular signal light or stop sign, etc., each day and at different times of the day.

In another embodiment of the present invention (when the driver-collected expected travel time/speed or the satellite-imaged expected travel time/speed are not available, or a rough estimate that is less costly would satisfy users), estimations may be used by the server. Any estimate, as long as it is reasonable, may be used to estimate the expected traveling speed. Such estimates may include but are not limited to the speed limit imposed by the traffic department for each block (or section) of a street. Together with the length of the block (or section), the server may estimate the expected travel-through time for a block (or section). The server may further modify the estimation of expected traveling speed by incorporating the following factors. For some of the areas, the street speed limits imposed by the traffic department may not be the same for different times of a day. For example, for a street that is adjacent to a school, the speed limit may be lower at about 3:30 PM, when school is dismissed. Also, the street speed limits usually do not reflect the expected traveling speeds of a street at different times of a day. For instance, the expected traveling speed on Main Street at 5:00 a.m. may be 40 miles per hour, the imposed speed limit, but the expected traveling speed at 5:00 p.m. may only be 20 miles per hour. The server may sample some of the streets at different times of a day to determine the relationship between the effective traveling speed and the imposed speed limit at those times, and use this data to estimate the expected traveling speed for other streets in the region at different times of a day. For example, the speed limit at Main Street is 40 miles per hour in city A; the server's sample of the expected traveling speed at 11:00 a.m. on a Monday shows 30 miles per hour, and 20 miles per hour at 5:00 p.m. The expected traveling speed/speed limit ratio is 75% at 11:00 a.m. and 50% at 5:00 p.m. The server may use these ratios to estimate the expected traveling speed of other streets at different times of a day in city A. For example, the speed limit of Broadway is 50 miles per hour; the server may then use the ratio collected from Main Street to estimate the expected traveling speed of Broadway at 11:00 a.m. on Mondays to be 37.5 miles per hour and at 5:00 p.m. on Mondays to be 25 miles per hour. The user may also use similar statistics from nation, state, county, city or local agencies to obtain these ratios.

The server may also use the statistics collected from nation, state, county, city or local agencies to estimate the average time a driver waits at a stop sign and/or a traffic light. By using the above data, the server may determine a user's total expected travel time through a block or a section of a street in a region.

The user may then enter into the system the time (e.g., 8:00 a.m.), day (e.g., Monday), and traveling route identifier(s) of his/her itinerary. The system may, according to the information provided, calculate the LTTR and present it to the user.

Major highways and/or major streets may be included into user route by default and the LTTR may be calculated with these highways and/or streets included in the user route.

Once the expected travel-through time is determined for a section or a block in a region, the server will be able to determine the expected traveling speed a user travels through a section or a block of a street in a region.

In another embodiment of the present invention, the server may allow the user to select a channel width that is defined by the length of time a user is willing to spend traveling out of his/her commuting route to pick up an order. It is a time-defined channel width and is different from the channel width option that is defined by the straight-line distance or road-traveling distance as described before. In this embodiment, the user is allowed to select a preferred traveling time he/she is willing to travel out of his/her commuting route to pick up his/her order. The server may then display a channel to the user that is defined by the user-selected preferred traveling time. The process of determining such a time-defined channel may be disclosed as follows:

As previously described, the server may be able to determine or estimate the expected traveling time and the expected traveling speed a user travels through each block or section of a street in an area. By using this technique, the server may allow the user to select a preferred traveling time and use this preferred traveling time to build a time-defined channel. In one of the embodiments of the time-defined channel, the channel width, which is the driving distance from an exit of user commute route to channel boundary, is determined by how far, on average, a user may travel away on the road from an exit of the user traveling route limited by the user-selected preferred traveling time.

Referring now to FIG. 24, the server system may identify all the paths (e.g., 3026, 3027, and 3028) a user may use to exit and travel away from the user-selected commute route 3020. Within each path, there may be a combination of sections, blocks, stop signs and traffic lights. The server may hire drivers to drive along each path that may travel away from user commute route. Subject to the traveling speed limits in each block or section in the path, the drivers travel along all paths and mark each unit time elapses and record the location the driver reaches at each unit time. The collection of all average points the driver reaches in all paths at a defined traveling time forms a channel. To illustrate, refer to FIG. 24, assuming the defined traveling time is five minutes, the hired driver drives away from a user route 3020 through a travel-away path 3028 from exit E 3034 for five minutes and, on average, may reach point P 3052 or Q 3054. P and Q are then set as channel boundaries defined by five minutes. The collection of all points P and Q for all the drive-away paths forms a channel 3060, partially displayed here, with a defined time of five minutes. The channel width of a defined traveling time (e.g., 5 minutes) is then the average driving distance from an exit point (e.g., E 3034) of a user route (e.g., 3020) by an average driver to drive along a path (e.g., 3028) for the defined traveling time—five minutes in our example. Note that even with the same defined traveling time, the road-traveling distance between any two points may not be the same. For example, with the same selected traveling time, the road traveling distance between E 3034 and P 3052 may be much larger then that of E 3034 and Q 3054. This is because a school S 3062 is located along EQ and the maximum allowable driving speed around the school is much slower.

The server may collect all channels represented by different traveling times for the user to select. The user selects a preferred traveling time and the server display a channel to the user according to the selected preferred traveling time.

The server may build these channels by physically traveling as described or by computer simulation. A computer simulation can easily be done since all factors needed, such as: all the drive-away paths pertaining to a user-selected traveling route, the numbers of blocks or sections in each path, the distance in each block or section within the path, the number of stop signs, and/or traffic lights in the path, etc., are all known. Other information needed, such as the expected traveling speed in each block, the waiting time at each stop sign and traffic light, the maximum allowable driving speed in a block or section, etc., is known through information collected as described before. The server may use this information to simulate channel width for each traveling-away path according to the user-defined preferred traveling time. The collection of these channel widths forms a channel. In the case where actual collection (by physical driving or satellite imaging as described before) of information, such as expected traveling speed in a block and/or the waiting time for a stop sign (or traffic light), etc., is not available, or in case rough estimation that is less costly may satisfy users, the server may use any reasonable means to estimate the expected traveling speed or waiting time. Such estimation means may include but are not limited to: the use of the maximum traveling speed in a region to estimate the expected traveling speed or the use of national, state, county, city or local statistics to estimate how long an average driver may wait for a stop sign (or for a traffic light). Also, by knowing the distance in each block/section and the expected traveling speed, the server may estimate the time in which a driver may travel through the block/section. All other timing factors that affect the traveling speed on a street (e.g., the allowable traveling speed of a street during extra-curricular time is lower than that of regular time, etc.), as discussed before, may be incorporated into traffic speed/time calculation. The server may incorporate these parameters into computer simulation to calculate channel widths for each user-selected preferred traveling time on different days and different times of a day, and produce channels for user's selection.

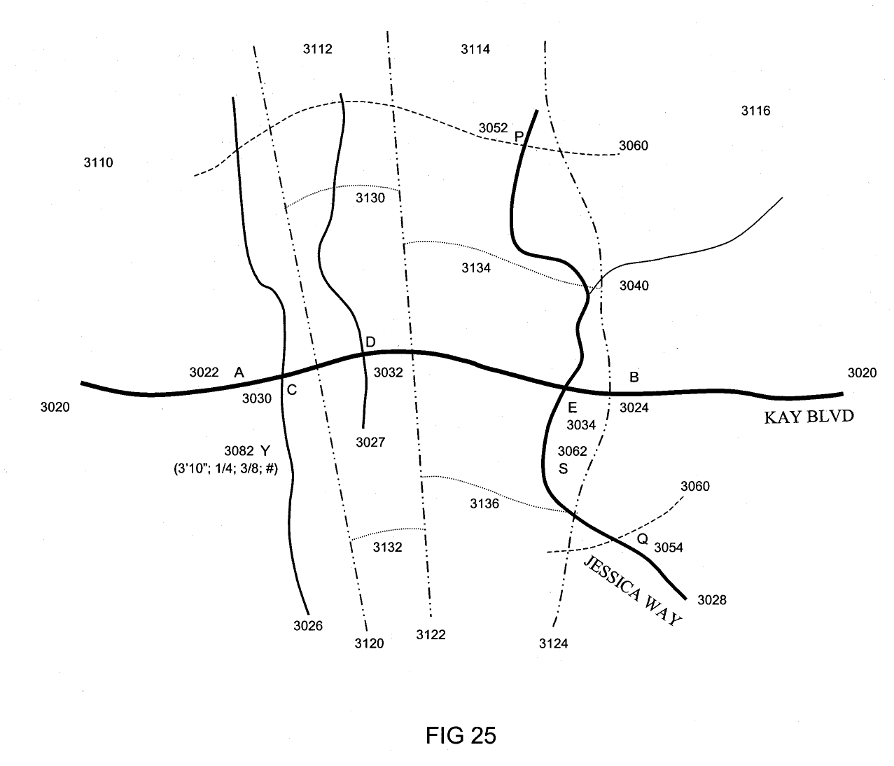

The above mentioned time-defined channel building method measures how far away, on average, a user can travel “on the road” within the defined traveling time. The method often involves determining the speed and traveling time on paths that may curve, so the calculation may be difficult. In the case where a rough estimation of traveling time would be enough to satisfy users, the server may build the time-defined channel using a concept similar to the straight-line distance concept described before. In this embodiment, the curving of paths is disregarded. Referring now to FIG. 25, in this embodiment, the server divides the area defined by user-selected identifier(s) into divisions, such as division 3110, 3112, 3114, and 3116, by division boundaries 3120, 3122, and 3124. The server may divide a user identifier-defined area into several divisions or may keep the area to only one division. The decision to divide an area into divisions may be made according to traffic conditions. For example, as shown in FIG. 25, the server may divide division 3112 and division 3114 as shown, because division 3112 is a rural area where the average traveling speed is faster, and division 3114 is an urban area where the average traveling speed is slower. The server may then determine the channel width in each division by the following procedure: The server may calculate the average traveling speed in a division. The server may also compute the average distance between traffic lights, stop signs, etc. in that division. The server may also calculate the average waiting time a user spends waiting for a traffic light and/or a stop sign. As the waiting time at a stop sign is usually shorter than that at a traffic light, the server may choose to ignore stop signs in determining waiting time. Assuming the average traveling speed in division 3112 is 30 miles per hour (or ½ mile per minute), the average distance between two traffic lights in division 3112 is one mile, and a user on average spends one minute waiting for traffic lights. In addition, it is assumed the server disregards stop sign waiting time computation, because this is usually small. Suppose the user selects a preferred traveling time of four minutes. In the first two minutes, the user travels one mile. The user then encounters a traffic light because the average distance between traffic lights is one mile. The user spends an additional minute waiting at traffic light. The user then spends the remaining minute to travel another ½ mile. The total traveling distance by the user is 1½ miles. The server then uses this distance to build channel boundaries 3130 and 3132. Each of these two boundaries is 1½ miles away from user route 3020. These channel boundaries, which are within division 3112, are defined by a user-selected preferred traveling time of four minutes. Note that the path curve is disregarded in this embodiment of boundary computation. Also, the average traveling speed is different in different divisions; the same preferred traveling time may yield different channel widths in different divisions. For example, division 3114, because it covers an urban area, has an average traveling speed of 15 miles per hour. The channel width defined by four minutes in this division would be only one mile as indicated by 3134 and 3136 (FIG. 25).

In another embodiment, the server may include the waiting at stop signs and traffic lights into the calculation of the average traveling speed in a division. For example, when waiting time at traffic lights and at stop signs is included, the server calculates the average traveling speed in a division as 10 miles per hour. The preferred traveling time of six minutes selected by the user in this division will yield channel boundaries that is one mile away from the user route.

The server, besides using the average traveling speed to compute channel width, may use estimated traveling speed or any other reasonable means to perform the computation. Such means may include, but are not limited to the maximum traveling speed or the mean traveling speed in a division, etc.

Because the traffic condition of a street (or road) varies on different days and/or at different times of a day, the server may allow the user to specify a day and the time of day when the user wants to receive channel information. The term “traveling” in the present invention means traveling with transportation equipment such as vehicles, motorcycles, bicycles, etc. It may also mean traveling without transportation equipment such as by walking, etc. When the transportation equipment is a bicycle or other type of man-powered equipment, the average traveling speed by such equipment is used when determining expected traveling speed. If human walking or running is involved, the average walking or running speed is used in determining expected traveling speed.

The server may allow the user to use any of the straight-line distance method, the road-traveling distance method, the two preferred traveling time methods or any combination of these methods to build channel(s). The server may also allow the user to select his/her preferred straight line distance, preferred road traveling distance or preferred traveling time (straight line concept or road traveling concept) to build his/her channel. The server may set default straight line distance, default road traveling distance or default preferred traveling time (straight line concept or road traveling concept) to build user channel in case the user neglects to define his/her selected parameter. Any of the above channel building parameters, i.e., straight line distance, road traveling distance or preferred traveling time may be selected by the user (or set as default by the server) with any number(s) ranging from zero to infinity.

When the selected location identifier is a zip code, telephone number or city name, it can define an area by itself. If the selected identifier is an address, which represents a point, a channel width may be selected either by user selection or by default to define an area. If the selected channel width is a straight-line distance, the defined area is a circle around the location identifier (e.g., an address) with the identifier as center and the distance as radius. If the identifier is an address and the channel width is defined by road-traveling distance or by preferred traveling time, the shape of the defined area may be irregular. The area is then defined by connecting boundaries that are defined by the selected road-driving distance or the preferred traveling time.

In another embodiment of the present invention, the buyer is allowed to change any portion of the default route built by the methods disclosed in the present invention as he/she wishes. A template may be provided to the buyer to enter via keyboard the highways or streets the buyer wants to travel out of the default route. Alternatively, the user may click on the map the places, the highways or streets the user wants to travel out of the default route. The system then may connect these selected places, highways or streets to the default route with routes with the shortest distance or the shortest traveling time. A drop-down menu that contains defaulted streets and/or highways may be used to allow the buyer to click on and select his/her desired traveling route.

After the user selects his/her desired travel route, the system may display the expected travel time to travel to the user through the user-selected route by using the method described before.

Referring again to FIG. 7, assuming the buyer chooses a straight-line channel width, e.g., ¼ mile, and indicates that the channel width is the distance he/she wants to travel away from the route. The MPS server may display two channel boundaries 578 and 580 that wrap around and extend along the chosen route 570 with the distance from a boundary to the chosen route equal to ¼ mile. The area between the channel boundaries defines a channel around the chosen route. The MPS server may display all available pickup points 510 and 512 covered by the channel.

If there are no pick up points within the channel, the MPS server may then display those pickup points around the channel such as point 514. The MPS server at this time may decide if the MPS server wants to relocate a pickup point to a place within the channel, or the MPS server will wait until condition permits, e.g., more buyers use the same route, to establish an extra pick up point to serve the buyer. If the MPS server determines that no new pickup point should be established, the buyer may select a pickup point (e.g., 514) outside of the buyer's channel.

Referring again to the process flow diagram of FIG. 2, once the beginning and the end address of the route is defined, the MPS server may display a map with all the possible routes involved at step 116. The buyer may then click or depress and drag the mouse key on the map described in FIG. 7 to define the buyer's chosen route at step 118. The buyer can choose to set the chosen route as a default route at steps 120 and 122. If the chosen route is a temporary route because the buyer is temporarily traveling along a new commute route, the buyer may not want to set the chosen route as a default route. The buyer may select a width for the MPS server to develop a channel around a chosen route at step 123. The MPS server may then display a channel that wraps around and extends along the route at step 124 with the defined width. The MPS server may display the channel as previously described in FIG. 7. The system may display all available pick up points at step 126. The buyer may use the buyer/user's mouse to click a pick up point at step 128 to select the user's preferred pick up point. The system may then record the selected pick up point and its address. The server may then register the address of the selected pick up point as the delivery address of the user/buyer order. The server may not be the seller of the order, if this is the case, the address of the selected pickup point may be transmitted to the seller of the order. The delivery address, which is the address of the selected pickup point, is then included in the shipping label that is to be attached to the user order by the seller later. The delivery address may be a code that is established by the MPS entity to represent the pick up point. The buyer can set the pick up point to be the buyer's default pick up point if the buyer desires—refer to steps 130 and 132. The buyer may also enter the buyer's preferred pickup time at step 134. He may also set this pick up time as a default at steps 136 and 138. The server may set a station time as the time a MPS stays at the pickup point. The station time may be announced to the buyer at the time the buyer logs on to the server web site. The buyer may use it to plan a time to come to the pick up point to pick up his/her order. The buyer may come anytime within the station time to pick up the order. For example, the MPS server may set station time between 4 p.m. to 7 p.m. or 6 a.m. to 9 a.m. and the buyer comes between those times to pick up the buyer's products. A MPS may stay at the pick up point until all buyers pick up their products.

The pick up time entry, in the case no station time is set, gives the MPS server a planning tool as to how long a MPS will stay at a pickup point before the MPS is sent to a next assignment.

In one embodiment of a MPS server, the pickup time entry may be also used as a guide to send a reminder to the buyer for pickups. For example, if a buyer enters 7:30 a.m. as the buyer's pick up time, the MPS server may send a reminder at 7:00 a.m. to the buyer to remind the buyer that he has an order to pick up. The reminder may be very important if the order is to be picked up early in the morning. The reminder may be in the form of telephone calls to the buyer's office, home, or cellular phone. It may also be in the form of e-mails or messages sent to a buyer's Palm Pilot, or it may be by other means permitted by technology.

The preferred pick up time entry may be used by the MPS operator as a guide for the timing of the preparation of the user order as will be discussed later.

When entering the beginning and ending route location identifiers, if the user enters only one identifier and leaves the other identifier un-entered, the system may treat the un-entered identifier the same as the one entered. The beginning and end route identifiers may be entered as the same. In this case, the defined user commute route is a point.

The system may allow the user to enter one location identifier only. If the identifier entered is an address, which defines a point, a channel width may be used to define an area to display pick up points. If the identifier entered is a city, telephone number, zip code, famous landmark, etc. that by itself can define an area, available pick up points may be displayed within the defined area for selection. In short, the MPS server may display (or, at the request of the user, display) a map with available pick up points for selection. The map may be defined by the user selected route, user selected channel, user selected location identifier(s), server default route, server default channel, or server default location identifier(s) and/or other identifier(s). As an alternative, the server may display (or, at the request of user, display) a list that contains available pick up points defined by all the above-mentioned identifier(s).

It is to the server's advantage if the server can limit the number of available pick up points users may select to as few as possible, although there may be many more pick up points available for selection. In other words, it is to the server's advantage if the server may direct more users to select a common pick up point to pick up their orders. Because with such an arrangement, the number of orders delivered by each mobile pick up station will be higher and thus more cost-efficient. In order to direct users to select common pick up points, the server may display only a few, e.g., one or two, of the available pick up point(s) for users' section. The users are then forced to select the displayed pick up points. The server may present other pick up points for user to select when the orders that are to be delivered to the displayed pick up point reaches the maximum delivery capacity of the mobile pick up station assigned to it. Also, the server may display other pick up points for a user to select if the user expresses dissatisfaction of the pick up point(s) displayed and wants other selections. The server may thus select one (or any number) of pick up point(s) among the available pick up points for the users' selection as long as it may justify the cost.

The server may present different users with different pick up points for selection even though these users share common travel routes or use common route location identifiers.

The server may assign more than one pick up station to a pick up point. Also, if in an area (or in a route), there is only one pickup point that is available for user to select, the user has to select that specific pickup point, or not use the server's service.

The user may then select his/her preferred pick up point among the available pick up points displayed to him/her.

To display too many pickup points to a buyer may be useless and confusing. In another embodiment of the present invention, the server calculates the closest “Y” pick up points around the user's selected identifier (e.g., user's home, etc), or to the user travel route. In this embodiment, the MPS entity may calculate the distance of each pickup point to the buyer's selected identifier (or to the user's travel route) and identify the “Y” pickup points that are with the closest (shortest) distances to the buyer's selected identifier (or to the user's travel route). The closest distance may be defined by the straight-line distance method or the road-traveling distance method discussed before. The server may then display these pick up points to the user or the server may calculate “Y” available pick up points the user may spend the least travel time to reach from the user's selected identifier or from the user travel route, according to the preferred traveling time method discussed previously and display these pick up points to the user. “Y” is the number of available pick up points selected by a user or by the server.

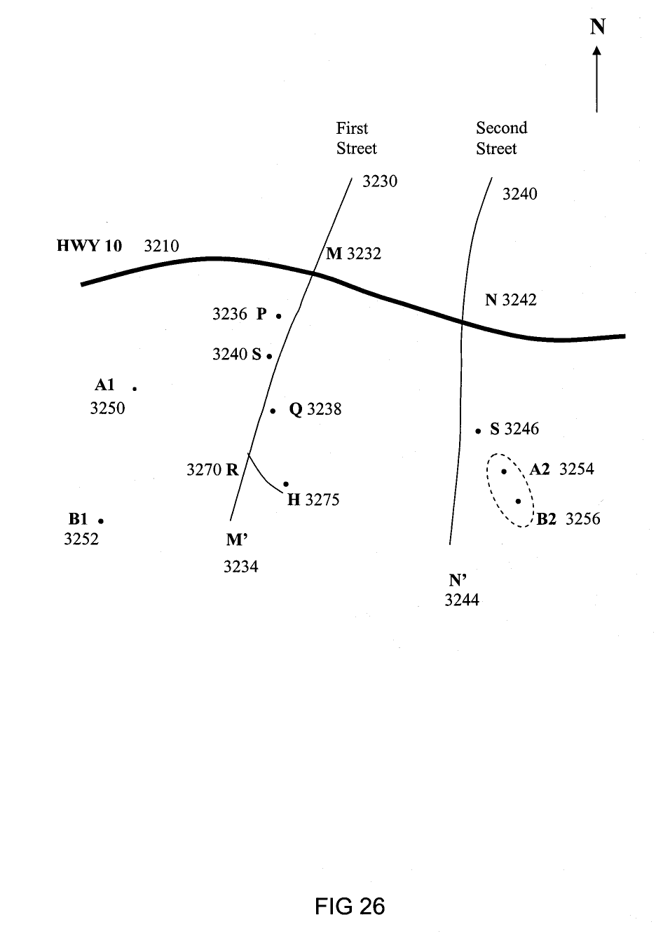

It may be economical for the MPS entity to use a location identifier (such as zip code, telephone number, city name, or commuting route, etc.) that may identify a large area. A problem may arise when such an identifier is used to identify and/or display pickup points for buyers' selections. The problem may be explained by the following example: In FIG. 26, P 3236 and Q 3238 are pickup points. Assuming the MPS entity displayed the map as shown in FIG. 26 (with pickup points P 3236 and Q 3238) for the buyer's selection. Assuming S 3240 and H 3275 are buyers. Note that P 3236 and Q 3238 are equally convenient to H 3275 and H 3275 may select any of P and Q as pickup point to pickup his/her order. However, Q 3238 is not convenient to buyer S 3240 although P 3236 is convenient to buyer S. A problem exists when H 3275 selects P 3236 as his/her pickup point and after the selection; the capacity at P 3236 is full. In this case, S 3240 has to select another pickup point, e.g. Q 3238 as a pickup point. Q 3238 is not convenient to S 3240. The example may happen in the real world as a pickup point such as the one near a highway exit may be “clogged” by buyers. Some of the buyers may select other pickup points that are equally convenient to use and leave the pickup point to buyers who live close to the pickup point. In this way, every buyer will be satisfied. In our example, it would be convenient for every person if H 3275 uses Q 3238 and S 3240 uses P 3236 as pickup point. In one embodiment of the present invention, the MPS entity institutes a system and may solve this problem. In the embodiment, a pickup point may be displayed to a buyer for selection based on its priority. The priority of the selection of a pickup point may be based on its closeness to a buyer's physical address. The one that is closer to a buyer's physical address (e.g. a buyer's home or office address) may have a higher priority over the one that is not. In the above example, Q 3238 is displayed to H 3275 before P 3236 is displayed because Q 3238 is the closest to H 3275. P 3236 may be displayed to H for selection after Q 3238 reaches its carrying capacity. In the embodiment, the MPS entity may calculate the distance of each pickup point to a buyer's physical address and determine the priority of each pickup location. A pickup point with higher priority is open for selection before a pickup point with lower priority. Pickup locations may be grouped into clusters. Each cluster may be assigned a priority. The MPS entity may define the priority of these clusters. For example, the MPS entity may determine that pickup points that are within ½ miles away from a buyer's address is considered the closest and assigned top priority. The pickup points that are within ½ mile to 1 mile to a buyer's physical address are at the next priority. A pickup point within higher priority cluster is open for selection before a pickup point within a lower priority cluster.

That is, when assigning a pickup point to a buyer to use, the MPS entity may assigned the pickup point that is closest to the buyer's physical address. The closeness of a pickup point to a buyer's physical address may be defined by the straight-line distance method, the road-traveling distance method or travel time method as discussed before.

When a buyer is assigned a pickup point to use by the MPS entity, the entity may assign the one that is the closest to the buyer's physical address as the buyer's pickup point. The MPS entity may assign the second closest pickup point for the buyer to use, if the pickup point is fully occupied.

This method may be used in conjunction with other identifiers such as commuting route to reach the maximum pickup convenience to a buyer. For the ease of operation, this method may also be used without any other identifiers. In this case, the buyer's physical address is the only identifier to assign a pickup point for a buyer to use.

In another embodiment of the present invention, the server, when displaying available pick up points for the user's selection, may display information such as the expected traveling time, straight-line distance and/or road-traveling distance from an exit of a highway or an intersection to a major street alongside the pick up point to aid the user's decision. In this embodiment, the server determines the major highways around the pickup point. The server then computes the straight distance (or road-travel distance or expected travel time) from the pickup point to the closest exit (or the second closest exit) of each of the surrounding highways. The server may then display this information along with the pick up point. For example, a pick up point is between Highway 10 and Highway 60; the closest exit from the pickup point to Highway 60 is Exit 24; the closest exit from the pick up point to Highway 10 is Exit 37. The server may display along the pick up point the road-travel distance to Exit 37 and/or the road-travel distance to Exit 24. The server searches other information associated with each available pick up point, such as the name of the pick up point, signs to identify the pick up point, activities occurring at the pick up point, etc. may be displayed as well. For example, in FIG. 24, Y 3082 is an available pick up point. The symbol (3′10″; ¼; ⅜; #) alongside Y 3082 may mean the expected traveling time from Y to exit C 3030 is three minutes and ten seconds; the straight distance from Y to exit C is ¼ mile, and the driving distance from Y to exit C is ⅜ mile. The # sign may mean special activities such as merchandise sale, free coffee, etc. occur at the pick up location. The user may click at the # sign to receive detailed information. In the case where a list, instead of a map, is used to display available pick up points, this information may then be displayed on the list along side the available pick up points. With this information displayed, the displaying of the channel itself may be unnecessary.

When building a channel, the server may allow the user to select a channel width or the server may set a default channel width for the user. The channel width may be defined by road-driving distance or straight-line distance or preferred traveling time. The width of user selected channel width or default channel width may be any number from zero to infinity. When the user forgets or ignores to select a channel width, the server may display to the user a channel with default channel width.

In another embodiment of the present invention, the MPS server may allow the user to enter more then one (i.e., two, three, four or more) identifier to identify the general area or localities the user wants pickup locations to be displayed for the user's selection. The route may or may not be built by user or by server default. When building a travel route with multiple identifiers, the travel route is built in a way that connects all identifiers entered. A channel width may be selected by the user or set by server default.

In the present invention, a general area, locality or localities may be defined by city (or cities), county (or counties), zip code (or zip codes) or area code (or area codes), etc. The general area, locality or localities may cover the identifier(s) or may cover the region between the identifiers if multiple identifiers are used. As an alternative, a map that is presented to the user on the user's screen may define a general area, locality or localities.

Referring again to FIG. 1, after finishing input of all setup information, a buyer proceeds to step 140. The MPS server may display product categories for the buyer to choose if the buyer does not want to change any information at step 144. Product categories are different groups of products sold by a seller. For a food producing company (e.g., a food catering business or a lunch/dinner delivery business) the categories may be: drinks, wine, Italian food, French food, Japanese food, desserts, pizza or other products the server is selling. The MPS entity may ask its suppliers, e.g. a food producing company, to provide product information. The product information may include product specifications, features, prices, nutrition information, etc. The MPS entity may keep the product information in its database. The server may use this information and a buyer's preference information to screen for products a buyer prefers and displays only those products that match the buyer's preferences.

The MPS server may display only those categories that match the buyer's preference and disregard those that the buyer is not interested in purchasing. The buyer may click on the category he/she wants to purchase at step 146. The MPS server may bring up all products under category buyer selected at step 148. After screened by category, the products displayed may be subject to the same screening process as previously described, which is, only products that match the buyer's preference may be displayed and any other products may be disregarded. The MPS server may display product features along with products. Those features displayed may be ingredients, calorie count, fat count, and price, etc. The MPS server may also employ newly developed technology that gives out the scent of the food when buyer reviews its product information to stimulate purchases. The buyer may cancel previous orders or, after reviewing product items, decide to order and continues to order mode at step 150.

In one embodiment, a MPS server provides an Automatic Selection Method (ASM) service. This is a MPS server service designed for a buyer who does not want to go through the trouble of ordering manually repeatedly and, after establishing the buyer's preferences with the MPS server, wants the MPS server to place orders for him/her according to the buyer's preferences. As an example, a buyer may set up a buyer's preference with the server. A buyer's preference may include the specifications, attributes or features of the products the buyer desires. As an example, a buyer's preference for a meal may contain less than 600 calories, fewer than 30 grams of fat, no red meat, no onion, be priced under $5.00 or have the total meal budget for a month lower than $250.00, etc. The user/buyer may decide if he/she wants to use the ASM method to order food at step 152.

If the buyer/user wants to use the ASM method to order food, the MPS server may follow the following steps to generate orders for the buyer: The MPS server may display a calendar at step 154. The buyer may mark on the calendar to indicate the day (or days) the buyer wants products to be delivered at step 156.

The system allows a user/buyer to select one day or multiple days for service. Instead of checking the day (or days) for service, the system may allow the user to check those days the user does not want service to be provided, and the system orders service for those days the user does not check. The system may allow the user to enter other selection options, such as: service to be provided for every Monday and Wednesday only, every Monday, Tuesday and Friday only, service to be provided every weekday, service to be provided excluding or including holidays, or to be provided on any combination of days, etc. The calendar the server presents to the user may be in any form as long as a user may use it to identify the day or the days(s) he/she wants (or does not want) service. The calendar may be a traditional calendar, a list containing days, a drop down menu containing days or other forms. The server may also allow the user to enter from keyboard the day or the days the user wants or does not want services.

The server may collect a buyer's product preference information from the buyer. When the product ordered is food, the preference information may include specifications/attributes of the food product ordered (e.g. spicy/non-spicy food, vegetarian/non-vegetarian food, nutrition data . . . ), features of the food ordered, price of each order or budget (e.g. monthly, bi-weekly or weekly budget, etc) of total food ordered, nutrition information, etc. The preference information may include the foods a buyer dislikes or wants to avoid. For example, a buyer may reveal in his/her preference information that he/she is allergic to eggs and declares that eggs should never be included in the buyer's food. The information can be collected from the buyer by using a server-provided template. The server may design a template and use the template to collect buyer preference information. In the template, a number of questions related to the buyer's preferences may be presented. Examples of the questions may be: Does the buyer prefer spicy food? What price does the buyer want to pay for the order?, Is buyer a vegetarian?, etc. The buyer may use the template to answer these questions. Some questions may be answered in the form of ranges, such as preferred price being below $5.00, $5.00 to $10.00, or over $10.00, etc. A food is mild hot, medium hot, or very hot. Some questions may be answered by checking yes or no. Some questions may be answered by typing key words to the template. The server collects this information.

The MPS entity may ask an entity to provide product information for these products sold through the MPS entity. The product information may include product specifications/attributes, features, prices, nutrition information, etc. These product information provided to the MPS server is preferably in a format that conforms to or is compatible with the template presented to a buyer. The MPS entity may keep the product information in the MPS entity's database. The server may use this information to search for products that match the buyer's preference. The MPS server may display only those products that match the buyer's preferences to the buyer. The product information is preferably displayed in the same format as the template.

When the buyer wants to use the ASM method to have the MPS entity to order products for him/her, the MPS entity may search its database for a product that match the buyer's preference for each day the buyer indicates he/she wants service. If the product is found, the MPS entity orders the product for the buyer. If a perfect match cannot be found, the server may search for a product with the closest resemblance to the buyer's preference and orders the product for the buyer. The server may set up criteria and/or determination rules. The MPS entity uses the criteria and/or determination rules to determine if a product is resemble to the product the buyer wants. As an example, if a buyer lists five attributes for the preferred food product the buyer wants. A product, e.g. product A, has three attributes identical to the buyer's listed attributes. Product A may be regarded as closely resemble to the buyer's preference. Another product, e.g. product B, has the most attributes, e.g. four attributes, identical to the buyer listed attributes. Product B is regarded as the product with the closet resemblance to the buyer's preference and may be used to fill the buyer's order. The server may then generate an ordered list for the buyer. The ordered list consists of the products that the MPS orders for the buyer for each day the buyer wants service. The products are selected by the MPS entity according to the buyer's preference. The products that fill the order list are preferably the products sold by suppliers affiliated with the MPS entity. The server may select a different product for the buyer for each day the buyer marks on the calendar that he/she wants service. When a buyer does not set a spending budget for the period of time he/she wants orders, the MPS server may generate orders for the buyer without considering the overall price of the orders. In the embodiment, the MPS entity is making purchasing decision for a buyer according to the buyer's preference and the days that the buyer wants service. That is, the MPS entity selects products for a buyer according to the buyer's preference for each day the buyer wants service and places orders to purchase the selected products for the buyer for the days the buyer wants service.

When an order is generated by the server, the server compares the order with previous orders, if an item in the order is a repeated item compared with previous orders, the MPS selects a different item to fill the order. For example, when the MPS server generates an order for a buyer, one item in the order is a roast beef sandwich. The server may compare with the buyer's previous orders and finds out that the buyer ordered a roast beef sandwich two days ago, the MPS server may replace the roast beef sandwich with some other item. The buyer and/or the MPS server may decide a time period over which a repeated item is permitted. For example, the buyer may decide that he/she allows a repeated item every two weeks. In this case, the MPS service may select an item to fill the buyer's order two weeks after the day the item first appears on the buyer's order. In the example, when the server generates an order for a buyer, the server may review the buyer's order for the last two weeks to see if the item generated is a repeated item. If it is, the server substitutes the item with a different item.

A “repeated item” can be defined as a final product, e.g. a roast beef sandwich. A “repeated item” can also be defined as a category, such as chicken, beef, fish, or the ethnic origin of food (e.g. American, Italian, Japanese, etc). As an example, if the allowed period of repeated order for a buyer is four days and the selected item for today's menu is Japanese food, then the next Japanese food appears on the buyer's menu will be after four days from today.

The MPS entity may collect personal information from a buyer. The information collected from a customer may be the ethnic group the buyer belongs to, buyer's last name (an indication of ethnic group the buyer belongs to), buyer's religion, buyer's gender, or the buyer's address (to determine the vicinity the buyer is living in), etc. The MPS entity may project (or predict) a buyer's preference information based on the buyer's personal information and use the projected preference information to place order for the buyer. For example, if the MPS entity finds out that a buyer's last name is of Muslim origin, the MPS entity may send out a inquiry to the buyer to inquire if a food item with pork is a concern or the MPS entity may avoid ordering any food item with pork for the buyer. If a buyer has placed orders from the MPS entity for a period of time and has established an ordering history, the entity may analyze the ordering history and use this information to project the buyer's purchasing preferences.

The server may transmit the MPS server-generated order list to the buyer to see if the buyer wants to change any item (product) in the list. The MPS entity may give the buyer a specified time to respond to the list. If the buyer fails to change or cancel any item in the order list within the specified time, the order list is considered accepted and the MPS entity delivers the order according to its delivery date. The MPS entity may have an agreement with a buyer. In the agreement, an order that is placed by the MPS entity for a buyer by using the ASM method is considered ordered by the buyer personally and is considered a firm sales contract.

The buyer may change any item on the order list. If the buyer changes an item, the server may need to re-calculate the list to accommodate the change. For example, if the buyer changes a $5.00 item for a $6.00 item, the server may need to modify the list so that the total price on the list will still satisfy the buyer's budget. Once the list is accepted, the server then transmits the order list to the entity (or entities) that will produce the item(s) in the order list and arranges delivery of the order according to the date(s) the buyer selected on the calendar.

In one embodiment of the present invention, the MPS entity chooses a selected group, monitors the orders (or choices) of the selected group, and publishes the orders (or choices) of the selected group to give a user a reference when the user makes his/her purchase decision. The server may select the size of the group. The entity may select the members in the group based on ethnicity, income level, gender and other criteria that are considered representative of the target market the entity wants to serve. The group members may or may not be the entity's current customers. As an example, the entity selects a selected group that consists of a hundred of the entity's current customers. The entity monitors the selected group's purchasing behavior and finds that in the last week of July, 30% of the group ordered chicken à La king of brand A, and 25% of the group ordered cheeseburgers of brand B, etc. The server may publish this information to aid a user in making his/her purchase decision. The server may perform such monitoring and publishing daily, weekly, biweekly, monthly or at any other interval determined by the entity. The entity may use this selected group purchase information as an order ordering criteria in the Automatic Selection Method (ASM). For example, the entity may select the item that is the most ordered by the selected group and place an order with the item for a customer when the customer is using the ASM method for ordering.

The entity may allow the user to place different orders and may have these orders delivered to different pickup locations at different delivery times in one day. For example, the user may order lunch and dinner on one day, and have the lunch delivered to pickup point A at 11:30 a.m. and have the dinner delivered to pickup point B at 5:30 p.m.

The buyer may choose to set different pickup points, and pickup times for each day as described in steps 112-138 (FIG. 2). In other words, the buyer is able to pick up his/her order at one pickup location on one day and pick up his/her order at a different pickup point on another day. Alternatively, the buyer may use a default route, pickup point or time information as previously entered in steps 158 and 160. The buyer may modify the buyer's preference if the buyer desires at step 162. The buyer may set up an “occurrence rate” for each product to appear on the buyer's menu at step 164. The occurrence rate is the percentage of times an item or an attribute of an item appears on the buyer's total orders.

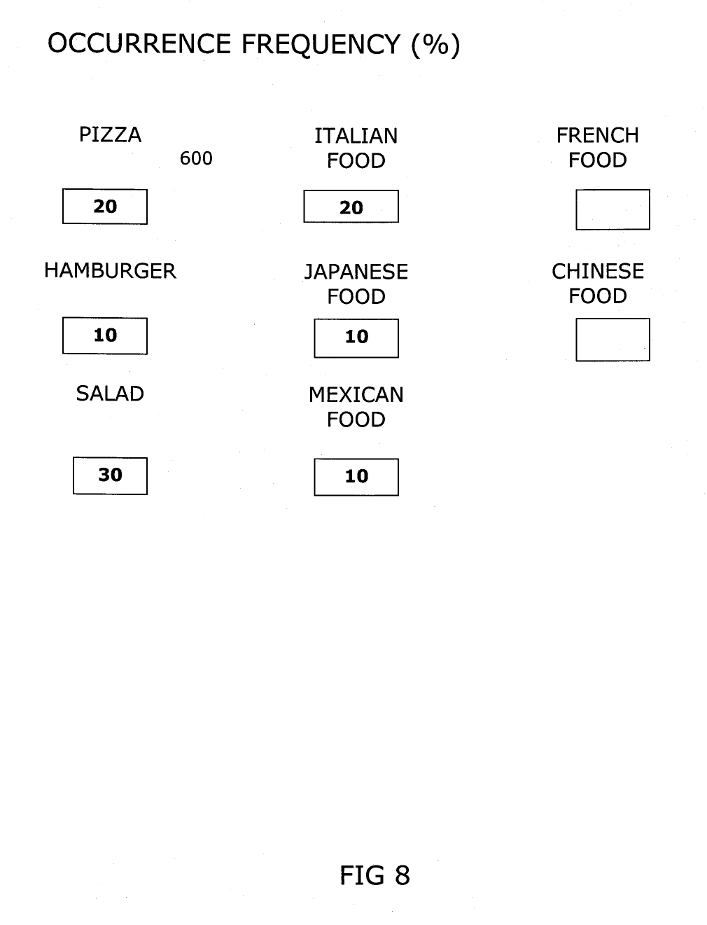

FIG. 8 is an example showing the use of a template to enter occurrence rates. In the example, a buyer enters a 20% occurrence rate for pizza 600. This means that the buyer wants 20% of the buyer's total orders to be pizza when the MPS server uses the ASM method to fill orders for him. In the example, if the buyer orders a total of 20 meals form the MPS entity, the ASM system will order 4 out of 20 of the buyer's meals with pizzas. (20×20%=4). The MPS server may generate an occurrence rate for a buyer based on the buyer's personal information such as: the ethnic group the buyer belongs to, buyer's last name (an indication of ethnic group the buyer belongs to), buyer's religion, buyer's gender or the buyer's address (to determine the area the buyer is living in), etc. As an example, if the MPS entity finds out that a buyer's last name is of Japanese origin, the MPS entity may set a higher occurrence rate of Japanese food for the buyer. That is, the ASM method may order a higher percentage of Japanese food for the buyer. If the buyer has placed orders from the MPS entity for a period of time and has established an ordering history, the entity may analyze the buyer's ordering history and use this information to project the buyer's the occurrence rate of a food item or an attribute.

Refer again to FIG. 1. In FIG. 1, the MPS server generates an order for the buyer according to the buyer's preference, with occurrence rate entered for each day the buyer selected on the calendar. Each day may contain a different order of products. The server may set up a cut-off time. The buyer may be allowed to manually change a server-generated order before the cut-off time. If the buyer does not change the server-generated order before the cut-off time, the server-generated order is delivered at step 66. The server-generated order may be delivered according to the selected day(s) without buyer's further authorization, and the buyer can be liable to pay for these orders. As an example, if the server-generated order for buyer A on May 2 is a roast beef sandwich, the server may send an e-mail on the morning of May 2 to remind buyer A of the order. If buyer A does not reply, change or cancel the order by 1:00 p.m. of May 2, the order of roast beef sandwich can be considered firm and be produced and delivered. The buyer can then be liable to pay for the order. The buyer may use the server-provided calendar to specify a date and request the production of the order according to the specified date. The production date and the delivery date of an order may be selected to be the same to insure the quality of the product.

If no change is made to the orders, the buyer may decide if the buyer wants to place orders in other categories at steps 168 and 170. If the buyer wants to place an order in another category, the buyer goes to category selection at step 146 and follows the same procedure as described before. If the buyer does not want to shop for any other categories, the buyer makes payments at step 172. The MPS server may regularly check buyer orders to see if there is any order or delivery that is due at step 174. If an order is due, the MPS entity prepares for production or makes inventory requisition for the order. The MPS entity prepares for all due orders.

Referring again to FIG. 2, the MPS server may collect buyers' names, pick up points, pick Up times and other related information for due orders at step 176. The server may first group orders by buyer name at step 178. The MPS server further groups those orders by pickup points at step 180. The MPS entity may set up a policy to deliver orders to pick up points only, as no delivery is made to a buyer's physical address. At this time, all orders are grouped by buyer names and by pick up points. A MPS is assigned to a pick up point. The MPS server may calculate the size of the orders to be shipped to a pick up point and assigns a MPS with enough capacity to execute the shipment at step 184. The MPS entity loads the orders to the MPS. The MPS, after being loaded with orders, is dispatched to the assigned pickup point at step 186. The MPS server may determine the timing of dispatching MPSs to pickup points. For example, if a MPS is needed at a pickup point at 4:00 PM and the MPS server also determines that the time spent on travel from the MPS server's warehouse to a MPS pick up point is about one hour, the MPS server may determine that the MPS should leave the MPS warehouse at about 3 PM.

A MPS server may send out a reminder to a buyer to remind the buyer to pick up the buyer's products at step 188. The reminder may be sent by e-mail, a telephone call to a buyer's cellular phone or office, or by sending a message to the buyer's Palm Pilot. With a buyer who is equipped with a Mobile Location Determination System (MLDS), Global Positioning System (GPS), car navigation system, cellular phone caller location determination system or other systems capable of determining user's current location, the MPS server may, upon detecting that the buyer is near the buyer's pickup point, start to prepare the user's order and/or send a message to the buyer to remind the buyer to pick up products ordered and give the buyer the directions to the pick up point.

When a MPS arrives at a pick up point, the MPS stays there for the station time at step 190 and waits for buyers to pick up products at step 192. In the case where the MPS is a locker kiosk without an operator or attendant, the station time may be longer than those stations with operators or attendants. The MPS may install a sign, fly a balloon, or turn on a search light for the buyer's easy identification. Also, a MPS may have microwave ovens for the buyer's convenience to heat up food the buyer picks up.

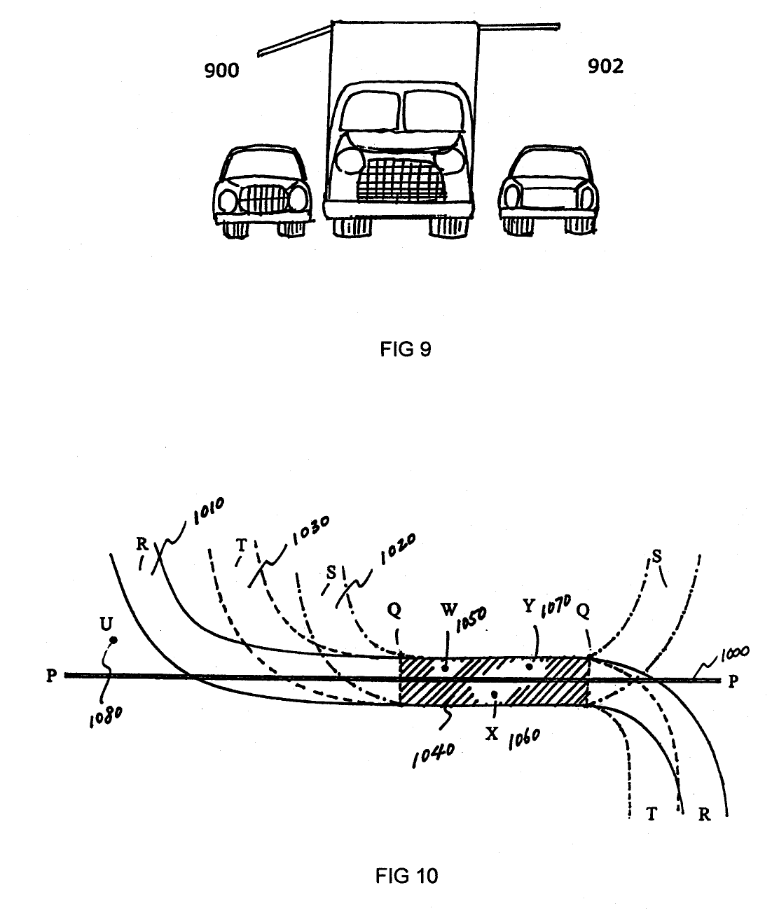

Referring to FIG. 9, a MPS may also install a panel 900. When the panel is pulled up to the panel's up position 902, the panel will shelter a buyer from the rain, snow, or sunlight. When in the case that the MPS is a truck, the panel provides the buyer a “drive thru” lane. A buyer can thus pick up products ordered without leaving the buyer's car.

Referring again to FIG. 2, when a buyer picks up a product at step 192, the operator of a MPS may want the buyer to sign a receipt as evidence of receiving products. If buyer fails to pick up an order at step 194, the MPS operator may follow the buyer's instructions as to how to handle the products not picked up. A MPS server may give instructions such returning the products not picked up to a MPS warehouse for re-delivery or sell the non-picked up products for whatever the operator can sell and credit the buyer for the amount sold, etc. The server may decide that the buyer's orders are released from a MPS only when the buyer or his/her representative personally appears at the pick up point to retrieve the order.

When the station time is up, the MPS may leave the MPS pick up point (or is picked up by MPS server) at step 196. The MPS station may leave the pick up point if all orders have been picked up, even if the station time is not up. For the maximum use of an MPS, it may be moved to another location to carry out other assignments at step 198.

If the buyer wants to order manually instead of using an ASM service to order at step 152 or if the delivery is not for the current day at step 153 and the selection of order is not complete at step 202, the MPS server may provide a calendar at step 204 for the buyer to select the days of order/delivery desired. The calendar displays a plurality of dates and allows the buyer to select multiple dates of service. For these days of service the buyer selects, the buyer may select for each date on the calendar a different order and the server relates each order to the selected day. The buyer may manually mark on calendar the days the buyer wants to order products and have them delivered at step 206, and the buyer fill those days with orders at step 208. The buyer may specify a different route at step 210 and pickup time at step 212 for each day by using the same procedure as described before.

If the manual selection of orders is complete at step 202, the buyer makes a decision as to whether the buyer wants to make other orders at step 170. If the buyer does want to make other orders, the buyer selects a category at step 146; if not, the buyer makes payments on the existing orders at step 172. If the buyer wants to order manually instead of using an ASM service at step 152, and if the order/delivery is for the current day at step 153, the buyer may go into the order mode and place an order at step 220. The buyer may change the route and pick up point at step 224, and pick up time at step 226 as previously described. The server may establish a cut-off time for every order placed by the buyer. The buyer may change or cancel an order before the cut-off time. If the order is not changed or cancelled by the cut-off time, the buyer is liable for payment of the product.

As previously described, a MPS server may indicate to a buyer available pickup points within or around the buyer's channel for buyer's selection. As described also, MPS server may indicate to the buyer available pickup points defined by other identifiers for the buyer's selection (“delivery area identifiers”).

Several different methods may be used by a MPS server to determine available pickup points for the buyer's selection.

It is to the benefit of the MPS server that pick up points are selected at locations where the maximum amount of users travel. An Approximate Method may be used for selection of available pickup points. In the Approximate Method, the MPS server may use the traffic volume of a route (e.g. a highway, a street off-ramp to a highway or a major street) as a guide to approximate buyer route concentrations and place available pickup points along the route for usage selection. A highly-traveled highway and/or its off-ramp street may be assumed to have a high user route concentration and available pick up points may be placed along it. The same assumption may be made for a busy major street. The MPS server may thus present to the buyer pick up points along those routes for selection. Other criteria in determining available pick up points may be considered and will be disclosed later.

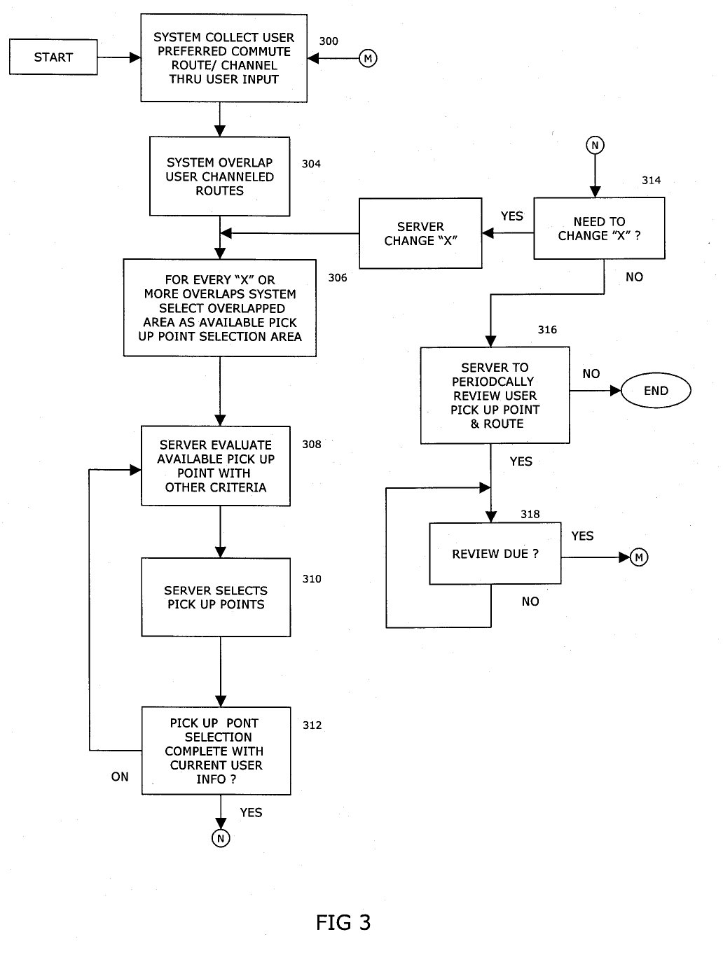

FIG. 3 is a process flow diagram of a method used by a MPS server for selecting available pick up locations using an overlap route method. In this method, the MPS server collects buyer chosen commute routes and/or channels from buyer input at step 300. The MPS server then overlaps all chosen routes without channel or all channeled chosen routes defined by all buyers at step 304. The MPS server may for every overlapped route or area select the overlapped route or area as an area for available pickup points at step 306. In addition to overlapping, the MPS server may consider other criteria for determining pickup points at step 308. Other criteria the MPS server might consider are if rent involved for using a pick up point, the amount of the rent, the distance of the pickup point from the buyer's route, convenience of the pickup point to a buyer's route, parking availability, pickup point easy identification, etc. The MPS server makes a decision and selects available pick up points at step 310. The MPS entity makes necessary arrangements, e.g. signs a lease with the property owner for the use of the pick up point. Once an arrangement is made, the MPS entity can add the pick up point to its database. The pick up point is then ready for selection.

A buyer may choose his/her chosen pickup point and/or default pickup point among those available provided by the MPS server. The MPS server decides if current available pick up points would be able to satisfy users at 312. If it is, the selection of available pick up points is complete and goes to step 314. If the MPS server needs to provide more pick up points to the buyer, the MPS server goes to step 308 for more selections. The MPS server may change parameters to expand or contract the area of available pickup points at step 314. For example, the server may decide that it is no longer economically feasible to select an area to establish available pick up points if the area only contains a few user route/channel overlaps. The server may increase the parameter. From time to time, the MPS server may periodically review buyers' chosen commuting routes at step 316 to see if the buyer route distributions have changed. If the buyer route distributions have changed, the MPS server may correspondingly reposition its pick up points to better serve buyers. If the time for route reviewing is due at step 318, the MPS server restarts the whole process to update the MPS pickup point position at step 300. FIG. 10 is a graphical representation of a MPS pick-up point area assessment. Assume that PP 1000 is a route, e.g., a highway or a major street with heavy traffic. Buyers R, S, and T each have a buyer's chosen route. Buyer R has chosen route RR 1010, buyer S has chosen route SS 1020, and buyer T has chosen route TT 1030. Also assuming in the beginning, a MPS server does not have any route information pertaining to buyers R, S, and T, then the MPS server can only use an approximate method to choose a pickup point, for example, point U 1080. Under this method, buyers R, S, and T have to travel out of their chosen channels to get access to point U.

Assuming the buyer routes are available to the MPS server. The MPS server may overlap all chosen channels from all of the buyers to form an overlapped area QQ 1040. Area QQ may be qualified as a pick up point selection area because QQ is the area overlapped by multiple chosen routes, namely RR, SS, and TT. The MPS server may propose pickup points within this available pickup point selection area QQ to a buyer wishing to pick up a product.

Now assume that points W 1050, X 1060, and Y 1070 are locations inside area QQ that the MPS server considers as possible pickup points. Also assume that point W is a parking lot in a major supermarket, W is also close to route PP, and easily accessed from route PP. The MPS server may select W to be a pick up point after the MPS server considers all the criteria. Point W may then be presented to buyers R, S, and T and W may be chosen as a pick up point. A buyer may then abandon their original pickup point U and position the new pickup point at W. The MPS server may propose more than one available pick up point in an available pick up point selection area depending upon buyer route concentration, e.g., X or Y may be selected as available pick up points also, if the MPS server desires.

In one embodiment of the present invention, a MPS server acts as a third-party delivery MPS server. A third party is a business entity that does not provide MPS server itself and have an agreement with a MPS server to use the MPS server services to serve the third-party's customer. For example, a local flower shop may receive orders online from a buyer. The flower shop allows the buyer to access a MPS server operated by an entity other than the flower shop so that the buyer can use the MPS server to position a pickup point and pick up flowers ordered there. This flower shop is a third-party seller.

Sometimes a third-party seller's customer may already have a preferred MPS pickup point established with a MPS server because of previous orders with other companies. In this case, the third-party seller only needs to confirm that the buyer wants to use the MPS service to pick up flowers ordered. The flower shop may then make arrangements with the MPS server so that the flowers ordered may reach the pick up point for the buyer to pick up. The arrangements between the third-party seller and a MPS server concerning the shipment of products from the third-party seller to a MPS warehouse may take many forms and will be discussed in more detail later.

Upon receipt of the third-party's products, a MPS server may search to see if the buyer has other orders that can also use MPS service. If the buyer does have other orders, the MPS service may group all orders pertaining to the same buyer and use a single MPS to deliver those products to a MPS pickup point for pick up by the buyer.

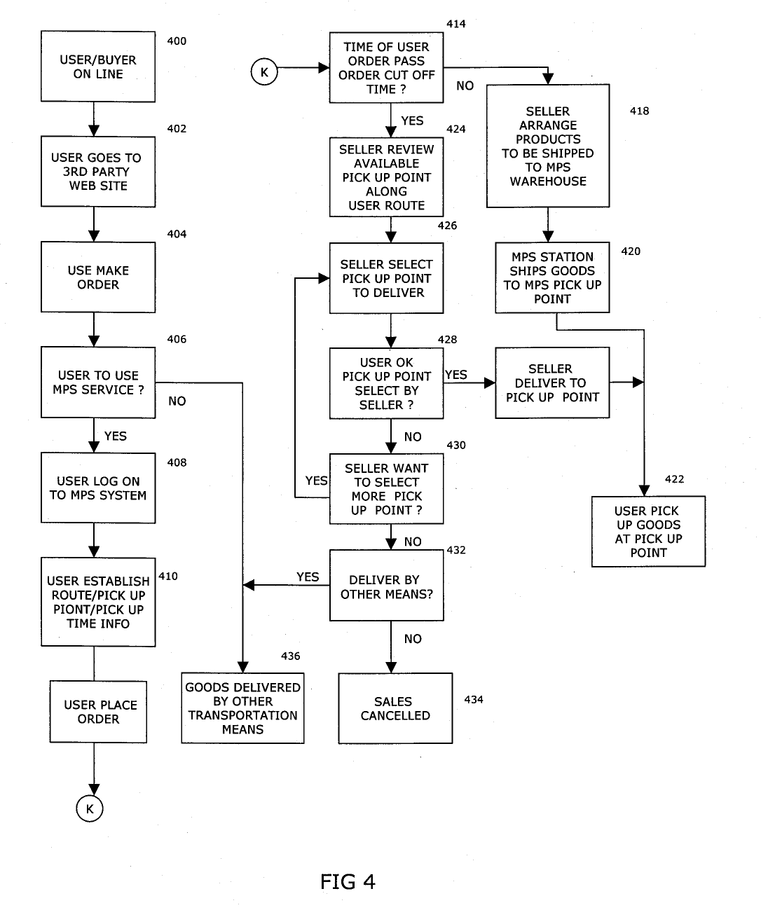

FIG. 4 is an example of a process flow diagram of a third-party seller ordering process. A buyer goes on the Internet at step 400, and goes to a third party's Website at step 402. The buyer creates orders at step 404, the buyer then makes a decision as to what delivery options the buyer will use at step 406. The buyer decides if he/she wants to use conventional delivery methods to ship his/her order, which usually involves shipment by common carriers (e.g. UPS or USPS), or uses a MPS service so that the buyer can pick up his/her order at a pickup point. Assuming the buyer wants to use a MPS service, he/she goes to a MPS server Web site at step 408. A link is established at the web page to connect the user to the MPS server.

At the MPS server website, the buyer may either set up to establish a pick up route and pick up point with the MPS server, or update route and pickup point information already established with the MPS server from previous purchases with the MPS server at step 410. The third-party seller keeps a record of the buyer's order together with all related shipping information. The user may be transferred back to the seller's website to complete some administrative details such as payment, etc.

The third-party seller may establish an order cutoff time, which is the latest time for order receiving. An effective cutoff time allows the seller enough time to pack and arrange ordered products to ship to a MPS warehouse before a MPS server dispatches to MPSs to pickup points. For example, assume a MPS leaves a MPS warehouse and then heads for a MPS pickup point at 3:30 PM. Also assume that it takes 30 minutes for the seller to process and pack orders, and it takes another 30 minutes for the products to be shipped to the MPS warehouse, the order cutoff time will be set at 2:30 PM. If a buyer orders before the cutoff time at step 414, the third-party seller then arranges the ordered products to be shipped to the MPS warehouse at 418.

There are various ways products can be shipped to a MPS warehouse, which will be disclosed later. Once ordered products are shipped to a MPS warehouse, the products are loaded onto a MPS and then the MPS moves to a MPS pickup point at step 420 and waits for buyers to pick up products at step 422.

In the case where a buyer orders after the cutoff time of 2:30 PM, as set in the above example, the third-party seller may impose an extra delivery fee to deliver the order to a preferred pickup point, and the buyer can pick up the order at that pick up point. In this case, the third-party seller logs on to a MPS server. The MPS server displays a map that covers the third-party seller's location and the buyer's route at step 424. The MPS server also displays the buyer's default pick up point and other available pick up points near the route. The seller selects a pick up point for delivery at step 426 and quotes the buyer the price of delivery to that pick up point. If the buyer agrees with the quotation and other terms at step 428, the products are delivered to the specified pick up point for buyer to pick up at step 422. If no pickup point is satisfactory to the buyer, other arrangements have to be made at step 436, or the sale is cancelled at step 434.

As previously noted when discussing step 418 of FIG. 4, various arrangements for the shipment of products from a third-party seller's store to a MPS warehouse may be made. These arrangements may take many forms.

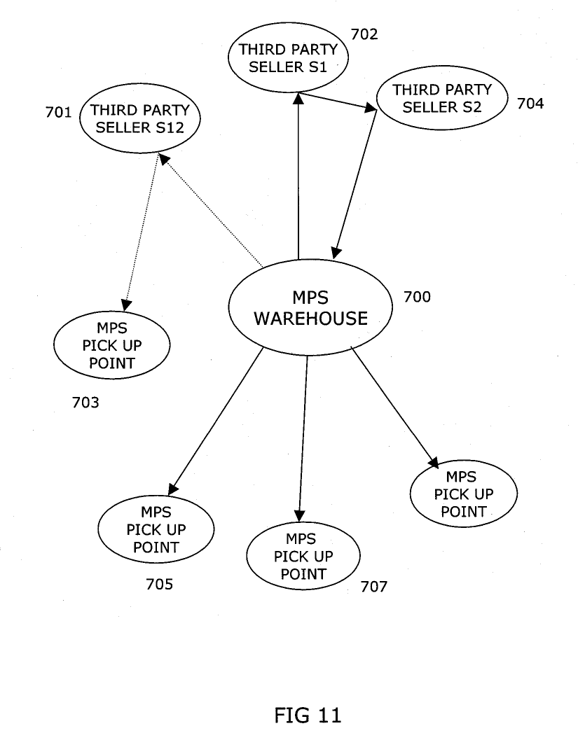

In one embodiment of a MPS server, as illustrated in FIG. 11, a MPS warehouse 700 may send out transportation equipment, e.g., MPSs, to the warehouses of a third-party seller S1 702 and a third-party seller S2 704 to pick up products ordered by buyers. The MPSs then go back to the MPS warehouse for packing and processing. The MPSs are dispatched to pick up points such as 705 and 707 with user orders loaded or it may, after picking up orders from a third party seller (e.g., S12 701), go directly to the assigned pickup points 703 for the user to pick up goods ordered.

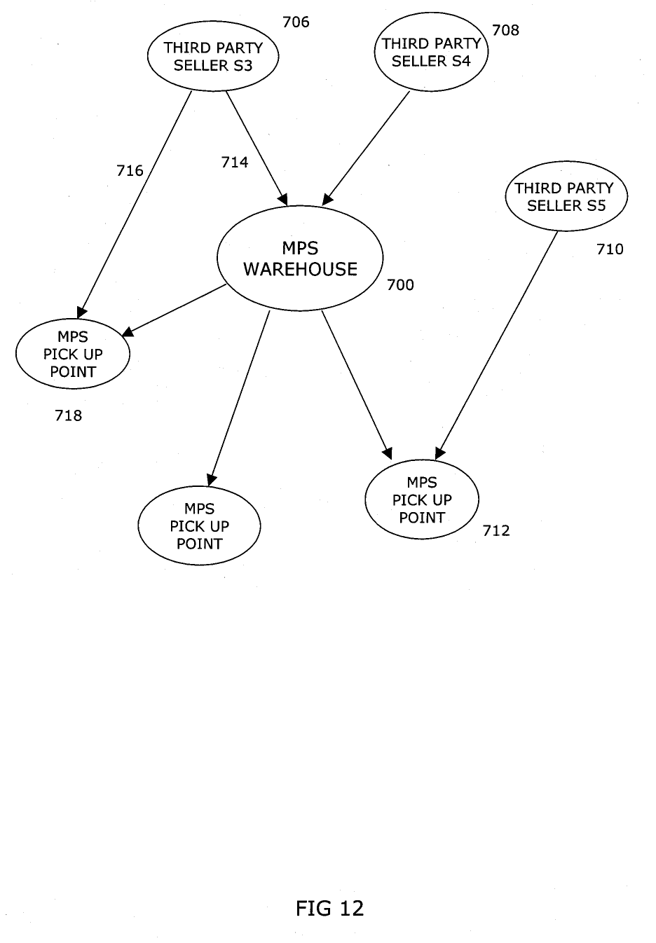

In an alternative embodiment of a MPS server, as illustrated in FIG. 12, a third-party seller S3 706 and a third-party seller S4 708 may ship buyer-ordered products to a MPS warehouse 700 by their own transportation means or by common carriers for further distribution. S5 710, another third-party seller, which is local to one of the pick up points 712, may choose to ship buyer ordered products directly to the pick up point 712. A MPS that stays at pickup point 712 receives the products and waits for a buyer to pick up the products. Third-party seller S3 may use route 716 to deliver a portion of orders directly to a pickup station 718 and at the same time deliver another portion of orders to the MPS warehouse 700 for further distribution.

The MPS with stations at 712 may be a movable trailer or a movable kiosk. A second MPS station may ship buyer orders to the MPS station and loads these orders to the MPS. The second MPS may leave the pickup point, and the MPS will house the orders and waits for buyers to pick up these orders.

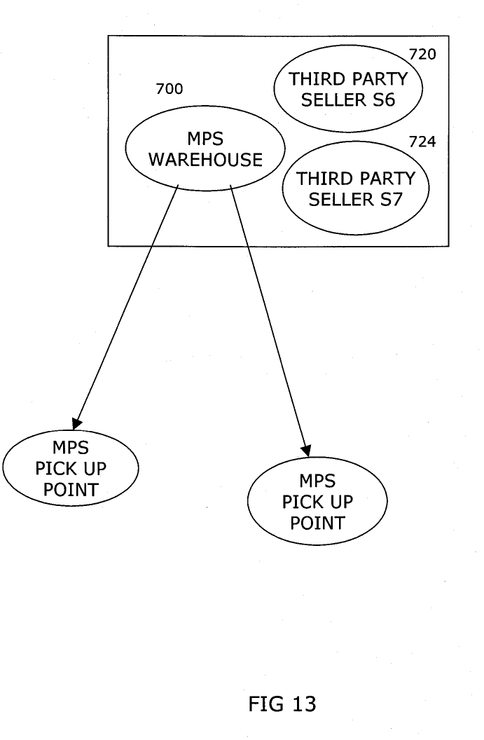

In another alternative embodiment of a MPS server, as illustrated in FIG. 13, third-party seller S6 720 and third-party seller S7 724 may be at the same location with a MPS warehouse 700. Orders may then be transferred to a MPS distribution center. The third-party sellers may be different entities that share the same warehouse or they may be different divisions that belong to the same entity. In this model, because the third-party sellers are so closely located to each other, the order cutoff time can be close to the time MPSs are dispatched to pick up points.

One embodiment of a MPS server provides for a channeled route search method in which the MPS server utilizes the commuting route and channel building technique previously described to carry out searches for products buyer wants to purchase. For example, a buyer wants to buy a car battery so the buyer goes to the Internet and logs on to a MPS server in search mode. The MPS server displays a map. A buyer may click or depress and drag the buyer's mouse on the map to define a route. The buyer may further define a width of a channel to form a channeled route and may search within this channel for stores that carry the products the buyer wants to purchase.

Referring again to FIG. 7, the buyer, through clicks or drag of mouse defines route 570. Assuming the buyer wants to search for a store with ¼ mile distance along the buyer's commuting route, the user sets a channel-width size of ¼ mile. The MPS server displays a channel 572 with boundaries 578, 580. Each boundary is ¼ mile apart from the route 570. The MPS server will later search to see if there are any stores within the channel that carry the product the buyer wants. The MPS server accesses a database that contains stores with information such as name, products carried, product price, address (with zip code), and telephone number, etc.

The MPS server first determines all the zip codes that are covered by the channel. A zip code is covered by the channel as long as any portion of the zip code area is within the channel. For example, zip codes 92001 and 92003 are covered by channel 572. Zip code 92005 and 92009 are not. The MPS server goes to a database to search for all stores that carry car batteries with zip codes 92001 or 92003. All the car battery carrying stores with zip codes 92001 or 92003 are selected for the next test, and those stores with other zip codes, e.g., 92005 or 92009, are disregarded. If no stores are found in this search, the buyer may change the width of channel or change the buyer's selected route to launch another search. If there are stores that carry car batteries with channel-matching zip codes (i.e., with zip codes that match 92001 or 92003), the MPS server saves these stores in memory and goes to the next step.

The MPS server searches for all the street names covered by (or within) the channel. Any street name or avenue name is covered by (or within) the channel as long as any portion of the street or avenue is inside the channel. For example, the channel covers Texas Street 592 and also Robinson Ave 594. The MPS server compares all the street names within this channel to the street name of those stores with matching zip codes selected from above step. At this stage, all car battery carrying stores, with matching zip codes and with street names matching any of the street names within the channel are selected for the next test and the others are disregarded. For example, after the zip code test, all stores with street names such as “Hawthorn Street” 582 are disregarded and all stores with street names such as “The 31st Street” 584, Texas Street 592 or Robinson Ave 594 are selected for the next test. This is because Hawthorn Street is not covered by the channel, but 31st Street and Texas Street are. Again, if there is no match found, the buyer can either enlarge the width of the channel or change the buyer's commuting route to launch another search.

If there are stores that match the above tests, the MPS server goes to the next step. The MPS server, after the buyer defines the width of the channel, can determine the street numbers (or street addresses, as sometimes called by people) at the boundaries of the channel. That is, the MPS server can determine the street numbers of points such as M 588 and N 590. The MPS server then determines if those matching stores from the above steps have street numbers that fall between the boundary points such as M and N. If a store does have a street number that falls between boundary points like M and N, the store is selected and is presented to the buyer; if not, the store is screened out and disregarded. For example, suppose the MPS server determines the address number of M 588 is 2002 31st Street and the address number of N 590 is 1800 31st Street, then a store with street address number 1900 31st Street will be selected and a store with address 2300 31st Street is disregarded. If no store is selected, the buyer can modify channel width and commute route to perform another search. After the buyer finds the stores that carry products the buyer wants to buy using this search method, the buyer can go to the store's web site and place the order. The buyer then decides whether the buyer wants to use a MPS service for pick up. If the buyer chooses to, the MPS server goes to step 406 (FIG. 4) and continues the procedures as previously described.

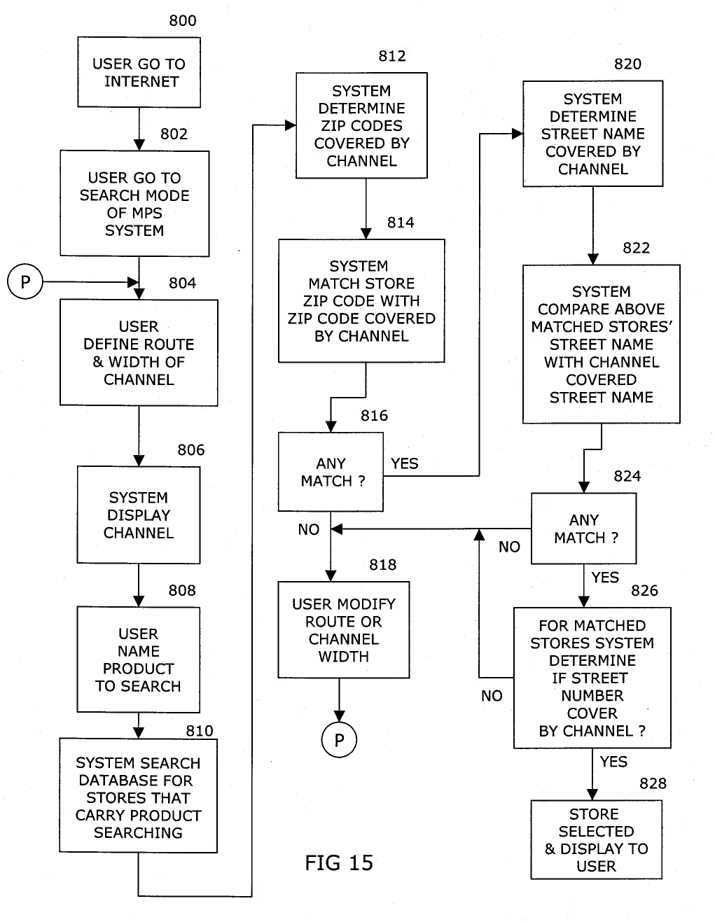

FIG. 15 is an example of a flowchart presentation of the above search method. A buyer uses a Web browser to access a MPS server at step 800. The buyer enters a channel search mode at step 802. The buyer defines a route and a channel as previously described in step 804. The MPS server displays the channel to the buyer at step 806. The user selects a product to search for at step 808. The MPS server searches a store database for stores carrying the requested product at step 810. The MPS server determines channel zip codes covered by the channel as previously described at step 812. The MPS server matches the channel zip codes found in step 812 to store zip codes of stores found in step 810. The MPS server may determine if any store zip codes match any channel zip codes at step 816. If no matches were found, the buyer is invited to modify the search parameters at step 818.

If the MPS server determines that there are matches between the channel zip codes and the store Zip codes, the MPS server determines the street names covered by the channel in step 820. The MPS server matches store street names to channel street names to determine if a store might fall within the channel at step 822. If there are no matching store street names and channel street names, the buyer is invited to redefine the search parameters at step 818.

If the MPS server determines that there are matches between the channel street names and the store street names, at step 826, the MPS server determines if a store street number is within the channel boundaries previously described. If there is a store street number within the channel boundaries, the MPS server displays the store to the buyer at step 828. If there are no store numbers within the channel boundaries, then the MPS server invites the buyer to redefine the search parameters at step 818.

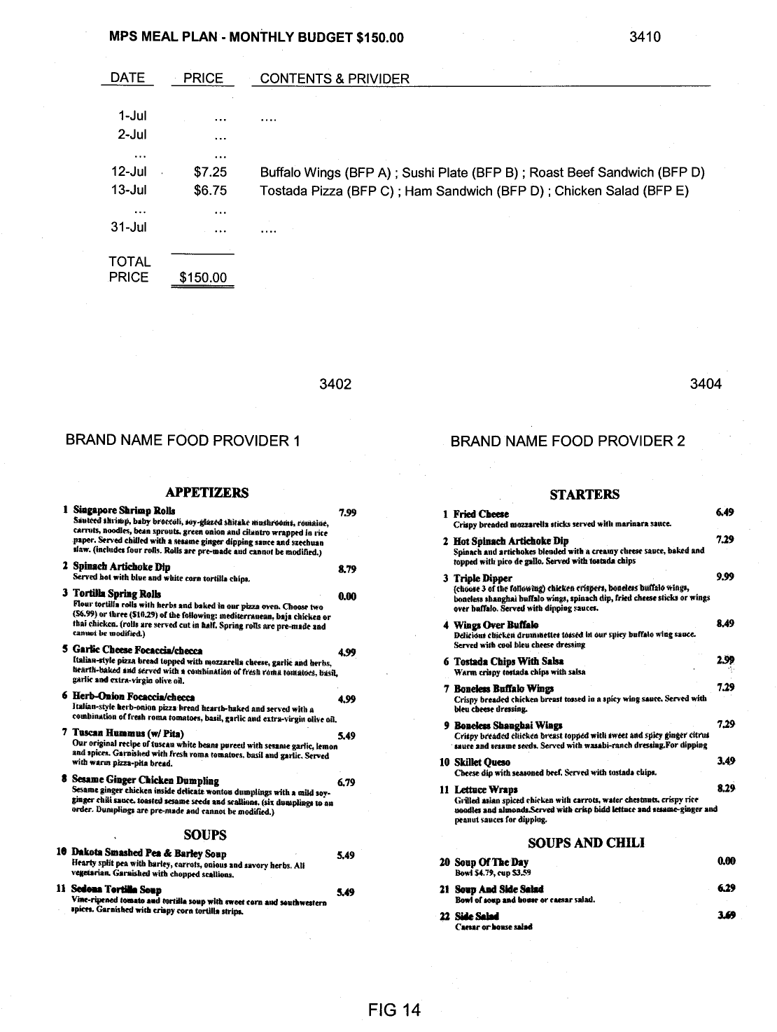

In one embodiment of a MPS server, the MPS server allows a third-party seller to search for another third-party seller within a specified territory. This method is the “Territory Search Method” referred to earlier. Referring again to FIG. 14, third-party seller S8 750 may use this method to locate affiliated third-party sellers S9 754 and S10 756 that are within a territory 780 of a MPS warehouse 700 that serves a buyer's 752 preferred pick up point 774. The MPS server may operate on a territorial basis, i.e., a MPS warehouse may be assigned a regional territory 780 and serve a number of pickup points 774 and 778 that are within its territory while other MPS warehouses may cover and serve other pickup points 768 within the other MPS warehouses' respective territories.

When the buyer places an order with third-party seller S8 and the buyer wants to use MPS services, the buyer may tell third-party seller S8 a pickup point ID number that is assigned and used to identify the buyer's preferred pickup point. Third-party seller S8 may then transmit the buyer's pickup point number along with all the addresses of its affiliates to the MPS server. The MPS server may use the transmitted buyer pickup point number to identify the MPS warehouse that serves the buyer's preferred pickup point.

In this embodiment of a MPS server, every MPS warehouse may be assigned a territory. A MPS server's territory may be determined by a MPS server according to criteria such as: number of buyers served, buyers' demographic distributions, distances a MPS has to travel, time a MPS spends when traveling to MPS pickup points etc. Every territory, e.g., 780, has its boundary, e.g., 782, and may be in different shapes as needed, e.g., it may be in the shape of a rectangle, circle or other irregular shapes. Each point on the boundary has a known distance and relative direction to the MPS warehouse; therefore, the street address of each point on the boundary can be determined.

The MPS server may then determine the zip codes and street names that are covered by the territory using the same method as previously described in the channeled route search method. Along with the affiliates' addresses provided by the third-party seller S8, the MPS server may be able to identify those affiliates that are within the territory of the MPS warehouse which serves the buyer's pick up point. Using the same procedures as used in the channeled route search method, the MPS server may first screen out those affiliates with zip codes not covered within the territory. The MPS server may then screen out those affiliates with street names not covered by the territory. Finally, by establishing the addresses at the boundary, the MPS server may determine those affiliates with addresses that are covered by the MPS warehouse territory. The MPS server may then present these affiliates to the third party seller S8 for selection.

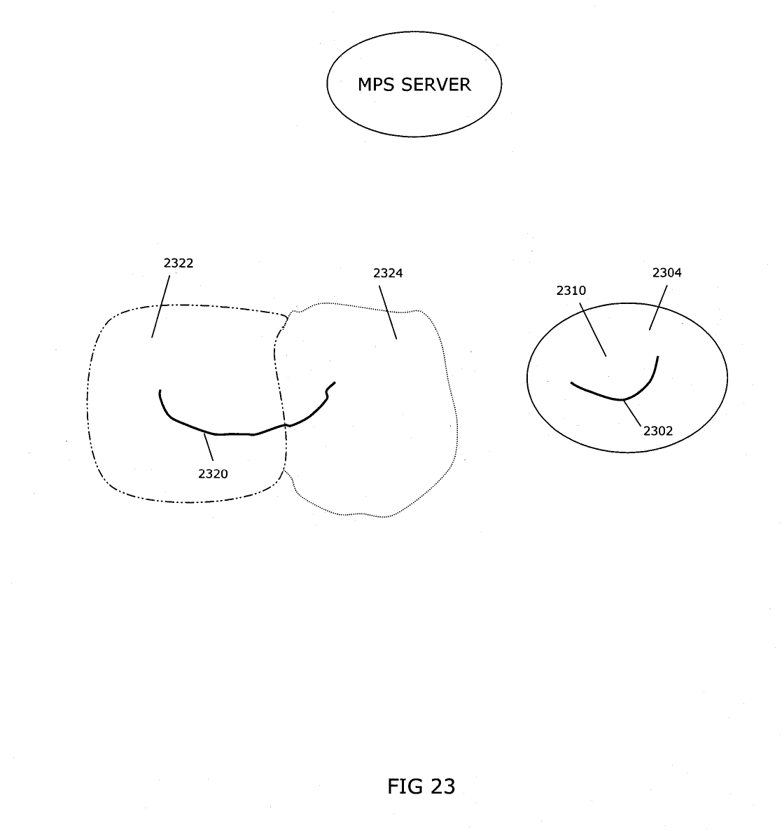

Referring now to FIG. 23, in a MPS server in accordance with an embodiment of the present invention, the MPS server is operated with multiple MPS warehouses. In this embodiment, each warehouse covers its own territory. The buyer/user goes to a MPS web site, inputs the beginning and ending address to define his/her route. The user may use other information such as zip codes, telephone numbers or landmarks to define his/her route as described before. The MPS server, according to this user route information, determines the territory that serves the user. For example, route 2302 is covered by territory 2304 that is assigned to warehouse 2310. A user route may be covered by more than one territory; for example, route 2320 is covered by territory 2322 and territory 2324.

In one embodiment of a MPS server, a buyer specifies another party to pick up the buyer's products. The buyer may use a MPS server to modify the pick up point to be a place where a pick up person (a recipient) prefers. The buyer can also specify the name of the pick up person and request that a MPS operator check the ID of the person who picks up the product to ensure proper pick up. In the case where the MPS is a locker kiosk including a plurality of lockers, the buyer can pass the code that is used to open the locker to the receiver, so that the receiver can open the locker to take the product out. In the case where the MPS server is operated by an entity that engages in the business of delivery or transportation, the service that the MPS server provides is the transport of the buyer's product or packages to a pick up point the pick up person desires and waits for the pick up person to retrieve them.

In one embodiment of a MPS server, the MPS server establishes Fixed Pickup Stations (FPSs), which are fixed structures such as buildings or offices that have the capacity to store user orders. For example, there may be stores, e.g., gasoline stations, convenience stores or super-markets, etc. that are located within the previously described available pick up points selection area. The MPS server may wish to contract with these stores to be pick up stations for MPS buyers. If a store agrees and an agreement is reached by the entity operating a MPS server and the store operators, the store becomes a FPS and may be one of the pick up points that are available for MPS buyers to select as pick up points. The server may then display these FPSs the same way it displays MPSs for the user's selection. After a user selects the FPS he/she wants his/her order to be shipped to, the MPS server may arrange for products ordered by buyers to be shipped to the FPS. Each FPS station may be used as a pick up point as well as a drop-off point, the same way as a regular MPS.

In another embodiment of the present invention, the FPS is equipped with temperature control equipment such as refrigerator, freezer and heater to store food products. In another embodiment of the present invention, the FPS is equipped with at least one cooking implement for the FPS operator to cook or prepare a user order. The server may select to equip a FPS with any one or more of the following cooking equipment, such as an oven, microwave oven, stove, sink, water supply, gas supply, or any other cooking equipment as long as the operator may use the provided equipment to fulfill intended cooking or preparing functions. In operation, the server may display FPSs, and the user may select a preferred pick up point (a FPS in this case) following the same process as a MPS pick up point selection as described. The server may then ship the food that a user ordered (fully cooked, partially cooked or uncooked) from its central kitchen to the user-selected FPS. The user may then pick up his/her order at the selected FPS. The FPS operator stores user food orders in a refrigerator or a heater. The FPS operator may, depending upon the nature and the requirements of the order, use the cooking equipment provided to cook or prepare these partially cooked or uncooked orders to their fully ready conditions before giving them to the user.

A MPS may be a receiving station as well as a drop-off station. A drop-off station is a station where a user submits packages to the MPS personnel the user wants the MPS service to ship to a receiver. The MPS server, after receiving packages dropped off from the user, ships the packages back to a MPS warehouse for distribution. After distribution, the packages may be shipped to a MPS pickup point that is convenient to the receiver's commuting route or by other means, such as by a common carrier, e.g. UPS, for delivery to a receiver. In the case where a MPS server is a delivery or transportation business entity, such as FedEx, a MPS can be used as a pick up station for designated recipients to pick up their packages. A MPS can also be used as a drop-off station for users to drop the packages they want the MPS server to ship to the package recipients. Again, after a MPS receives such packages from a user, the MPS will ship the packages back to a MPS warehouse for distribution.

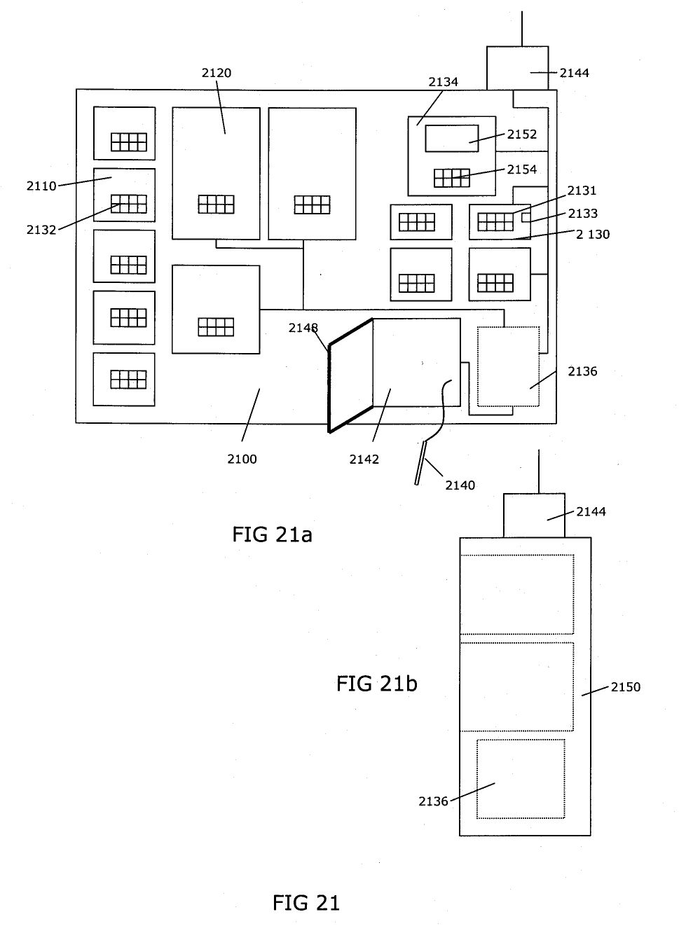

Referring now to FIG. 21a and FIG. 21b, in a MPS locker station in accordance with an embodiment of the present invention, the MPS locker station 2100 with side view 2150 includes a plurality of lockers, such as lockers 2110, 2120, and 2130, which enclose products ordered by the buyers. Each locker is electrically coupled to a microprocessor or controller 2136 for operation of the locker kiosk. The controller is electrically coupled to the lockers by a keypad as exemplified by keypad 2131 and an electrically actuated lock or bolt as exemplified by electrically actuated lock 2133 of locker 2130. This locker kiosk, herein referred to as “locker station,” is portable and is transported to an assigned pick up point after the locker station is loaded with products the buyer ordered and will be stationed at the pick up point during the station time. The locker station, like other kinds of pick up stations, has the capacity to carry all types of products. For instance, in one embodiment of a MPS kiosk, in addition to the ability to carry general non-perishable products, the MPS kiosk is equipped with a cooling device to carry food or floral products. The cooling system, just like those installed on other pick up stations, may be a refrigerator powered by electricity or solar power. The cooling system may also be an insulating system that is cooled by ice, dry ice or other means. The lockers 2110, 2120, 2130 installed on the locker station 2100 may be opened by using an entry code (i.e., a password) assigned temporarily to the locker and given to a buyer. Lockers may vary in size. A buyer, after completing his/her order, may receive a locker identifier (e.g., a product ID) and an access code (e.g., a password) to open the locker. The buyer goes to the pick up point where the MPS locker station is positioned, and uses the identifier and access code to identify and open the locker to receive the product ordered. In one embodiment in accordance with the present invention, the locker station is secured to the ground or a wall by a lock so that it cannot be easily moved. In this way, it may not be necessary for an operator to attend to the kiosk during operation.

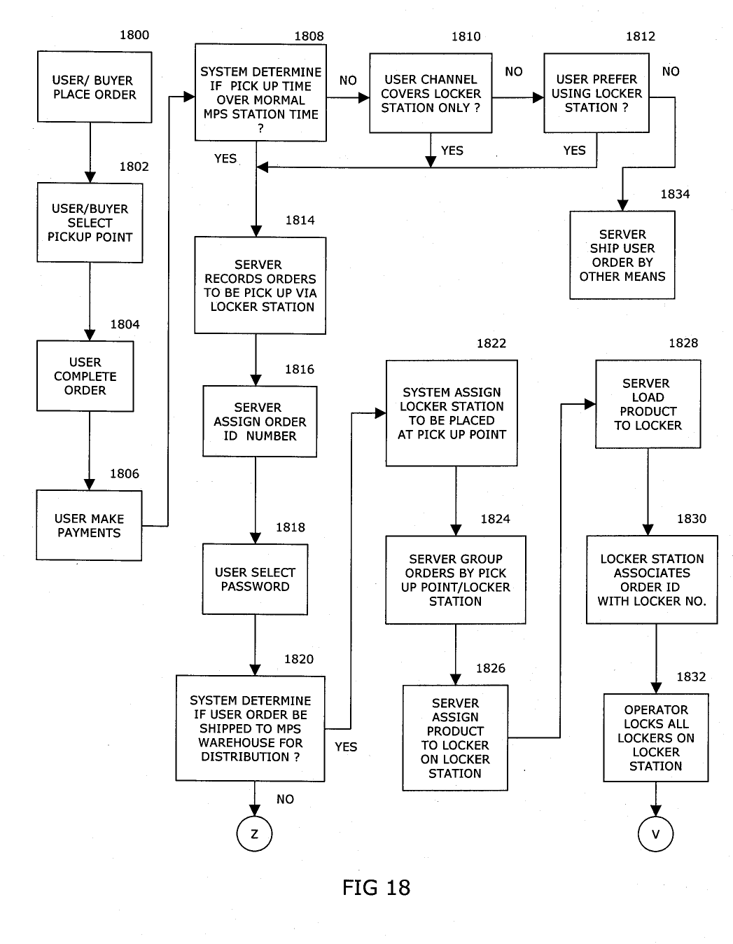

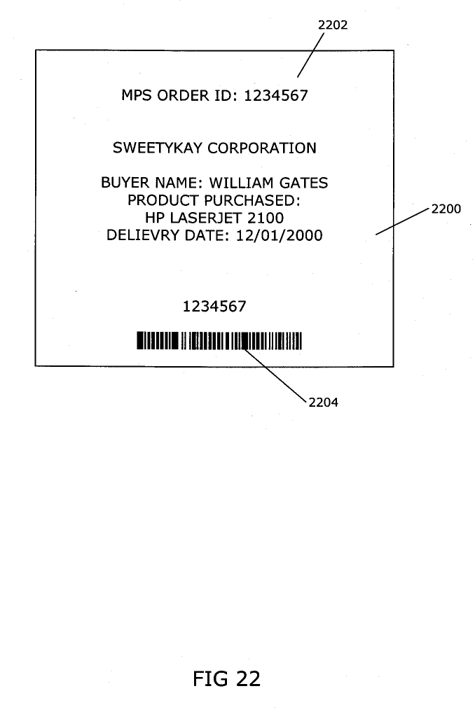

Referring now to FIG. 18, FIG. 21, and FIG. 22, a user/buyer may place an order 1800 and select his/her preferred pick up point 1802. When the user completes his/her order 1804, he/she makes payments. The payments may be made by using credit card, check, or other means 1806. Steps 1800 to 1806 are similar to steps 100 to 174 of FIG. 1 as described before. The system may review the user's entry for pick up time and determine if the user's preferred pick up time surpasses the normal MPS station time. A locker station, because it can be operated without an operator, can be assigned a station time much longer than that of a normal station that is attended by an operator. A user's order may be assigned to a locker station if the user wants to pick up an order at a time that surpasses normal station time 1808. Also, the user may be assigned to a locker station to pick up his/her order, if his/her preferred channel covers locker station 1810, or the user prefers to pick up at a locker station 1812. The user's order may be shipped by other means, e.g. normal MPS station, etc., if it is not transported by locker station 1834.

The server may record the orders that will be handled by locker station 1814. The server may then assign an order identifier (an ID number) to the user for his/her order 1816. The order ID may be the seller's sales order number or other numbers defined by the seller. In one embodiment, the seller may use the MPS server's shipping document number 2202 (FIG. 22) as the order ID. The MPS server may generate and send to third-party sellers for their uses, shipping labels 2200 with bar codes 2204 that represent shipping document number 2202. The seller fills out the necessary information on the label and may attach the label to the outside of the order package. The uses of the label will be disclosed later. The user may make a record of this order ID number as he/she will use this number later to find the locker that contains his/her order. The user may select a password at step 1818.

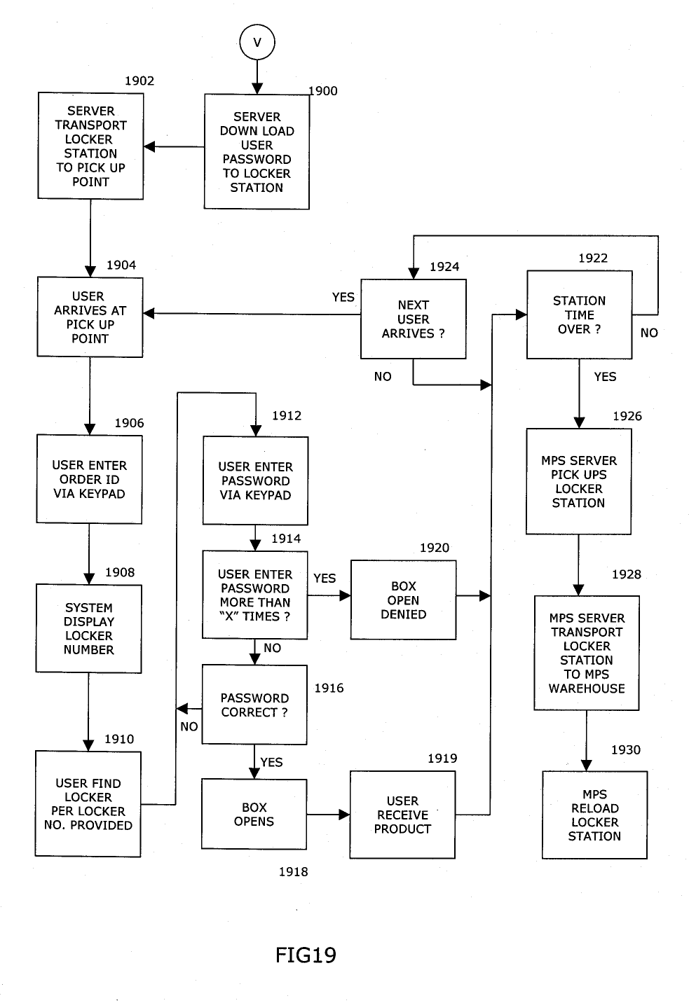

In another embodiment in accordance with the present invention, the MPS server arranges to have user orders placed by a third-party seller to transport to a MPS warehouse, and then the server loads these orders to a locker station 1820. In this embodiment, the MPS server either has the third-party seller ship orders to a MPS warehouse, or the operator of the MPS server picks up these orders from third-party sellers, and then ships them back to a MPS warehouse where locker stations are waiting to be loaded. The MPS server assigns each locker station a pick up point to where the locker is to be placed at 1822. The MPS server groups orders by pickup points. The operator of the MPS server then transports those orders to the locker station that will be placed at the pick up point 1824. The MPS Server then assigns each order with a locker (e.g., locker 2120, FIG. 21) to be stored in 1826. The MPS server assigns orders to lockers based upon order sizes, product character (e.g., perishables like food or floral products may be assigned to a locker with cooling capacity) or other criteria such as a handicapped or short user's product may be placed in a lower locker for his/her convenience, etc. The operator of the MPS server then loads product into the assigned locker 1828. The MPS server then registers the product order ID with the locker, so that the system may relate product order ID to its storing locker 1830. In a registration process in accordance with an embodiment of the present invention, the operator deposits user orders into a locker 2110, then the operator uses keypad 2132 (FIG. 21) on the locker to enter the product ID displayed on the product package into the locker's system. Because each locker has a keypad installed on its door and each keypad is separately wired to the microprocessor or controller 2136 of the main keypad 2134, the microprocessor can relate the product order ID to its storing locker. The microprocessor contains memory means to record the product ID entered through each keypad. In another embodiment of the registration process in accordance with the present invention, the operator can use an optical scanner pen 2140 to scan the bar code 2204 on the MPS shipping sticker 2200 (FIG. 22). The sticker is placed on the outside of the order package by the seller. Each locker has an optical scanner pen wired to its inside. FIG. 22 shows a locker 2142 with a door 2148 opened and a scanner pen 2140 wired to the inside of the locker. Each scanner pen is separately wired to the microprocessor of the main keypad. The shipping sticker contains a bar code 2204 that represents the product ID 2202. By scanning the bar code with the scanner pen, the microprocessor relates each locker with the product order ID of the product it stores. After the operator loads all the orders into lockers, the operator locks all the lockers on the locker station 1832. The operator then downloads, from the MPS server, user passwords to the locker microprocessor 1900 (FIG. 19). The locker station then registers these passwords. In one embodiment in accordance with the present invention, the download is performed through a wiring connection from a MPS server to a locker station's microprocessor. In another embodiment, the download is performed through a wireless radio transmission between the MPS server and the radio transmission device 2144 (FIG. 21) connected to the locker microprocessor. The operator of the MPS server then transports the locker station to its assigned pick up point 1902. The locker station stays at the pick up point. A locking device may lock and fix the station to the ground or to a wall so that it cannot be easily removed. When the user arrives at the locker station 1904, he/she keys in the order ID through the main keypad 1906 (also 2134 FIG. 21) by using keypad 2154 (FIG. 21). The microprocessor finds the locker that related to the order ID. The display device 2152 (FIG. 21) on the main keypad 2134 (FIG. 21) displays the locker number of the locker that stores user orders 1908. The user then finds the locker storing his/her order by locker number provided 1910. At step 1912, the user keys in the password by using the keypad 2132 (FIG. 21) on the locker 2110 (FIG. 21). If the password is entered correctly, the locker will open 1918, and the user receives the product in the locker 1919. If the user enters a wrong password, the system asks the user to enter it again 1912. If the user fails a certain time of password entries, the user is denied entry into the locker 1920. The station stays at the pick up point for a determined station time; within this station time, the station serves other users that arrive 1924. When the station time is Up, the operator of the MPS server recovers the locker stations 1926 and transports the locker stations back to a MPS warehouse 1928 for reloading 1930.

Referring again to step 1820 of FIG. 18, in another embodiment of a MPS system in accordance with the present invention, the MPS truck may carry locker stations and travel to third-party sellers to collect user orders, and then goes directly to the assigned pick up point without going back to a MPS warehouse.

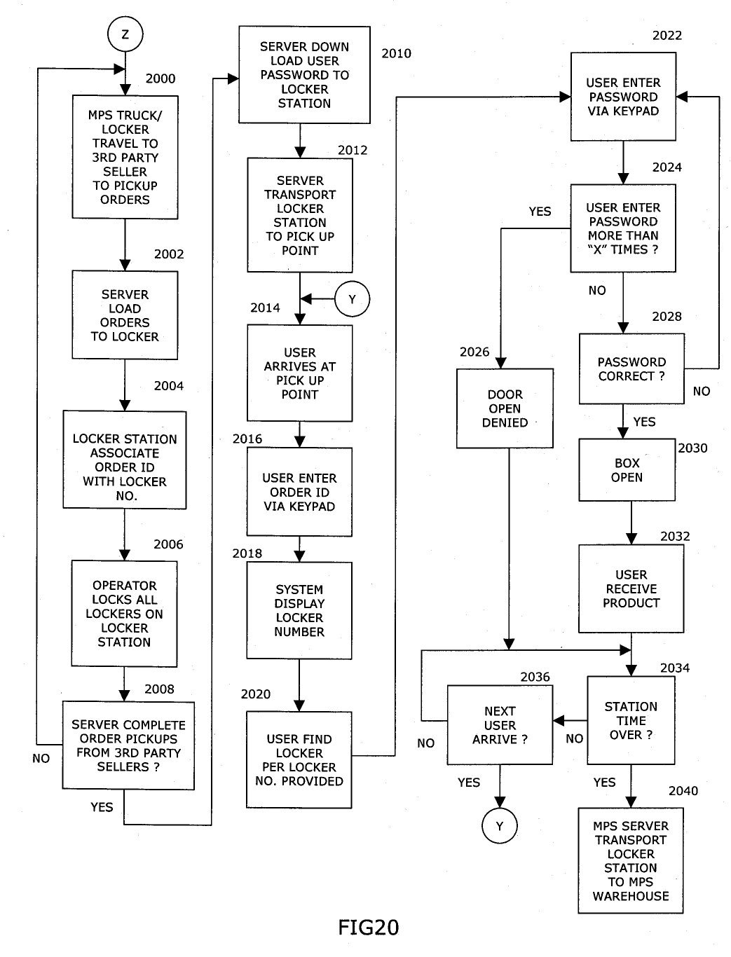

Referring now to FIG. 20, the MPS truck travels 2000 with lockers to third-party seller to pick up user order. The MPS operator then selects a locker to store the order he/she just picked up 2002. The operator then registers order ID with locker 2004 and locks all the lockers 2006. Steps 2002 to 2006 is similar to steps 1828 to 1832 of FIG. 18 and can be understood by referring to these steps. The MPS truck/locker travels to other third party sellers to collect orders until all orders are collected 2008. The operator of the MPS server may download a user password through wireless radio transmission between the MPS server and the radio transmission device connected to the locker microprocessor 2010. Steps 2012 to 2036 describe the steps from the locker station's arrival at pick up point to the completion of station time, which are similar to steps 1904 to 1922 of FIG. 19 previously described and not repeated here. At step 2040, the MPS locker station is transported back to a MPS warehouse when station time is over.

In another embodiment of locker station in accordance with the present invention, a locker station may be fixed at a pick up point as a FPS (Fixed Pickup Station) described before and cannot be moved. In this embodiment, the operator of the MPS server ships user orders to the locker station and loads the lockers with orders. The MPS server may receive user pickup information transmitted from the locker station on a regular basis so that the MPS server may monitor the activities of the locker station.

If the user fails to pick up his/her order in time, the operator of the MPS server may decide that it will ship those products back to the same pick up point for the user to pick up again. The user may not want to change the password and the locker that stores the order. The operator of the MPS server may establish a policy that allows users to pick up products within a determined number of days. Beyond this predetermined period, the product may be returned to the sender or handled in a way according to the operator of the MPS server's policy.

In one embodiment in accordance with the present invention, it should be noted that a locker station can also be a drop off point. In this embodiment, the user goes to a MPS system and tells the system the size of the drop-off load. If the MPS server determines that a locker will be available for receiving a drop-off, the system gives the user an order ID and allows the user to set up a password. The user goes to the pick up station and then keys in the order ID and password into the main keypad. If the order ID and password are entered correctly, the microprocessor opens the locker, and the locker is available for the user to deposit the package he/she wants to drop off. The user may post instructions on the package as to how he/she wants the package to be handled. The user may give the order ID and the password to a third party receiver. The third party receiver can use the order ID and password to find and open the locker and retrieve the product.

Referring again to FIG. 4, when a user/buyer goes to a third party seller's web site and purchases online 404, the user decides if the user wants to use MPS service as a delivery method 406. If the user wants to use MPS delivery service to pick up his/her order, he/she may go to step 408 to get access to the MPS system and then select a pick up point. The significance of step 408 may be explained by the following example: when a user goes to a third party seller website, e.g., Amazon.com, to purchase goods, the user must tell the third party seller, i.e., Amazon.com, the address where the order is to be delivered. Amazon.com then uses this address to prepare shipping label. A shipping carrier then ships the order to the shipping address according to the shipping label. During the process, the user must know the delivery address beforehand. However, in the case where the user wants to use the MPS service and to have the MPS system ship his/her order to a pickup point, it is highly likely that the user may only know the general locality of the pickup point and not its exact street address. This leaves the user unable to inform the third party seller of the location where his/her order is to be shipped. To solve this problem, a link may be installed at the third party seller's web page so that the user may be linked (transferred) to the MPS system. In the MPS system, a pick up point may be selected. Once the pick up point is selected, the address of the pick up point is then transmitted back to the third party seller system so that the third party seller may be informed about the address of the selected pick up point and may use the address to prepare the shipping label. The selected pick up point where the user may pick up his/her order is established in step 410. Pick up time may be established in step 410 also.

There are at least two different ways a user may log on to the MPS system for pick up point selection. In one embodiment, the user is transferred (or linked) to a MPS server website from the third party's website. In this embodiment, the MPS server maintains a system that handles all the functions in pick up point selection. The MPS server may also maintain a database that keeps all users' information, such as preferred pickup points, pickup times, addresses, orders, user preferences, etc. The third party seller, if in need, may log on to the MPS server website to get access to this information. The MPS server may collect order information, such as order sizes, pick up point, pickup time, user name, etc., from all third party sellers and arranges MPS stations dispatched to user pickup points. In another embodiment, the MPS server, under arrangements with a third party seller, downloads the pick up point selecting system software to the third party's system. Under this arrangement, pickup points are selected within a third party's website (system). Order and pickup information are then transmitted to the MPS server for arrangement of shipments. The MPS server constantly updates the third party seller for pick up point changes, route changes, map changes, and/or any other changes. As disclosed, the system may select a pickup point for a buyer and dispatch a mobile pickup station to the pickup point. The mobile pickup station contains the product ordered by the buyer. The buyer may then pick up the buyer's order at the selected pickup point. There are many reasons the system may want to select pick up points for a buyer to pick up order. One of the reasons is that some of the pick up points may be too small to handle too many buyers. The server may then select other pick up points for the buyer to use in order to ease the traffic on the small pick up points.

It should be noted that throughout the present invention, the server may present various identifiers, such as route, channeled route, zip code, telephone, landmark, etc. to define a pick up point.

When a zip code (or a telephone number or a landmark, etc.) is used as an identifier, the MPS entity may choose to place available pickup points along a highway (or a street off-ramp to a highway or a major street) within the zip code (or a telephone number or a landmark, etc.). This is because a highway (or a street off-ramp to a highway or a major street) may be assumed to have heavy traffic and may be used to place available pickup points. A gas station or a shopping center parking lot that is along an off-ramp street of a highway and near the highway may be a good candidate for pickup point selection.

Food Delivery Service

In another embodiment of the present invention, a MPS, which may be a vehicle, a kiosk or a trailer, is equipped with refrigerator(s) and/or food heating device(s) to carry or store food products. The MPS may further be equipped with microwave oven(s) and is capable of heating up or cooking the food carried that is ordered by the user/recipient. The MPS may further be equipped with other cooking equipment and supplies that allow the operator(s) of the MPS, e.g., the driver and/or helper, to cook (or prepare) food in the MPS. The MPS may be equipped with one or more of the cooking equipment and supplies, such as a stove, oven, microwave oven, sink, refrigerator, cookware, water supply, gas supply, water tank, package material, sanitary equipment, etc. to perform cooking or preparation functions. The MPS may further be equipped with facilities such as toilet(s), first aid equipment, fire extinguisher(s), etc. that may accommodate the need of a MPS operator(s) when it stations at a MPS pick up point. The MPS may be also equipped with telephone(s), computer(s), wireless transmitter(s) and/or receiver(s) so that it can communicate with a MPS server, access the Internet, access the MPS Intranet, or communicate with other parties. In an exemplary use of the present invention, a MPS server is a food service provider, e.g., a caterer or a restaurant. A user/customer uses the service provided by the MPS server to order food and select preferred pick up location for pick-up as described. The server then collects all the user orders and groups these orders by user names and by pick up locations. The MPS server loads these grouped orders to the corresponding MPS station and dispatches the MPS station to its assigned pickup location for pickup.

Another embodiment of the present invention involves a system of preparing and scheduling user orders by the server after users determine their preferred pickup points. When preparing user orders, the MPS server (or a partner restaurant that uses the MPS service to deliver its food) may fully cook (or prepare) the user order, partially cooks (or prepares) the order in its central kitchen before the order leaves the production facility and is loaded to a MPS. User orders may be uncooked when it leaves production facility and is loaded to a MPS. The server loads the MPS with user orders and dispatches the MPS to its assigned pick up location. The server (or a partner restaurant that uses the MPS service to deliver its food) makes a decision to fully cook, partially cook or not cook user order according to the nature of the order. For example, the server (or a partner restaurant that uses the MPS service to deliver its food) may fully cook/prepare orders such as garden salads, chicken salads, cold cut sandwiches, sashimi or chicken noodle soup, etc. and pack those foods ready in its central kitchen before loading these orders onto the MPS. The food orders are then stored in the refrigerator or heater in the MPS and transported to their pick up location. The MPS server (or a partner restaurant that uses the MPS service to deliver its food) may partially cook/prepare some of the user orders such as chicken á la king, prime rib, roast beef, crawfish étoufee, etc. in the central kitchen, and then load it onto the MPS and ships to the MPS pickup location. The MPS operator may further cook or microwave these partially cooked orders in the MPS its ready to consume condition during the time the MPS is dispatched to its pick up location or the operator may further cook or microwave the order to its ready to consume condition when parking and waiting at the pick up location. Alternatively, the operator may further cook or microwave the order to its ready to consume condition just before the estimated time of user (or recipient) arrival or at the time of user arrival when parking and waiting at the pickup location. In the present invention, the term “partially cooked” means orders are cooked but not to the point of its normal readiness for consumption.

The server (or a partner restaurant that uses the MPS service to deliver its food) may keep orders such as fried chicken, French fries, pizzas, etc., uncooked when loading these orders onto the MPS. The MPS is then dispatched to and waits at the pickup location. The operator waits until the estimated user arrival time is up or until the time the user arrives at the pickup station and starts to cook. The user order may be a combination of fully cooked orders, partially cooked orders, and uncooked orders. The MPS operator may, after these partially cooked and/or uncooked orders are prepared, pack them with cooked orders, and then hand the complete package to the recipient at the time of the recipient's arrival.

The server may schedule the timing of preparing (or processing) user orders for the MPS operator(s) to follow. Because a user tends to arrive at the pick up point at about the same time every day, the MPS server may determine a user's usual arrival time at the user selected pick up point. The MPS server may also determine the time the MPS operator needs to prepare and complete each user order in the MPS. Based on this information, the MPS server may produce a working schedule for the MPS operators to follow in preparing user orders.

The server may use the following procedure to determine the user's usual arrival time at the pick up point. The MPS operator collects the time of user arrival at the pick up point each time the user arrives. The operator then sends these records to MPS server. The MPS server keeps and compiles those records to determine the user's usual arrival time or the server may ask the user to enter the user's preferred pick up time during user registration and use the user input to determine user's usual arrival time.

Once the usual arrival times of all users and the preparation time of all user orders are determined, the server may prepare a working schedule for the MPS operator to follow for the preparation of user orders. The MPS operator(s) then prepares/cooks user orders according to the schedule.

The server may delegate to the MPS operator to produce the operator's own working schedule by using this information.

Besides using projected arrival time for the user as a basis to prepare user orders, there may be other timing methods used by an MPS operator or a third party affiliate to prepare or cook user order products, such as:

A) The user may communicate to the MPS operator by phone, Internet, Palm Pilot or any other communication means to notify the MPS operator of the user's arrival time at the MPS pick up location. The MPS operator may then use the communicated arrival time as user arrival time together with the user order preparation time to determine the timing of preparing user orders.

B) The user and the MPS server may install devices that utilize location determination technique, such as Mobile Location Determination System (MLDS), Global Positioning System (GPS) or car navigation system, etc. A tracking device installed with the user, along with the device installed with the MPS server, may allow the MPS operator (or the MPS server) to detect the user's current location and/or traveling directions. The MPS operator (or the MPS server) may periodically update the user's current location information by using these technologies and use this information to estimate the time of user arrival and prepare the user's order accordingly.

C) A user order may be prepared at the time of the user's arrival at the pick up location. This approach is suitable for an order that requires a short amount of time (or no time) to prepare by a MPS operator to its ready to consume condition. As an example, assuming a user's order is chicken noodle soup, the server may fully cook the order in its central kitchen and stores the order in the MPS refrigerator. The order is cold when user arrives. Because it takes only a few minutes to heat it up, the operator may wait until the user arrives, then heat up the order and give it to the user/recipient. This approach is also suitable for orders that require immediate consumption after preparation, such as French fries, fried chicken, etc.

d) Some items in an order may be partially prepared or cooked in the central kitchen. The item then leaves the central kitchen in the partially prepared or cooked stage and is loaded to a MPS and shipped to a MPS pick up point. An item is partially prepared or cooked when it is prepared or cooked to a stage where further preparation or cooking is needed to bring the product to its normal ready-to-consume condition. An item may be partially prepared to a stage that a specific further cooking time, e.g. two minutes, is needed to bring the item to its ready-to-consume condition. The additional cooking time, e.g., two minutes, may be determined by the MPS server and may be applied to a segment of food items, or all the food items, delivered through the MPS service. The MPS may publicize the further cooking time to buyers.

Under this system, a MPS operator or a buyer can easily remember the time needed to further process an item.

Different food items may have different desired partially prepared stages. A MPS entity, or a partner restaurant that produces a food item, may determine the desired partially prepared stage for a food item. There are several ways to prepare a food item to its desired partially prepared stage. One way is to prepare the item according to cooking time. For example, if an item needs 10 minutes to be fully cook. A 90% partially prepared stage may be reached by cooking the item by 9 minutes.

This further cooking or preparation may be easy enough for the user to do it himself/herself. If a user wants to take these orders home and do this further heating/preparation personally instead of having the MPS operator do it, the user may indicate so when he/she places the order. The MPS operator may hand these orders over to the user at his/her arrival without further preparation.

Handling instructions that contain packaging and storage information and other information such as further cooking time and temperature needed, etc. may be attached to the outside of user orders.

Cooking equipment in a MPS station may be removable and/or replaceable. For example, a refrigerator may be replaced with an oven when more cooking activity is needed at the MPS station and less storage space is required.

The MPS server may be in affiliation with one or more Brand-Name Food Providers (BFP) such as Red Lobster, Chili's, Mimi's Café, to incorporate these BFPs' products into the MPS delivery service. A BFP is a food service provider, such as a restaurant, that sells its food products using a brand that does not belong to the MPS server.

In one of the embodiments, the MPS entity and BFPs, through arrangement, may be located with each other in one building, one location or one compound. Through such an arrangement, the MPS server may conveniently collect all BFPs' products in the MPS central kitchen/warehouse, process these products, and load these orders to corresponding MPS stations and dispatch these MPS stations to MPS pickup points. The arrangements between the MPS and a BFP may be that the MPS server leases spaces of its central kitchen to the BFP(s) and vice versa or the MPS may co-own the central kitchen with a BFP(s).

All the methods, processes, and procedures disclosed in the present invention, such as ASM method, route selection, channel selection and pickup point selection can also be applicable to BFP customers and their orders. Note that in the present invention, it is possible for a user to place different orders to different BFPs that are affiliated with the MPS server and conveniently receives all orders at one pickup location. For example, the user may order steak from restaurant A and seafood platter from restaurant B and receive all orders at once when he/she arrives at the pick up point the user selected. A and B are all in affiliation with the MPS server as BFP members.

The MPS server may operate a web site. The MPS server may be affiliated with one or more BFPs and may designate a section of its web site to a BFP with which the MPS server is affiliated. A buyer may log on to the MPS server's web site and click on a BFP icon to get access to the BFP's product menu. The product menu may be a drop down menu that contains a list of the BFP's products, or it may be a webpage that displays the BFP's products. A BFP may constantly update the product menu. The products may be disclosed with product specifications and pricing information. The buyer may click on a product to order it. As an alternative, a link may be established on the server's web site. The link may connect a buyer to the BFP web site. The BFP website displays the product information, and the buyer may place an order for the product at the BFP web site. Here, a customer may decide if he/she wants to use the MPS delivery service to pick up orders. An icon connected to a MPS module may be presented to the BFP's customer. After a user completes his/her order at the BFP web site, the user may click the icon. The buyer is then transferred to the server's website. At the web site, the buyer may use MPS service to select a MPS pick up point.

In other words, there may be at least two options a user may use to get access to a BFP's (or a third party seller's) product. The first option is that the MPS server may list a BFP's or an affiliated third party seller's products on the MPS web site and a user may order the seller's product on the server's web site. As a second option, the MPS server may establish a link on its web page. The link connects the user to the third party seller's website; the user may then place an order on the third party seller's website.

In the first option, the user may select the third party seller's product through a product list or product catalog presented on the MPS server's web page. The third party seller or BFP constantly updates the product list or product catalog. After the user completes his/her order, the order information such as name of the buyer, product ordered, MPS pickup point information, pickup point address, product preferences, etc. is transmitted to the BFP or third party seller by fax, by telephone or via the Internet. The BFP or the third party may use this information to produce the order and prepare shipping label. The shipping label, which includes buyer's name, pickup point address (or pick up point ID code), and other information, is attached to the order by the BFP for delivery and for identification after the BFP packs the order. The BFP is the producer of the order.

The server may display available pickup points for the user's selection by a map. Or, the server may display available pickup points by using a list. The buyer may click on a pickup point to identify the pickup point to where the buyer wants to pick up his/her order. The server then finds the address of the pickup point and relates this address to the buyer's order. The server then transmits the pickup point address information together with other order information to the BFP or third party seller for preparation of shipping label. The shipping label designates the select pickup point as shipping address. The BFP or the third party seller then produces the order, packs the order, and attaches the shipping label to the order. The BFP or the third party seller may pack the order to a state where the order is ready to be picked up by the buyer, i.e., it is sealed, boxed, labeled with shipping label, etc.

In the second option, the user is linked from the MPS website to a BFP's or a third party seller's website. The user may place an order in the BFP's or the third party seller's website by clicking at the product icon presented in the BFP's or third party's webpage. The user, after completion of ordering, may be linked back to the MPS server website to complete other details such as making payment or determining pickup points, etc. and the third party seller collects all the order and delivery information to produce user orders and prepare shipping documents and shipping labels. A shipping document and a shipping label all contain information of shipping address. The shipping address is the address of the selected pick up point of an order.

The supplier, e.g. a BFP or a third party seller, may be responsible for preparing a buyer order (e.g. cooking or retrieving the order from inventory), packing the order, and labeling the order to a state (i.e. boxed, sealed and labeled) where it's ready to be picked up by the buyer. The supplier of a meal order (e.g. a BFP) may pack all orders and affix the shipping labels to corresponding orders in its store for a MPS to pick up.

Because the MPS entity may delegate order preparation (e.g. retrieving the order from inventory, packing and labeling) to its supplier (i.e. BFPs) and may not be involved in order preparation other than picking up and delivering orders, the cost to a MPS entity with regards to shipping and handling is low.

After production, the orders may then be arranged to be shipped to a MPS distribution center and distributed to pick up points by using arrangements described in FIG. 11, FIG. 12 or FIG. 13. For example, the MPS entity may send out MPSs to BFPs to pick up products produced by BFPs. After the MPSs collect orders from BFPs, the MPSs return to the MPS entity distribution center for order processing and order distribution. Orders are unloaded and grouped by pickup points and buyer ID (e.g. buyer name). Each MPS is assigned with a pickup point. Orders that are to be delivered to the pickup point are loaded to the MPS. The MPS is then dispatched to the pickup point waiting for orders to be picked up. The MPS server may make pre-arrangement with a BFP (or third party seller) and set up a time to pick up the order from the BFP or third party seller. The MPS server may dispatch a MPS to the BFP or third party seller on or after that time to pick up the order. The food products a MPS deliver may be perishable. A MPS can be equipped with a refrigerator and/or heater. The perishable food products the MPS truck carries are stored in the refrigerator and/or heater (a temperature controlled condition) to keep the food products within a temperature range that meets government requirements, e.g. at or above 135 degrees Fahrenheit, or at or under 41 degrees Fahrenheit.

To remain the freshness and the quality of a food product a MPS service delivers, the food product can be prepared to its ready to be packed condition and then be packed to its ready to be delivered condition on the day of its delivery.

Because server may spend a significant amount of money to promote the server's website and lure a buyer to come to the server's website to purchase, failure of a BFP or third party seller to make available the buyer's ordered product may hurt the server's reputation. An agreement may be made between the server and the BFP or the third party seller in which a penalty may be imposed on the BFP or third party seller to compensate the MPS server and/or the buyer if the order is not available for pickup at the BFP at the agreed upon time. A similar penalty may be imposed on the MPS server if the BFP or third party seller has its product ready and the MPS server fails to pickup the order. To assure a buyer guarantee of delivery, the server may establish a compensation plan and announce the plan to a buyer before the buyer signs up with the server. The compensation plan compensates the buyer if the buyer's order is not available for the buyer to pick up or if it is not to the buyer's satisfaction when the buyer arrives at the pickup point within the MPS station time. Such a compensation plan may include the server compensating a buyer a certain amount of cash on the spot when the buyer comes to the pickup point during the station time and the buyer's order is not ready or satisfactory. The compensation may not be limited to cash; it may, for example, be a credit against future purchases, gift certificates, etc.

Because a MPS may pick up orders from a number of BFPs, the MPS server may plan a route and follows the planned route by sending a Mobile Pickup Station to pick up orders at each BFP (or third party seller). The planned route may specify the time a Mobile Pickup Station arrives at each BFP. The time a Mobile Pickup Station arrives at a BFP is determined by several factors, such as the travel time needed to travel to the BFP, the time needed for the BFP to prepare the orders, loading time of orders, etc. The time a Mobile Pickup Station arrives at a BFP is communicated to the BFP and agreed upon by both parties beforehand, and the BFP may be obligated by agreement to have its orders ready for the Mobile Pickup Station to pick up at the agreed upon time. Failure of having the BFP's orders ready for the Mobile Pickup Station to pick up at the agreed upon time may subject the BFP to a penalty. The orders are then shipped to a MPS warehouse for distribution to corresponding pickup points. These orders are then loaded to a MPS and shipped to the corresponding pickup point for pick up. In another embodiment, the orders are not shipped to a MPS warehouse for distribution, but shipped directly to a pickup point for pick up. In any case, the MPS stays at the pickup point to allow user to pick it up. The pickup point may be a fixed structure known as a Fixed Pickup Point as previously described.

The MPS server may provide any one of the following identifiers, such as route, channeled route, overlapped route, overlapped channel, address with channel, zip code, telephone number, city name or landmark, etc. to a buyer so that the buyer may identify the preferred area of picking up his/her order. The server may display these available pick up point(s) defined by the area to the user. The user may select a preferred pickup point for picking up his/her order or, as an option, the server may select a pickup point for the user to pick up his/her order.

In case an order is a food item, the order needs to be stored within a proper temperature range. Because a MPS station may be equipped with proper equipment to store food and most passenger cars are not, a pickup point close to the buyer's home may selected to avoid long exposure of the food item to room temperature. In this case, an identifier based on a buyer's home, e.g. the buyer's home zip code or the buyer's home telephone, may be used for pickup point selection. The server may then select a pickup location for the buyer to use based on the distance between the buyer's home and a pickup location. For example, the server may compute the distances of all available pickup locations to the buyer's home, select a pickup location that is closest to the buyer's home, and deliver the buyer's order to the pickup location for the buyer to pickup. The closeness of a pickup location to the buyer's home may be defined by straight-line distance, driving distance or traveling time as discussed previously.

One of the features of the invention is that the buyer may place different orders to different BFPs and receive all orders from these BFPs in one visit to a pickup point.

A BFP may license its brand name and/or recipe to a MPS server, and the MPS personnel may produce, in the MPS central kitchen according to the BFP's recipe, the products that bear the BFP's brand name. The products may then be incorporated into the MPS delivery function as described and are delivered to the selected pickup points waiting for pickup. The MPS server may develop its own brand of food and sell its own food by using the MPS delivery system. The MPS server may operate its business model by 100% partnership with BFPs without its own brand name, 100% use its own brand name without partnership with any BFP, or in partnership with some BFPs and at the same time develops its own brand name.

The following are other embodiments in the present invention:

I) In another embodiment of the present invention, orders are accepted and delivered with “No Tips, No Delivery Fees, and No Minimum Orders”.

In one embodiment of the present invention, a large number (e.g. hundreds, such as four or five hundred or more) of meals are delivered to a single pick up location waiting for pickup as opposed to being delivered door to door. Delivery costs (such as fuel costs, driver wages, depreciation) are thus eliminated. Because the orders delivered are large in quantity, the MPS entity, when acting as a delivery carrier, can spread the delivery costs (e.g. driver wages, fuel costs, depreciation) to all orders, and find that delivery costs per sales dollar (or per order) are low. By so doing, the MPS entity can afford to absorb all delivery costs and may deliver meals to a buyer without delivery fees charged to the buyer. In this embodiment, a MPS entity institutes a “No Delivery Fee” policy, i.e. it operates by performing the present methods without charging delivery fees, as explained further below. Under this policy, a customer order will be accepted and delivered without delivery fees charged to the customer by the MPS entity (the deliverer) and/or by the seller of the order regardless of the total price of the order and/or the quantity of the order. That is, in this embodiment, a customer order will be accepted and delivered without delivery fees charged to the buyer even though the order contains only one ordering unit of an item and the item is the lowest-priced item sold via the MPS service. One “ordering unit” of an item is the basic unit to order the item (such as a dish or a meal).

In one embodiment of the present invention, an MPS driver is compensated with a much higher salary than the salary paid by a conventional meal delivery business. (In the conventional meal delivery industry, a driver is typically paid with minimum wages and relies on tips from a buyer as compensation.) As discussed, in an MPS operation, a large number (e.g. hundreds, such as four or five hundred or more) of meals are delivered to a single pick up location waiting for pickup. Because the orders delivered are large in quantity, the MPS entity, when acting as a delivery carrier, may spread its driver's wages to all orders and can afford to pay its driver a higher salary. Because a MPS driver (delivery personnel) is paid enough by the MPS entity, the driver (delivery personnel) does not need to collect tips from a buyer and still earns a compatible income. In the embodiment, a “No Tips” policy is established by the MPS entity. “Tip” referred to herein is defined as compensation received by a delivery personnel (e.g. a delivery truck driver) from a buyer (or a recipient) for the delivery service of the products the buyer purchased. Under the “No Tips policy”, a customer order is accepted and delivered with no tips to be received (or expected to be received) by delivery personnel regardless of the total price of the order and/or the quantity of the order. Also, under this policy, no tips are charged to a buyer by the shipper/deliverer (e.g. the MPS entity) or by the seller regardless of the total price of the order and/or the quantity of the order. That is, a customer order is accepted and delivered with no tips to be received or expected to be received even though the order contains only one ordering unit of an item and the item is the least-priced item sold. In other words, under the “No Tips” policy, a delivery personnel of a delivery entity, e.g. a MPS entity, receives (or expects to receive) compensation for delivering an order only from the entity he/she is employed even if the order contains only one ordering unit of an item and the item is the lowest-priced item sold through the delivery entity ”

In one embodiment, orders with the same pickup location are aggregated and dispatched to the pick up location waiting for pickup. Because all buyers with the same pick up location come to the location to pick up orders, the incremental cost of delivering an extra order (to be exact, the incremental cost of “passing” an extra order to a buyer) at the pick up location is near zero. The MPS entity may thus afford to deliver an order even if the sales price of the order is very low. Therefore, in the MPS delivery model, a minimum order requirement for an order can be eliminated. By contrast, in the conventional meal delivery model, the incremental cost of delivering an extra item (which is the cost incurred when a delivery personnel travels to the next delivery location to deliver the extra item) is never zero and can be significant. This is the reason a business entity in the conventional meal delivery model sets up a minimum order requirement to justify a delivery. In the embodiment, the MPS entity eliminates the minimum order requirement. That is, the MPS entity sets up a “No Minimum Order” policy. The elimination of minimum order requirements increases the customer base of the MPS entity. For example, almost all conventional meal delivery services will reject an order of a $7.00 meal from a single person, because the industry typically requires a minimum order of $15.00. However, the order is acceptable by the MPS service because of no minimum order requirements.

With the “No Minimum Order” requirement, a customer order is accepted and delivered regardless of the total price of the order and/or the quantity of the order. That is, under the “No Minimum Order” policy, a customer order is accepted and delivered even though the order contains only one ordering unit of an item and the item is the lowest-priced item sold through the MPS service. In this embodiment, any order placed by a buyer through the MPS entity will be delivered by the MPS entity.

A meaningful minimum order is one in an amount that is higher than the unit price of the lowest-priced item sold. That is to say, if a seller (or a MPS entity) allows a buyer to place an order that contains only one ordering unit of an item and the price of the item is not higher than the price of the lowest-priced item sold through the MPS service, then there is no need to establish a minimum order requirement. For example, if on the MPS web site, the lowest unit price of an item is $5.00 and if the MPS entity accepts an order of $5.00, a minimum order requirement is unnecessary and meaningless. In this example, a meaningful minimum order must be higher than $5.00.

The above policies may help the MPS entity gain a large customer base and generate many sales. The large customer base and large sales may in turn help to maintain the viability of the MPS model. The MPS entity may amortize its fixed overhead over the large sales it generates, resulting in a lower fixed overhead per sales dollar. Therefore, even though the MPS entity is paying delivery costs without being reimbursed by buyers, the total cost (delivery cost plus fixed overhead) per sales dollar of a MPS entity may not be higher than that of a conventional meal delivery entity. However, the sales volume of a MPS entity would be much larger than that of a conventional meal delivery entity and have a larger profit potential.

In the MPS meal delivery model, a BFP may be deemed a supplier of the MPS entity. Orders from a BFP may be pre-packed and labeled by the BFP to the extent that it is ready to be handed over to a buyer. In this case, the MPS entity may simply pick up the pre-packed orders from BFPs and deliver them to a pick up location. Therefore, the operating costs of a MPS entity may be low. Since its operation costs are low, the elimination of minimum order, delivery fee, and tips should not be a burden to the MPS entity.

The “No Minimum Order”, “No Tips”, and “No Delivery Fee” steps of the present method may be included in a written policy and announced to the public. The policy may be used by the MPS entity to gain customers. The policy may state that no orders placed to a BFP through the MPS entity are subject to minimum order requirements, no buyers are charged with delivery fees (either by the deliverer or by the seller), and no delivery personnel (i.e. MPS truck drivers) expect to and/or are allowed to receive tips. Also, no delivery fees are transferred and charged to a BFP. The no delivery fee, no tips and no minimum order policies may be established on a long-term or permanent basis by the MPS entity.

The “No Minimum Order” policy allows the MPS entity to reach a larger customer base than a conventional meal delivery service can reach. The “No Tips” policy, as well as the “No Delivery Fees” policy allows a buyer to lower his/her effective cost when purchasing through the MPS model. Each of the above policies makes the MPS service more attractive than the service provided by a conventional meal deliverer.

In the MPS model, the commission a MPS entity charges to a participating restaurant may be the same as or no higher than the commission a bona fide entity in the conventional meal delivery industry would charge. Also, in the MPS model, when a buyer purchases a BFP's item thru the MPS entity, the buyer may pay a price no higher than the price he/she pays through a conventional meal delivery service. The above features are available because the total costs a MPS operation face can be no higher than those that a conventional meal delivery service face. When the MPS entity owns its own store and sells its own products through the MPS delivery service, it may sell the product at a price equal to it sells the product in its own store.

In the present invention, the “No Tips”, “No Delivery Fees” and/or “No Minimum Orders” steps of the present method can alternatively be defined as follows. A “No Tip” step can comprise the following: “delivering an order by a delivery entity, e.g. a MPS entity, with which one or more delivery personnel are employed. A delivery personnel receives (or expect to receive) only the wages from the delivery entity for delivering an order even if the order contains only one ordering unit of an item and the item is the least-priced item sold through the delivery entity.” The “No Delivery fee” step can comprise the following: “receiving compensation for the delivery of a product only from the seller of the product, even if the order contains only one ordering unit of an item and the item is the least-priced item sold through the delivery entity.” The “No Minimum Order” step can comprise the following: “accepting an order and delivering it with a delivery entity (e.g. a MPS entity) even if the order contains only one ordering unit of an item and the item is the least-priced item sold by the seller through the delivery entity (e.g. the MPS entity).

A “No Tips” and “No Delivery Fee” step or policy may also be described as follows: A buyer, when using cash to pay for a product or a service, is charged only with the listed price of the product or service plus the statutory fees (e.g. sales tax) associated with the purchase, even if the order contains only one ordering unit of an item and the item is the least-priced item sold through by the MPS service. When a buyer uses a credit card to pay for a product or a service, this step comprises charging the buyer only the listed price of the product or service plus statutory fees (e.g. sales tax) associated with the purchase even if the order contains only one ordering unit of an item and the item is the least-priced item sold through by the MPS service. The buyer can optionally be charged with a fee associated with the use of credit card (i.e., not directly associated with the production or delivery of a product), but a supplier (e.g. a BFP) and/or delivery agent (e.g. the MPS entity) may waive the charge of the fee to the buyer and absorb the cost in connection with the steps of providing products with no tips and/or no delivery fee. The fee associated with the use of credit card is not charged to the buyer when the buyer uses cash to pay for the purchase.

In the “No Delivery Fee” policy, if a MPS entity delivers and sells its own food, the MPS charges its customer for an order only the listed price of the order plus the related statutory taxes (e.g. sales tax) associated with the order even if the order contains only one ordering unit of an item and the item is the least-priced item sold through by the MPS service. The listed price is the same price a customer would pay if the customer consumes the same product in the MPS entity's store. When customer uses a credit card to purchase a product, a fee associated with the use of the credit card can be charged as discussed before.

The “No Tips, No Delivery Fees, and No Minimum Order” policy can be used by other business opportunities such as grocery deliveries. A MPS entity may use this policy to deliver products it produces or products produced by other entity (e.g. a BFP).

A MPS service may choose to institute any one, any two or all three of the “No tips”, “No Minimum Order” and “No Delivery Fees” policies.

One of skill in the art will appreciate that establishing a de minimus minimum order to circumvent the claims of the present invention may be deemed to be within the spirit of the present invention and is deemed to be covered by the invention. For example, if a company sets a minimum order of $1.00 when the lowest-priced item sold by the company is $5.00 a unit. Another example of such a de minimus minimum order is placing a low-price item unrelated to the seller's business on a seller's menu without bona fide business intention to sell the item. For example, in the case of a restaurant placing a five cent straw for sale on its menu, and setting a minimum order above five cents (e.g. at ten cents) In addition, charging a delivery fee to a buyer and at the same time reducing the selling price of the item purchased by the buyer as a way to reimburse the buyer for the delivery fee charged can be deemed as having no delivery fee charged.

II) In another embodiment, the MPS entity may use a system as follows to speed up the process of picking up orders: The MPS entity may divide a Mobile Pickup Station into racks. Each rack is identified by a rack number. Each rack may be further divided into cells (or compartments). Each cell may be identified by a cell address (or cell number). A cell address may be defined by the rack number, column number and the row number of the cell. Each cell may be installed with a temperature-controlling device to store food products. A sticker can be attached to the outside, e.g. the rim, of a cell. The sticker contains a bar code (the first bar code) which contains the cell number that identifies the cell. When a BFP packs a buyer's order, the BFP attaches a shipping label to the outside of the order package. The label contains a second bar code. The second bar code contains buyer information and necessary information to identify the buyer's order. Examples of buyer information may be: the buyer's name, telephone number, address, product information, pickup location information, the license plate number of the car the buyer drives, the description of the car the buyer drives, etc. A MPS operator is equipped with a device, preferably a portable device (such as a hand-held device) with a scanner. When a person (e.g. a MPS operator) loads an order into a cell, he/she can use the device to scan the first bar code attached to the cell and then scan the second bar code on the shipping label. A microprocessor in the device then relates the information contained in the first bar code to the information in the second bar code. One of skill in the art will appreciate that other electronic labeling technologies, such as those using RFID chips or other wireless technologies, can be used in place of barcoding.

When a buyer arrives at the pickup point, he/she may identify him/her self to the MPS operator with information such as name, address or telephone number, etc. The operator keys in this information to the device. The device then relays the buyer information to cell address information and locates the cell that contains the buyer's order. The hand-held device can then display the cell address of the buyer's order to the operator. The operator can then retrieve the order according to the cell address and hands the order over to the buyer.

Because a person usually drives the same car every day, a buyer can be identified by his/her car information. Such car information may be the license plate number of the car the buyer drives. The car information can include a description of the car the buyer drives, such as the make of the car and the color of the car, e.g. for purposes of verifying the license plate number information. When a buyer approaches the pickup location, the MPS operator catches the buyer's car information and can enter the buyer's car information, e.g. the license plate number, into the operator's device. The device can use the information, e.g. the car's license plate number, and relate it to the cell address of the buyer's order. The MPS operator can thus locate the buyer's order. A lamp or a similar device can be installed on the outside wall of every cell. The lamp can blink when the order is located by the device. In this way, the operator can easily spot the buyer's order.

A buyer's order may contain multiple items. The items may be loaded into different cells in a MPS truck. To facilitate this, the BFP who produces the order can attach each item with a shipping label that contains the same buyer information. When a person (e.g. a MPS truck operator) loads an item into a cell, he/she can use the device to scan the bar code attached to the cell and then scan the bar code on the shipping label attached to the item until all items are scanned and loaded. A microprocessor in the device then relates the information contained in the first bar code to the information in the second bar code. After all items are loaded to the truck, the device can display to the operator all cell addresses with the same buyer information. Therefore, if a buyer's order contains different items and the items are stored in different cells, the device can display to the operator all the cell address of the cells that contain the buyer's order. In this way, the operator can collect all the items in the buyer's order very easily. In addition, lamps can be installed outside the cells. These lamps can all blink so that the operator can identify and collect all the items in a buyer's order with ease.

The MPS entity may design a decal. The decal can be used to replace a license plate. The decal can have a number and the number may be registered with the entity. The decal can be used to identify a buyer's order as a license plate does as discussed.

The advantage of using the user's car license plate number to identify the cell address of an order is: the MPS operator can read the license plate number of the car a buyer is driving at a distance. That is the MPS operator can identify a car license plate number when a buyer approaches the pick up point. There is no need to communicate with the buyer personally in order to identify the buyer. A license plate normally contains a number of letters and numbers. The server may choose to use some of the letters or numbers on a buyer's license plate to identify the buyer's order.

III) In another embodiment of the present invention, the MPS entity can request a BFP to provide nutritional information of the meals the BFP produces. The nutritional information may include the calorie count, fat count, cholesterol count, sodium count, etc. of a meal. The nutritional count information can be displayed with the food the BFP produces and sells through the MPS's web site.

The MPS entity can collect a buyer's order history and use this information together with the nutritional information provided by the BFPs to monitor a nutritional item, e.g. total calories, the buyer presumably consumed (via the food the buyer has purchased) for a period of time. The entity may do so by compiling a total of the nutritional item in the foods the buyer has ordered for the period of time. For example, if the entity wants to know the total calories the buyer has consumed within the last twenty days, the entity may collect the food the buyer has purchased for the last twenty days and run the total calorie counts in each food the buyer has purchased for that period. If within the last twenty days there are days the buyer did not purchase food from the BFP, an estimate, e.g. an average of the nutrition count for these ordering days, may be used to approximate the total calories the buyer has consumed for these missing days. The entity may use the same method to calculate other nutritional items that are of interest and display this information to a buyer. That is, the entity may calculate and display to the buyer the total calories, fat, sodium and other items the buyer has presumably consumed during a particular period of time.

The MPS entity may collect a buyer's health information. The health information may include: the buyer's age, gender, blood pressure, cholesterol level, blood sugar level, triglycerides level, etc. The MPS entity may use a buyer's health information along with the buyer's food ordering history to determine if a nutrition item (e.g. sodium) has been consumed in excess and needs to be cut down. The MPS entity may come up with a recommended diet plan to the buyer. The entity may come up with a list of foods the buyer is recommended to purchase. The list of foods the entity recommends can further be screened by the preference information provided by the buyer. For example, if a buyer has consumed too much fat, the server may recommend the buyer to purchase foods with less fat. The food can further be selected according to the buyer's preference. The food items the entity recommended in a buyer's diet plan is preferably coming from the food items sold by a BFP the entity is affiliated with. In case the buyer wants the MPS entity to use the Automatic Selection Method (ASM) to order food for him/her, the recommended nutrition value for a nutrition item becomes a factor when the MPS entity orders food for the buyer.

When the buyer does not want to use the ASM method to order but prefers to order food manually, the MPS server can use the buyer's health information and/or the buyer's food ordering history to advise the buyer if the meal the buyer is ordering is unhealthy/healthy to the buyer. For example, if the buyer's triglycerides reading is 1300. The buyer orders a regular coke as a drink for his/her dinner. The MPS server may decide that the sugar content in the coke is unhealthy to the buyer considering the buyer's triglycerides reading. The entity may, at the time of receiving the order, advise the buyer that a coke is unhealthy to him/her. The MPS entity may do so by issue a warning. A warning may be in different levels. For example: a red warning may be very unhealthy, an orange warning may be unhealthy, a yellow earning may mean neutral, and a green warning may mean healthy. The MPS entity can determine a warning, whether is red, orange yellow or green, by a buyer's personal health information and/or ordering history. The MPS entity can review the nutrition information for all the items sold on its web site and use a buyer's health information and/or ordering history to post warnings by these meals. In this way, a buyer receives a menu with warning system that tailored to his/her personal health condition. The MPS server may hire a health care professional to administer such warnings.

IV) In one embodiment, a piece of LAM (Liquid Absorbing Material) is placed in a meal package.

A MPS truck may be equipped with a temperature control device. An example of such a device is a heating device (a heater proofer). A customer's order, e.g. Sea Food Pasta, may be kept in the device to be kept warm. However, in this setting, moisture evaporates from the surface of the food over time and the food becomes dry. A method to prevent moisture evaporation and dryness of the food is as follows: When a food item is stored in a container, moisture evaporates through its surface and goes to container space. If the container is stored in a heated condition, e.g. over 135 degrees Fahrenheit, more moisture evaporates from the food surface and goes to the container space. Some of the moisture in the container space comes back to the food item as a natural process. At the beginning of the process, the quantity of moisture that goes out of the food surface into the container space is more than the quantity of moisture coming back from the container space to the food surface. The process continues. Eventually, the amount of moisture that goes out of the food surface into the container space equals the amount of moisture coming back to the food surface. At this stage, equilibrium is reached.

The evaporation of moisture from food surface into container space causes the food item to dry. In addition, the imperfection of the container sealing (or a leakage in the container body) causes more moisture to evaporate from the food item. To prevent the effect of moisture loss on the food surface, a piece of Liquid Absorbing Material (LAM) is placed in the container. The LAM, acting as a sponge, is preferably made of food-graded material and is preferably transparent. The LAM is soaked with liquid, e.g. water, before sealed into the container. The LAM is preferably placed on top of the food to cover the food. As an alternative, the LAM may be installed on the inside wall of the container and is pre-soaked with liquid before the food item is put into the container. The LAM supplies moisture to the container space and causes equilibrium to be reached with less moisture coming from the food surface. This process reduces the dryness of the food. This device may be used to improve the quality of the food during storage. The container is sealed after the food item is put inside it. A hole (or holes) of selected size may be instituted on the surface of the container to release container pressure due to heating of the container and maintain proper moisture inside the container.

A container that contains food may be stored in a refrigerator with a piece of LAM inside it. When a consumer heats up such a container with a microwave oven, the moisture coming out of the LAM can act as a steamer. The process can heat up the food item and at the same time keep the food moist.

Another option to prevent the loss of moisture from the food surface is to cover the food item with non-water absorbing, airtight material to reduce the space moisture can go. Since a normal commercially available food container is rigid and not collapsible, the space between container walls and food surface exists. Moisture can evaporate out of the food surface and go into the space and the food item may become dry. The larger the space moisture can go, the more the moisture may evaporate out of the food surface, and the food surface becomes dryer. One way to reduce food surface dryness is to reduce the space moisture can travel. One way to reduce the space moisture can go to is to lay a piece of sheet-like airtight material on top of the food item. The material closely touches the surface of the food and surrounds the food so that the space between the food item and the sheet material is reduced to a minimum. The material does not have to wrap the food item from top to bottom because it is time consuming to do so. The preferred process is to place the food in the center of a container and then to lay the piece of the material on top of the food. The size of the material is large enough to cover the upper surface of the food and a portion of the material may touch the container wall so that the material and container wall may form a seal around the food. Because the sheet-like material is airtight and touches the food and container wall, the space moisture can go is very small. The process limits the space moisture that can go and reduces the amount of moisture that can evaporate from food surface. This is a very simple process because the material does not have to be water-soaked.

V) In one embodiment, a MPS entity may select a pick up location for a buyer to use based on the parking availability of the pick up location and the package volume of the buyer's order. Because pick up locations may have different parking capabilities, some pick up locations (such as gas stations) may have a limited amount of parking spaces, and some pick up locations (such as shopping centers) may have a larger amount of parking spaces. In this embodiment, the MPS entity sets up a rule for selecting pickup location for a buyer to use. In the rule, a pick up location to be used by a buyer is selected based on the available parking spaces of the pick up location and the package volume of the buyer's order. The rule can be as follows. When a buyer completes his/her order, the MPS entity can determine the package volume of the buyer's order and/or the number of packages the buyer's order contains. If the number of packages that the buyer's order contains is over a determined amount (e.g. 3 individual meals) or the package volume of the buyer's order is over a determined amount (e.g. 2 cubic feet), the buyer is directed to use a pick up location with parking spaces fewer than a certain number (e.g. less than 20 available parking spaces). This is because the carrying capacity (i.e., volume and number of meals/products that a MPS can carry) is a fixed, limited amount, and buyers that pick up a larger number or volume of meals from a MPS reduce the amount of parking required to accommodate such buyers. For example, if each buyer picking up meals from a particular MPS picks up a multiple meals, the MPS will service fewer buyers (and thus require less parking) than if each buyer picks up only a single meal. If a buyer picks up an order which is less than a determined number of packages or less than a determined amount of package volume, the buyer in this embodiment is directed to use a pick up location with more than a certain number of parking spaces. Preferably, the number of parking spaces available at a particular pick up location is at least the same as or is higher than the peak number of buyers estimated to arrive at the location over a particular period of time (i.e., the peak period encompassed by the Customer Arrival Distribution, described below).

A MPS station can only carry a fixed number of packages. Therefore, if more buyers with larger numbers of packages go to a pick up location to pick up orders, it will result in less buyers going to the pick up location. Therefore in order to improve the traffic condition in a pickup location where parking space is limited, it is logical to assign buyers with larger numbers of packages to use such a pick up location. Because a pick up location with a large number of parking spaces may handle an increased amount of traffic, it is therefore logical to assign buyers with lesser package amounts to use such a pick up location.

The MPS entity can ask the owner a pick up location to provide parking availability information. The MPS entity can use this information to categorize pick up locations into groups. For example, a pick up location with fewer than 20 parking spaces may be classified as group one. A larger pick up location with parking spaces numbering between 20 and 50 may be classified as group two. An even larger pickup location with over 50 parking spaces may be categorized as group three, etc. Here, the entity groups pick up locations based on the available parking spaces of a pick up location. The MPS entity then sets up criteria and uses this criteria to assign a buyer to a pickup location. When a buyer completes his/her order, the seller or the MPS entity can calculate the total number of packages (or the total package volume) of the buyer's order. The MPS entity can use this information, the criteria of assigning pickup location, and the parking availability information to determine the pick up location the buyer may use to pick up his/her order. For example, the MPS entity uses three packages and two packages as criteria to assign pickup locations. In the example, a buyer who picks up an order with over three packages may be directed to use a pick up location in group one. A buyer who picks up an order with two or three packages may be directed to pick up his/her order at a pick up location in group two. A buyer who picks up an order with only one package may be directed to pick up his/her order in group three.

In case the MPS entity allows a buyer to select a pickup location the buyer prefers, the MPS server may display to the buyer only those pickup locations that satisfy the above selection rules for the buyer's selection.

In the case that a buyer's pickup location is assigned by the MPS entity, the MPS entity may assign a pick up location that satisfies the package/volume selection rules to the buyer for the buyer to use. In this case, the entity may hide these pick up points determined not satisfying the selection rules from a buyer so that the buyer may not have the opportunity to select these pick up points.

Many times, the purchase price of an order is in relationship to the quantity of products a buyer purchases. The server may use the dollar amount (the purchase price) of the order as a guide to assign pick up points. In this case, an order with a larger dollar amount may be assumed to contain a larger quantity of products and with a larger package volume. The order is thus assigned to a pick up location with fewer available parking spaces. By the same method, an order with a smaller dollar amount may be assumed to contain a smaller quantity of orders and smaller package volume. The order is thus assigned to a pick up point with more available parking spaces.

The size of the premises of a pickup location has a positive correlation with its parking availability. For example, a four-acre shopping center would have more parking spaces than a three-acre shopping center. Therefore, a MPS entity may use the size of the premises of a pickup location as a base to project the parking availability of the pickup location and use it as a criteria to select pickup location.

VI). FIG. 26 is another embodiment of the present invention. In this embodiment, the MPS server uses a buyer's physical address to identity a segment of the user's travel route and uses this information to determine pick up point selections. This embodiment can be used in combination with zip code, telephone number, city name or landmark in identifying pick up points.

In the embodiment, the server uses one of the buyer's physical addresses (e.g. home address or office address) as a reference point to search for and/or to display the highways or major streets around the address. The MPS entity can identify these highways/major streets. Once the highways/major streets are identified, the server may display the pre-arranged pick up locations along these highways or streets for selection. A pre-arranged pickup location can be a gas station or a shopping center. The MPS entity may than display these pickup locations for the buyer to select. The entity may select a pickup location among these pickup locations and assign the pickup location for the buyer to use.

Refer to FIG. 26 as an example; H 3275 is the buyer's home. The server can use the buyer's home address H 3275 to calculate and identify the highway (s) around the buyer's home. Highway 10 3210 and Highway 60 (not shown) are the example of such highways. The MPS entity can then use the user's home address to determine the relative location of the user's home to such highways. In the example, the MPS server can determine that HWY 10 3210, is to the north of the buyer's home, and HWY 60 (not shown in FIG. 26) is to the south of the buyer's home. The MPS server may want to determine a number and identify the number of exits on a highway that are closest to the buyer's home. For example, the server wants to search for the two exits on Highway 10 that are closest to the buyer's home H 3275. The MPS entity may calculate the distance of each exit on Highway 10 to the buyer's home and identity the two exits on highway 10 that are closest to the buyer's home or have the shortest driving distance to the buyer's home. Assuming the server has identified these two exits, namely, M 3232 and N 3242. Because the server has determined that the buyer's home is south of Highway 10 3210, the server may assume that the user would use either segment MM′ or segment NN′ (termed “Exiting Segment”) to exit Highway 10 and go home because MM′ or NN′ is in the direction to the buyer's home. The MPS entity may identify MM′ and NN and may select locations, such as P 3236, Q 3238, or S 3246 (all along Existing Segments) as available pickup points for the to pickup his/her orders. The server may select any one among P 3236, Q 3238, or S3246 as pickup location and delivers the buyer's order to the location. In other words, in the embodiment, the MPS entity searches for the highway(s), or major street(s), around the buyer's physical address. Once the MPS entity identifies these highway(s), or major street(s), the MPS entity may further identify the Exiting Segment(s) close to the buyer's physical address. The MPS entity then searches for these gas stations or shopping centers along these Exiting Segment(s) that the MPS entity has pre-arranged to be pickup locations. The MPS entity may then display these pickup locations for the buyer to select. The entity may select a pickup location among these pickup locations for the buyer to use.

The MPS server may define the meaning of “major street.” For example, the server may define a major as a street with traffic volume over a determined amount within a determined amount of time.

Once an exit is identified, the MPS entity can identify an Exit-to-Home Route. An Exit-to-Home Route is a route that connects a buyer's home and a Highway exit. The route connects a set of streets the buyer can use or is projected to use. For example, route M(3232)R(3270)H(3275) is an Exit-to-Home Route. The MPS server may allow a buyer to identify the exit and the streets the buyer prefers to use when a buyer goes home. The MPS entity may use this information to build the buyer's Preferred Exit-to-Home Route. Or, the MPS entity may select, from all Exit-to-Home Routes that connect the buyer's home, the shortest one and use it to project the buyer's Preferred Exit-to-Home Route. The server may identify the Preferred Exit-to-Home Route of a buyer and select a pickup location for the buyer to use along the Preferred Exit-to-Home Route. The MPS entity may collect the Exit-to-Home Routes for other buyers and overlap these routes to determine an overlapped segment as described before. Pickup points may be selected along the overlapped Exit-to-Home Route with the method discussed previously. Once a buyer's Preferred Exit-to-Home Route is defined, the MPS entity can select a channel width or allow the buyer to select a channel width along the route. The MPS entity can build a channel along the route using the method discussed before. The MPS entity can select a pickup location within the channeled area for the buyer to use.

In one embodiment, the MPS entity may ask a buyer to indicate the direction of travel when the buyer travels on a highway (or a major street) selected by the buyer. The entity may use this information to project the exit the buyer uses when the buyer travels to his/her physical address. For example, if the buyer indicates that he/she is traveling on highway X and going towards direction Y, the closes exit on highway X from the buyer's physical address and opposite to the direction of Y can be projected as the exit the buyer uses. For example, if the buyer uses highway 10 and travels eastbound when goes home, the MPS entity may project M 3232 as the exit the buyer uses because it is the closest exit to the buyer's home and is to the west of the buyer's home. In one embodiment, the MPS entity uses the telephone number or the address of the buyer's travel origin (e.g. the buyer's office) to determine the buyer's travel direction when the buyer travels to his/her destination. For example, the server can collect the buyer's office address or telephone number. By knowing the buyer's telephone number or office address, the server can determine the direction of the buyer's office relative to the buyer's home. The server can then predict the direction of traveling, on a highway or on a major street, when the buyer goes home from work.

In one embodiment, the MPS entity can identify the exits on the highways around a buyer's physical address. The MPS server then calculates all Exit-to-Home Routes. As discussed an Exit-to-Home route connects an exit on a highway with the buyer's physical address. The MPS server then identifies the shortest Exit-to-Home Route. The exit that connects the buyer's home with the shortest Exit-to-Home Route can be projected as the buyer's preferred exit.

Instead of projecting a buyer's preferred exit, the MPS entity may then allow the user to indicate the highway exit the buyer prefers to use after the buyer is allowed to select a highway or a major street the buyer prefers to use.

Once a buyer's preferred exit is identified, the MPS entity can use it as an identifier to display these gas stations or shopping centers around the exit the entity have pre-arranged as pickup locations for the buyer to use. The MPS entity may determine a distance around an exit. The distance and the exit can define an area. The MPS entity can display all gas stations or shopping centers within the area the entity have pre-arranged as pickup locations for the buyer to use. Or, the MPS entity may allow the buyer to define a distance from the exit. The distance and the exit can define an area. The MPS entity may display all gas stations or shopping centers within the area the entity have pre-arranged as pickup locations for the buyer to use.

In one embodiment, the MPS entity can identify the pickup locations that are located in the area between a buyer's preferred exit and the buyer's home for the buyer to use. The area between the preferred exit and the buyer's home may be defined as follows. The MPS entity connects the buyer's preferred exit and the buyer's home with a straight line. The MPS entity can draw a line that is vertical to the straight line from the preferred exit. The MPS entity can draw another line from the buyer's home that is also vertical to the straight line. The space between the two lines can be defined as “the area in between the exit and the buyer's home”. For example, in FIG. 26, assuming M 3232 is the buyer's preferred exit and H 3275 is the buyer's home. The MPS entity draws a line MH that connects M 3232 and H 3275. The MPS entity then draws a line at M 3232 that is vertical to line MH. The MPS entity draws another line at H 3275 that is also vertical to line MH. The pickup locations that are between these two lines can be displayed for buyer to use. Further, the MPS entity can select a distance (or let a buyer to select a distance) form the straight line, e.g. MH, and build a channel along the straight line. The channel defines an area and the MPS entity can display pickup locations within this area for buyer to use.

In the embodiment, H 3275 may be the buyer's office and M 3232 may be the preferred exit the buyer uses when the buyer goes to/from work. In this case, the MPS entity may then select a pickup location between buyer's office and the preferred exit for the buyer to use.

The “distance” described in the embodiment is preferably be road-traveling distance as discussed before.

VII) A buyer may be associated with a group. The members of the group use the MPS service to purchase. Each member in the group has his/her preferred pickup location. Each member may order different meal from different BFPs but each member shares a common physical address, e.g. a home address or an office address. In one embodiment of the present invention, an arrangement can be made so that one member of the group may pick up the orders of all members of the group at the pick up point preferred by the member who picks up the orders. In the embodiment, every member in a group is identified by a group code. The group code may be the street number of the group or may be another type of identification. When a user registers with the server, the user may be provided with a template to enter his/her information. Assuming A is a user belongs to group G. In the template provided by the MPS server, a space may be used by user A to enter his/her group code. All members in the group are identified by the same group code. When user, e.g. user A, places an order, user A selects his/her own preferred pickup point as previously described. So do all other members in the group. User A, may select his/her preferred pick up point different from the pick up point selected by any other members of the group. A box called “pick up member” is provided to all group members in a server provided template. When a member, such as member A, is scheduled to pick up orders for all the members in the group, the member checks the “pick up member” box. The MPS server then searches for all buyers with the same group code and temporarily changes the pickup location of all members in the group to the pick up location of the pick up member. In this way, all orders in the group will be delivered to the pick up location selected by the pick up member. The MPS entity also temporarily changes the order recipient of all members in the group to be the “pickup member” so that when the “pickup member” arrives at the pick up point, the member is authorized to pick up all the orders of the group.

Each member may select a date or dates to be a pickup member. For example, in a group, member John may select every Monday and Tuesday as the pickup member and member Peter may select every Wednesday and Thursday as the pick up member. The MPS entity then arranges to deliver all the group members' orders to the pick up point selected by John on every Monday and Tuesday. Using the same method, the MPS entity arranges to deliver all the group members' orders to the pick up point selected by Peter on every Wednesday and Thursday. Also, the MPS entity may update its contact information so that the MPS entity may call or send an email to the pick up member for picking up of the orders.

VIII) A MPS entity can save delivery costs if its buyers can select pickup locations to use within a few pick up locations. Actually, the fewer pickup locations buyers select the more delivery costs the MPS entity can save.

One embodiment of the present invention uses this concept to cut delivery costs. In this embodiment, a MPS entity pre-arranged a number of pickup locations and groups the pickup locations into groups. A pickup location (e.g., in an area and/or selected from a group of pickup locations in an area) is released (offered) one (or a few) at a time for buyers to select from. A released pickup location is closed when the carrying capacity of the pickup location is full. At that time, another pickup location in the group is opened for buyers to use. A buyer cannot select a pick up location that has not been released. That is, once pickup locations are grouped, the entity may select one (or a few, such as two) of the pick up locations in one group for buyers to use. Pickup locations in a group are open one at a time. Un-opened pickup locations are hidden from the buyer foe selection. A buyer is then forced to use the pickup location(s) released. The MPS entity may monitor the opened pick up location(s) and calculate the orders to be picked up at the opened pick up location(s). Once an opened pickup location has accumulated enough orders to fulfill its carrying capacity, the pickup location is closed for selection. Another pickup location in the group can be released for buyers to use. In other words, in this embodiment, a MPS entity first selects one pick up location in one group for a buyer to use and does not make available or offer the other pickup locations in the group from the buyer. The entity then selects the same pick up location for a second buyer to use and hides the other pickup locations in the group from the second buyer. The MPS entity opens a second pickup location in the group for a third buyer to use when the carrying capacity of the first pickup location is full.

The MPS entity first determines the criteria of grouping pickup locations. The MPS entity then group pickup locations into groups according to the criteria. The MPS entity may use the “closeness” of pickup locations (the distance between them) as a criterion to group pickup locations. The MPS entity may determine the meaning of “closeness”. “Closeness” can be defined by distance, e.g. ¼ miles. In this case, a group of pickup locations that are located within ¼ miles to each other can be grouped together. The MPS entity may use the area pickup locations are located as a criteria to group pickup locations. For example, the MPS entity wants to use a city as criteria to group pickup locations. The MPS entity may further divide a city into grids, e.g. 9 grids, and group the pickup locations in a grid as a group. The entity may group pick up locations by their relative locations. Pickup locations that are close to each other by may be grouped together. The MPS server may determine the distance of pickup locations for grouping. The MPS entity may select a reference point and group all pickup locations within a certain distance (e.g. ¼ mile) from the selected reference point.

Alternatively, pickup locations that are equally convenient to buyers may be grouped together. For example, pick up locations that are located along a street may be grouped in one group.

In this embodiment, the MPS entity regulates the selection of pickup locations to save delivery costs. For example, pickup location A and pickup location B are along Grand Avenue and are one block away from each other. The two pickup locations are so close to each other that opening both pickup points at the same time for buyers to use makes no sense. Since these two pickup locations are not far away, a better approach is to release only one of the two pick up points for the buyer to use in the first stage. When the released pickup point is selected to its full capacity, the server then releases the other pickup point for buyer to use.

In the case a buyer's pickup location is determined and assigned by a MPS entity, the entity may select one pickup location within a group at a time and assign the pickup location for a buyer to use. The pickup location is open until the pickup location's carrying capacity is full. The MPS server may then open another pickup location in the group and assign other buyers to use the pickup location.

The carrying capacity of a pickup location in the embodiment can be the carrying capacity of the MPS station that is assigned to the pickup location. The term “carrying capacity” in the embodiment can mean the physical capacity of a MPS station. That is, if a MPS station can carry a maximum of 300 orders, the carrying capacity can be set at 300 orders. For the purpose of deciding closing of a pickup location, the MPS entity can set the carrying capacity of a MPS station with a quantity the MPS is content with. For example, the MPS entity may be satisfied if a MPS station is 80% full, then the carrying capacity of a pickup location can be set at 240 orders (80% of 300 orders).

IX). The MPS entity may find it easier and more cost efficient to collect orders from a BFP if the BFP is located in one location with other BFPs (or close to other BFPs). This is because when the MPS entity picks up orders from the BFP, it can pick up orders from other BFPs at the same time to save transportation costs.

In one embodiment, BFPs that are close to other BFPs are grouped together.

Consider the following example: Assuming store A13250 and store A2 3254 (see FIG. 26) belong to the same franchise chain A (BFP A). Store B1 3252 and store B2 3256 belong to franchise chain B (BFP B). Also assuming A2 3254 and B2 3256 are located in one location (or are close to each other). A13250 and B1 3252 are some distance apart from each other. Assuming when the MPS entity accounts for all orders, it discovers that both BFP A and BFP B receive orders. Assume further that none of these orders are large enough for the MPS server to justify the cost of sending one MPS station to either A13250 or B1 3252 in a separate trip to pick up orders. The MPS server may ask BFP A and BFP B to pass the production of their orders to store A2 3254 and store B2 3256. In this way, orders of BFP A are produced by A2 3254 and orders of BFP B are produced by B2 3256. Since A2 3254 and B2 3256 are in one location (or are close to each other), the MPS server may pickup all the orders in one trip. Here, because A1 and A2 (or B1 and B2) belong to the same chain, they should have no problem to produce the same product.

A BFP that is grouped with other BFPs may receive higher priority in receiving orders than a BFP that is not grouped with other BFPs. The meaning of priority can be explained by the following example: Assume Store A2 3254 receives higher priority in receiving orders than store A13250. Store B2 3256 receives higher priority in receiving orders than store B1 3252. An order for chain A is passed to A2 3254 before it is passed to A13250. An order for chain B is passed to B2 3256 before it is passed to B1 3252. Let's further assume that the order chain A received is 300 orders of Sea Food Pasta. The order is passed to A2 3254 for production first. If the total production capacity of A2 3254 is 250 meals, the balance of the order (50 meals of Sea Pasta) is then passed to A13250 for production. Chain A may reject to produce the balance of the order (50 meals) if passing the production of these meals to A13250 cannot make a profit. In other an order is passed to a store with higher priority first. The order is passed to a store with lower priority if the store with higher priority does not have the capacity to produce the order.

The MPS entity first determines the criteria of grouping BFPs. The MPS entity then group BFPs into groups according to the criteria. The MPS entity may use the “closeness” of BFPs as a criteria to group BFPs. In this case, the MPS entity may determine the meaning of “closeness”. “Closeness” can be defined by a distance, e.g. ¼ miles. In this case, BFPs that are located within ¼ miles to each other can be grouped together. Another example, the MPS entity may select a reference point and group all BFPs within a certain distance (e.g. ¼ mile) from the selected reference point. Alternatively, BFPs that are equally convenient to the MPS entity to pickup orders may be grouped together. For example, BFPs that are located in a shopping mall or located within a determined number of blocks may be grouped in one group. Or, BFPs that can be arranged so that a MPS truck can pickup orders from these BFPs in one pickup route can be grouped together.

The MPS entity can save in its database all the menus of the BFPs the MPS entity is affiliated with. When the MPS entity receives an order, it can search into its database and determine the BFPs that are able to produce the order. The MPS entity can identify the BFPs that can be grouped with other BFPs and the BFPs that cannot be group with other BFPs. Buyer orders are passed to a BFP that is grouped with other BFPs for production in a higher priority than a BFP that is not grouped with other BFPs. That is, buyer orders are passed to a BFP that is grouped with other BFPs first. Buyer orders are passed to a BFP that is not grouped with other BFPs only when the BFPs that can be grouped with other groups cannot handle the order. By doing so, a MPS server may save transportation cost and time in collecting buyer orders from BFPs. The grouping method can be used by a MPS entity when a MPS entity is designing a meal plan as will be discussed later.

The grouping method can be used even if a BFP that is affiliated with the MPS entity does not belong to any restaurant chains.

X). When a BFP is a franchised chain such as McDonald's that contains stores with different owners, selling products through the MPS web site may cause cannibalization to occur. This is because all stores in the chain are selling almost identical products and when a store in the chain sells its product by using MPS service, the products it sells can reach a distant customer who is supposed to be the customer of another store that nears the customer. For example, a buyer lives in Chino Hills and is a regular customer of a restaurant of a franchise chain in Chino Hills. If the buyer uses the MPS service to order the food of the franchise chain, the user may receive foods from another restaurant in the chain and not the one the buyer used to visit. Cannibalization occurs between the two restaurants in the situation. The cannibalized store may suffer economic loss especially the cannibalized store and the cannibalizing store do not belong to the same owner. Disputes may thus occur.

To alleviate the loss to the cannibalized store and resolve the dispute, the franchise chain may institute several arrangements.

In one embodiment, the franchise chain institutes a rotating system. In the system, affected stores sell their foods through the MPS service by turns. An affected store is a store in a chain that may cannibalize, or be cannibalized by, other stores in the same chain because of the MPS services. One way to operate the rotating system is to rotate the receiving of orders from the MPS service among affected stores. For example: The franchise may decide that the first order coming to the chain is assigned to, produced by, and sold by store A in the chain and the second order coming to the BFP system is assigned to, produced by, and sold by store B in the chain, etc. Orders may be rotated by day. For example, all the orders coming to the chain from the MPS service on day one is assigned to, produced by, and sold by store A in the chain. All the orders coming to the chain from the MPS service on day two is assigned to, produced by, and sold by store B in the chain, etc. Under the system, every store has the same opportunity to produce and sell orders from the MPS system and the effect of cannibalization may be neutralized. In the system, an affected BFP chain store can make an arrangement with other affected BFP chain stores. The arrangement schedules production/selling of MPS orders for every affected store so that the economic loss to a cannibalized store is neutralized.

In one embodiment, the franchise chain assigns each store in the BFP franchise chain a territory to alleviate the cannibalization effect. The franchise may define a store's territory by criteria such as addresses, zip codes, city names or telephone numbers. When a buyer places an order, the MPS server may use the buyer's physical address information (e.g. the user's home or office address, home or office zip code, home or office telephone number) to determine the territory the buyer is in. If the buyer's physical address falls within the territory of store A, the buyer's order is assigned to store A and the order is produced by and billed by store A. The franchise chain and a franchise store may jointly determine the store's territory.

In one embodiment, a reimbursement plan that compensates the loss to the cannibalized store may be used to alleviate the dispute. The reimbursement plan may be: the cannibalizing store reimburses an agreed upon amount of money to the cannibalized store for an order the cannibalizing store sold and billed. The reimbursed order may be defined as an order that is placed by a buyer whose physical address falls into the cannibalized store's territory, and the order is produced and billed by the cannibalizing store.

Even without cannibalization, the above arrangements provide every store with the same opportunity to produce and sell orders by using the MPS service. In this way, fairness can be reached.

There may be an agreement between affected stores. In the agreement, all disputes related to cannibalizing are settled. Claims against a cannibalizing store are released when the cannibalizing store participates in any or all of the above mentioned arrangements.

XI). In another embodiment of the present invention, the MPS server can select to block or display some or all of the contents of a BFP's information to a buyer according to the buyer's physical address. The physical address is the street address of the buyer's home, office or the buyer's travel origin or destination. This option may be illustrated by the following example: Assume restaurant A is a restaurant in a restaurant chain. Restaurant A joins the MPS delivery service. A buyer, John, may order and receive the restaurant chain's food from A by using MPS ordering and pick up service. Assume there is another restaurant (restaurant B) in the restaurant chain and is located near buyer John. Buyer John's physical address is within the territory of restaurant B. The restaurant chain may request that the MPS server to block the access of buyer John from receiving the food from a restaurant in the chain unless the food is prepared by restaurant B. In other words, a chain may wish to block a buyer from ordering the chain's product from one restaurant of the chain if the buyer's physical address, e.g. home address, falls into the territory of another restaurant of the chain. The purpose of the blockage is to prevent cannibalization within the restaurants. For example, Restaurant Chain M has a restaurant (restaurant C) on Grand Avenue in the city of Chino Hills. Chain M may wish to block access of its products to the residents living around Grand Avenue of Chino Hills unless the orders are produced by restaurant C.

The restaurant chain may designate an area assigned to a restaurant in a chain. The restaurant chain may determine the boundary of the area. The MPS server may use a buyer's physical address (or telephone number) as a key to determine if the buyer's physical address is within the area. If it is, the buyer is allowed to access the service from the restaurant. Other restaurants in the chain is blocked from the buyer.

In one embodiment, a restaurant chain (or a food provider) may designate an area it wants to release special information to the consumers within the area. The special information may be special promotions. The chain may define an area and the boundary of the area. The MPS server may use a consumer's physical address to determine if the consumer is within the area for the special information. If the consumer's physical address is within the defined area, the consumer is allowed to access to the special information. In this embodiment, different consumers in different areas may receive different information. This embodiment is useful for a business entity that wants to penetrate a particular market by providing special promotions. The special promotion may be special for that market the entity may not want the consumer in other market to receive it.

XII) In one embodiment of the present invention, a MPS entity determines the timing of different tasks in its delivery operation. For example, after the MPS entity passes take-out orders to a BFP, the BFP may use the slow (or idle) period of the BFP's kitchen operation (e.g. from 1:30 p.m. to 3:30 p.m.) to produce these take-out orders. This period, e.g. from 1:30 p.m. to 3:00 p.m., is usually slow and not a BFP's normal hours to complete the production of dinner orders. The BFP benefits by utilizing the period to produce dinner orders because expenses (such as rent or utility) for that period have already been incurred. To better control its production operation, the BFP may set up a cut-off time of receiving orders. The cut-off time may be selected coincides with its slow/idle period. In the above example, the order cut-off time may be set at 1:30 p.m., just before the beginning of the slow/idle time. Or, the order cut-off time may be selected based on the convenience of its target customers. For example, if the BFP's target customers have a break (e.g. lunch break time) from noon to 1:00 p.m., the cut-off time may be set at a time within the break time. This is because an employer usually does not mind if an employee uses his/her break time to shop online.

In a MPS operation, each activity has a due time. For example, a BFP may want to produce orders it receives using its slow/idle time and all orders have to be completed by a determined time (e.g. 2:30 p.m). A MPS truck needs to have enough time to ship the orders it picked up from BFPs to its warehouse for processing. A MPS truck needs to deliver these orders to a pickup point before the start of a MPS station time (e.g. 5:00 p.m.). Because all these constraints, a BFP and the MPS server needs to coordinate with each other and agree upon a time (the “Order Due Time”) by when the BFP will have all orders completed and ready at its place so that a MPS station can come and pick up these orders. An Order Due Time may be determined by several factors, such as the production starting time of the orders, the size of orders, the production time needed to complete these orders, etc

Once orders are picked up from BFPs, they are shipped to a MPS warehouse for processing (e.g. grouping with other orders for distribution, completing the needed paper work . . . ). Assume that it takes 30 minutes for orders to be processed in the MPS warehouse and the start of the Station Time at a pickup location is 5:30 p.m. The orders have to be shipped to the warehouse by 5:00 p.m. The time orders have to be shipped to a warehouse is called Order to Warehouse time. Or, O2W time.

Assume that the Order Due Time at a BFP is 3:30 p.m., the MPS Station Time at a pickup location starts at 5:00 p.m. and it takes 30 minutes for an order to be processed (e.g. grouping with other orders for distribution, completing the needed paper work . . . ) in the MPS warehouse. The transportation time of the orders from the BFP to the MPS warehouse (termed: B2W Time) plus the transportation time from the MPS warehouse to the pick up point (termed: W2P Time) can only be one hour. The MPS server may then need to determine how to spread the one hour between the B2W time and the W2P time. The longer the B2W time is, the shorter the W2P time can be, and vice versa. Determining the length of W2P time and B2W time may have marketing implications and the MPS server may need to make decisions as to how to spread the time between the B2W time and the W2P time. The decision may be based on marketing strategies. One example of the strategy may be that a longer W2P time can expose the MPS entity to a larger customer base and can be used when the MPS entity needs expansion. A longer B2W time can cover more BFPs for a buyer's selection and may provide more variety of service. The strategy can be used when the MPS entity wants to enhance customer loyalty.

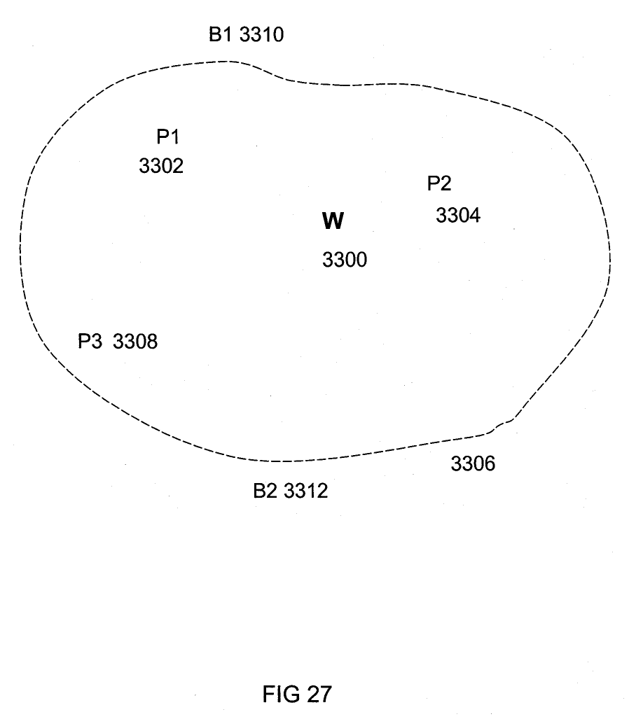

A “Dispatch Time” is the time a MPS station is dispatched from a MPS warehouse to travel to a pick up location. A MPS station must arrive at its assigned pickup point before the start of the Station Time at the pickup point. Let's assume the MPS entity decides that the Dispatch Time of a MPS station is 4:30 p.m. and the Station Time at a pickup location is determined to be 5:00 p.m., then the farthest point a MPS station can reach is a place that is 30 minutes driving distance away from the warehouse. A “boundary point”, e.g. B1 3310 FIG. 27, is the farthest point a MPS station can reach away from the warehouse within the constraint of the “Station Time”. Once a “delivery boundary” (a limitation of MPS deliveries, is a collection of boundary points), e.g. 3306 FIG. 27, is established, available pick up points may be selected (or arranged) within it. The distance from warehouse W 3300 to each point on the boundary (such as B1 3310 or B2 3312) may not be the same due to different traffic conditions. P1 3302, P2 3304 and P3 3308 are examples of available pick up points selected (or arranged) by the MPS entity.

If more than one BFP is involved in MPS operation, the server may determine a B2W Time for each BFP. The Dispatch Time of MPS stations at the warehouse may be determined by using the longest B2W time with the MPS warehouse.

Once a Dispatch Time is determined, only those BPFs that are located within the driving distance from the MPS warehouse in the longest B2W Time may be included in the MPS service, unless a BFP elects to deliver its orders to the MPS warehouse by its own transportation means.

As stated, a MPS Station Time can start at a specific time and end at a second specific time. The start of a Station Time may be determined by an Order Due Time plus B2M time plus the time spent in in-warehouse processing plus W2P time. In case a MPS entity produces its own products for sale and uses the MPS delivery method to deliver these products, the MPS entity does not need to travel to a BFP to pickup these products. The MPS entity may still need to consider Dispatch Time, W2P time, Station Time in its operation.

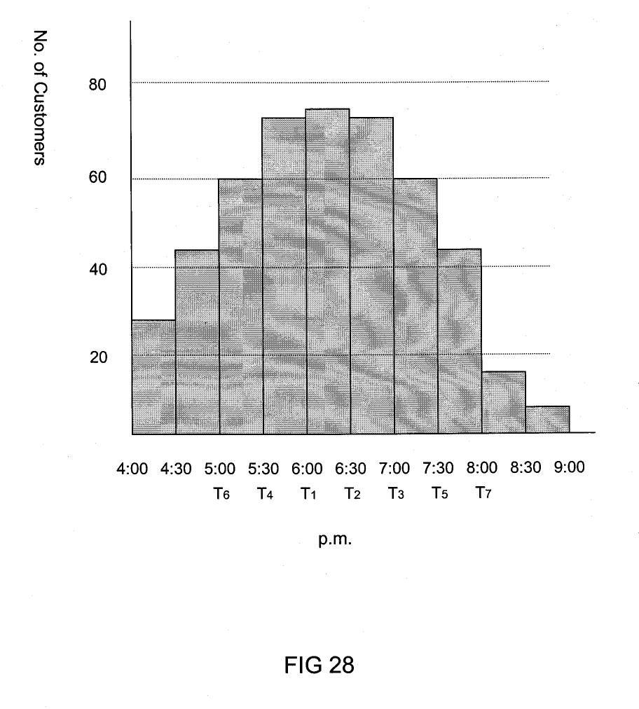

In one embodiment, the MPS entity determines the Station Time at a pickup location based on other factors such as the time the members of its customer base (its potential customers) “pass by” a pickup location during the customers' to/from work commute. The term “pass by” as used herein means traveling so as to move from a first location to a second location by means of a route which passes through or next to a pickup location at which a customer can stop to pick up an order. This term includes both situations in which a customer stops at the pickup location and/or situations in which a customer continues traveling past or through the pickup location without stopping. The potential customers of the MPS entity may work at different places and leave work at different times, therefore, passing the pickup location at different times. Even if the MPS entity's potential customers get off work at the same time, e.g. 5:00 p.m., they may work at different places, face different traffic conditions and may pass by a pickup location at differing times. The number of potential customers that pass by a pickup location over a period of time may form a distribution (a pattern). For example, the potential customers may start to pass by a pickup location at 4:00 p.m., the number of these potential customers gradually increases, reaches its peak between 6:00 p.m. to 6:30 p.m. then gradually reduces, and falls below a level after 9:00 p.m. The distribution may be expressed by graphics such as in FIG. 28. The height of a bar in this figure represents the number of customers within a period of time. For example, FIG. 28 shows 60 potential customers passing by a pickup location between 5:00 p.m. to 5:30 p.m. The distribution of potential customers passing by a pickup location over a period of time, i.e. during the customers' to/from work commuting, is called herein a “Customer Pass-by Distribution (CPD)”. In one embodiment of the present invention, the MPS entity uses the Customer Pass-by Distribution at a pickup location to project the arrival distribution of its customers at the pickup location. The distribution of customers that arrive at a pickup location (i.e., those that stop at the location) during the customers' to/from work commuting is called Customer Arrival Distribution (CAD). The MPS entity can use the projected Customer Arrival Distribution at a pickup location to determine the start of the Station Time and/or the end of the Station Time of a MPS station at the pickup location. The Customer Pass-by Distribution at a pickup location can be estimated by the MPS entity or may be determined by the MPS entity through inquiries, such as inquiries to current customers, or by analysis of data obtained from a third party relating to persons traveling in a particular area who have characteristics (income, mode of transportation used, etc.) likely to make them customers of a service employing the present method. The traffic flow distribution of a near-by major street or a highway may be used as a base to estimate the Customer Pass-by Distribution of a pickup location. The MPS entity may determine the Customer Pass-by Distribution of a pickup location by sending out inquiries to its potential customers and ask for the times that they will pass by the pickup location.

In the above example, assume that the number of potential customers pass by a pickup location before 4:30 p.m. and after 8:00 p.m. are insignificant. The MPS entity may then assume that the actual customers passing by the pickup location and the orders to be picked up during that periods of time are also insignificant. Because of this, the MPS entity may determine that it cannot justify the costs to station a MPS at the pickup location before 4:30 p.m. and after 8:00 p.m. and the MPS entity may set the Station Time at the pickup location starting from 4:30 p.m. and ending at 8:00 p.m.

In one embodiment, the MPS entity can determine the Station Time at a pickup location based on the Customer Pass-by Distribution at the pickup location along with the costs and benefits associated with stationing a MPS at the pickup location for the period of time. In the embodiment, the MPS entity uses Customer Pass-by Distribution at a pickup location to project the Customer Arrival Distribution at the pickup location. Based on this information, the MPS server may determine (or expects) the orders to be picked up at the pickup location for a particular period of time. If the costs of stationing a MPS station for the particular period of time at the pickup location exceed the revenue receives for the period of time at the pickup location, the period of time is excluded as Station Time at the pickup location.

In other words, in the embodiment, the MPS entity may determine (or estimate) the Customer Pass-by Distribution at a pickup location, analyze the distribution and use the distribution to estimate the Customer Arrival Distribution at the pickup location. The MPS entity then uses the estimated Customer Arrival Distribution along with cost-and-benefit analysis of stationing a MPS station at the pickup location to determine the Station Time at the pickup location. In this embodiment, the MPS entity can select a period of time and can use the projected Customer Arrival Distribution (projected by the Customer Pass-by Distribution) to determine (or project) the number of customers that would arrive at the pickup location during the period of time. Based on the information, the MPS entity can estimate the number of orders that would be picked up at the pickup location during the period of time. The MPS entity can then perform a cost-and-benefit analysis for the period of time. If the costs of stationing a MPS station at that pickup location during the period of time exceeds the benefits received (by delivering these orders) at that pickup location during the period of time, the period of time is excluded from the Station Time at the pickup location. If the benefits received (by delivering these orders) from stationing a MPS station at the pickup location during the period of time exceeds the costs incurred during the stationing of a MPS station at the pickup location for a particular period of time, the period of time is included in (or is selected as) the Station Time at the pickup location. For example, if the MPS entity determines (or estimates) that there would be fewer than six customers to use a pickup location between 8:30 p.m. to 9:00 p.m. and the costs of stationing a MPS station between that time at the pickup location is $30.00, then the MPS entity may exclude 8:30 p.m. to 9:00 p.m. from the Station Time at the pickup location if the income generated from the six customers is $20.00, i.e. if no profit is estimated to be made during that time period or if a loss is expected. In this case, the Station Time at the pickup location would end at 8:30 p.m. The costs of stationing at a pickup location that can be considered in determining a Station Time in this embodiment of the present method include labor costs, rent expense and other expenses occurred at the pickup location.

Once the periods of time that are included (or excluded) in a Station Time are determined, the MPS entity can use this information to determine the beginning and/or ending times of a Station Time for a particular location.

A MPS entity may have an incentive to make the Station Time at a pickup location as short as possible because a shorter Station Time may mean lower station costs. The following method can be used to reach this goal. In one embodiment, the MPS entity uses the Customer Pass-by Distribution at a pickup location to project the Customer Arrival Distribution at the pickup location and uses the projected Customer Arrival Distribution at the pickup location along with the carrying capacity of the MPS station assigned to the pickup location to determine the Station Time. Assuming that the MPS station that is assigned to a pickup location can carry a maximum of 340 individual orders and one customer picks up one order only, for example, and assuming that FIG. 28 is the project Customer Arrival Distribution at the pickup location, the MPS entity can determine the Station Time as follows: The MPS entity first determines a time length. The time length covers a period of time with length ΔT. The MPS entity may use ΔT as a unit to compile a Customer Arrival Distribution. Using the example shown in FIG. 28, the distribution is compiled with ΔT=30 minutes. In one embodiment, the MPS entity uses the period (T₁T₂) that includes the peak (between 6:00 p.m. to 6:30 p.m. in FIG. 28) of a projected Customer Arrival Distribution to start determining a Station Time. Period T₁T₂ beginning at T₁ and ending at T₂. In the example, T₁=6:00 p.m. and T₂=6:30 p.m. The MPS entity then uses the projected Customer Arrival Distribution to find out the number of customers that are projected to arrive at the pickup location to pick up orders during the period T₁T₂. If the number of customers projected to arrive over the time period T₁T₂ to pick up orders is less than the MPS carrying capacity, the MPS entity then finds out the total number of customers that are projected to arrive at the pickup location in time period T₁T₂ plus time period T₂T₃. (Here T₃=T₂+ΔT. T₂T₃ is a time period from 6:30 p.m. to 7:00 p.m.). If the total is still less than the MPS capacity, the MPS entity finds out the total number of customers arriving in time period T₁T₂ plus T₂T₃ plus T₄T₁. (Here T₄=T₁−ΔT. T₄T₁ is the period from 5:30 p.m. to 6:00 p.m.). The MPS entity keep “going outwards” from the peak period until the total orders that are projected to be picked up at the pickup location reaches the capacity (e.g. 340 orders) of the pickup station that is assigned to the pickup location.

The following table details a computation of a preferred Station Time using the example shown in FIG. 28, assuming ΔT=30 minutes and one customer picks up one order:

| | | | Total | |
|---|---|---|---|---|
| projected customer arrivals from | (T₁T₂) | 75 | 75 | |
| 6:00 p.m. to 6:30 p.m. | | | | |
| projected customer arrivals from | (T₂T₃) | 73 | 148 | |
| 6:30 p.m. to 7:00 p.m. | | | | |
| projected customer arrivals from | (T₄T₁) | 72 | 220 | |
| 5:30 p.m. to 6:00 p.m. | | | | |
| projected customer arrivals from | (T₃T₅) | 60 | 280 | |
| 7:00 p.m. to 7:30 p.m. | | | | |
| projected customer arrivals from | (T₆T₄) | 60 | 340 | stop |
| 5:00 p.m. to 5:30 p.m. | | | | |

The computation stops when the total orders that projected to be picked up at the pickup location reach the capacity (e.g. 340 orders) of the pickup station stations at the pickup location. In the example, the Station Time is then determined to start at 5:00 p.m. and end at 7:30 p.m. In the example, if a MPS station with a larger carrying capacity is assigned to the pickup location, the station time can be longer.

The method can be used to determine the end of Station Time when the start of the Station Time is determined by other factors such as the Dispatch Time at the MPS warehouse and W2P time associated with the warehouse and a pickup location. For example, the MPS entity may determine that the station time can only starts at 5:30 p.m. because of the limitation places by the Dispatch Time and W2P time. In one embodiment, the MPS entity can determine the Station Time at a pickup location when the Station Time is fixed. The method is as follows. Assuming the carrying capacity of the MPS station that is assigned to the pickup location is 320 orders. The MPS entity first determines the beginning of Station Time. The MPS entity then defines a time length ΔT (30 minutes in our example) and uses this time length to compile the projected Customer Arrival Distribution as disclosed before. Use FIG. 28 as an example, the Station Time starts at 5:30 p.m. (T4). The MPS entity can use the projected Customer Arrival Distribution to find out the number of customers that are projected to arrive at the pickup location to pickup orders within the time period T₄T₁. (T₁=T₄+ΔT, as the previous example). If the number of customers projected to arrive at the pickup location to pickup orders in time period T₄T₁ is less than the MPS carrying capacity, the MPS then finds out the total customers that are projected to arrive at the pickup location in time period T₄T₁ plus time period T₁T₂. (T₂=T₁+ΔT, as in the previous example). If the total is still less than the MPS carrying capacity, the MPS entity finds out the total number of customers arrive at the pickup location to pickup orders in T₄T₁ plus T₁T₂ Plus T₂T₃ . . . . The MPS entity keep doing this until the orders that projected to be picked up at the pickup location reach the capacity (e.g. 320 orders) of the pickup station that assigned to the pickup location.

In the example, assuming, MPS capacity is 320 orders. One customer picks up one order and ΔT=30 minutes.

| | | | Total | |
|---|---|---|---|---|
| projected customer arrivals from | (T₄T₁) | 72 | 72 | |
| 5:30 p.m. to 6:00 p.m. | | | | |
| projected customer arrivals from | (T₁T₂) | 75 | 147 | |
| 6:00 p.m. to 6:30 p.m. | | | | |
| projected customer arrivals from | (T₂T₃) | 72 | 219 | |
| 6:30 p.m. to 7:00 p.m. | | | | |
| projected customer arrivals from | (T₃T₅) | 60 | 279 | |
| 7:00 p.m. to 7:30 p.m. | | | | |
| projected customer arrivals from | (T₅T₇) | 41 | 320 | stop |
| 7:30 p.m. to 8:00 p.m. | | | | |

The computation stops when the total orders that projected to be picked up at the pickup location reach the capacity (e.g. 320 orders) of the pickup station stations at the pickup location. In the example, the Station Time is then determined to start at 5:30 p.m. and end at 8:00 p.m.

In the embodiment, the carrying capacity of a MPS station may be the physical capacity of the MPS station. For example, if a MPS truck can physically carry a maximum of 400 individual orders (or packages), the carrying capacity of the truck is 400 individual orders.

A carrying capacity of a MPS station, for the purpose of determining station time of a MPS station at a pickup location, may be determined by the orders (packages) available at the pickup location. For example, if the total orders from a MPS entity's suppliers for a day at a pickup location are 200 individual orders, the carrying capacity of a MPS station that is assigned to the pickup location is 200, even though the physical carrying capacity of the MPS station is 400 orders.

In other words, a MPS entity can use Customer Pass-by Distribution at a pickup location as a factor to determine the start of a Station Time at a pickup location. A MPS entity can use Customer Pass-by Distribution at a pickup location and the costs and benefits of stationing a MPS station at the pickup location to determine the end of Station Time at the pickup location. A MPS entity can use Customer Pass-by Distribution at a pickup location and the carrying capacity of the MPS station assigned to the pickup location and the expected time the orders to be picked up by customers to determine the end of Station Time at the pickup location.

In one embodiment, a MPS entity uses Customer Arrival Distribution to replace Customer Pass-by Distribution and uses the methods disclosed above to determine Station Time, the start of Station Time, the end of Station Time, and the including or excluding of a period of time in a Station Time. In this embodiment, the Station Time, the start of the Station Time, or the end of the Station Time at a pickup location can be determined by Customer Arrival Distribution at the pickup location and the costs and benefits of stationing a MPS station at the pickup location. In this embodiment, the Station Time, the start of Station Time, or the end of Station Time at a pickup location can be determined by Customer arrival Distribution at the pickup location, the carrying capacity of the MPS station assigned to the pickup location and the expected time the orders to be picked up by customers.

Customer Arrival Distribution may be obtained by analyzing the commuting information of the MPS entity's customers. The MPS entity may use this information to set the Station Time. The MPS entity may collect a customer's commuting information when the customer registers with the MPS service. As an example, after customers register to the MPS service, the MPS entity observes that the first customer arrives at a pickup location at 3:15 p.m. and the last customer arrives at the pickup location at 8:45 p.m. The MPS entity may set the Station Time at the pickup location from 3:15 p.m. to 8:45 p.m. Because the MPS entity determines (or estimates) that no customer will arrive at the pickup location before 3:15 p.m., the MPS entity may not want to start its Station Time at the pick up location before that time.

If a MPS entity has many pickup locations, the entity may set one Station Time uniformly for all pickup locations. In this case, the Station Time may be determined by using average information. Examples of the average information may be: the average carrying capacity of all MPS stations, the average Customer Pass-by Distribution (or the average Customer Arrival Distribution) at all pickup locations or the average station costs of MPS stations at all pickup locations.

If a MPS operator needs time to set up a MPS station at a pickup location, the MPS station may arrive at the pickup location earlier than the start of the Station Time. In this case, the Station Time at a pickup location may be defined as the time that is available for customers to pickup the customers' orders at the pickup location. For instance, if a MPS station needs five minutes to be set up at a pickup location, the MPS station may arrive at the pickup location at 4:55 p.m. A MPS station may use 4:55 p.m. to 5:00 p.m. to set up the MPS station. In this case, the determined Station Time (e.g. 5:00 p.m. to 7:00 p.m.) at the pickup location is the time a MPS station is ready and is available for customer to pick up their orders.

Once a Station Time at a pickup location is determined, it is published to all customers. A customer can calculate the time he/she needs to travel to a pickup location and use this information to select a pickup location to use. If the customer cannot arrive at one pickup location within its Station Time, the customer has to select another pickup location to use. When a customer's pickup location is assigned by the MPS entity, the MPS entity has to make certain that the Station Time of the pickup location is feasible for the customer to pickup his/her order. If not, the MPS entity has to assign another pickup location for the buyer to use.

For the purpose of easy remembering and easy promotion of the station start time and/or station end time, a station start time and/or station end time may be selected on the hour, half hour, or quarter hour. For example, assuming the costs and benefit analysis of a pickup location finds that the Station Time at the pickup location should be ended at 7:27 p.m. For the purpose of easy remembering and easy promotion of the station end time, the MPS entity may set the station end time at the pickup location at 7:30 p.m. Using this principle, a start time of a pickup station may be set at 4:30 p.m., 4:45 p.m., 5:00 p.m., 5:15 p.m., or 5:30 p.m. An end time of a pickup station may be set at 7:30 p.m., 7:45 p.m., 8:00 p.m., or 8:15 p.m.

The method described above that uses carrying capacity of a MPS station as a factor to determine Station Time is called the Carrying Capacity Method. The method that uses costs and benefits analysis of stationing a MPS station as a factor to determine Station Time is called the Costs of Station Method. Assuming a MPS entity sets the end of Station Time at a pickup location at a time, e.g. 8:00 p.m., if the MPS station that is assigned to the pickup location is capable of carrying more orders, and if the MPS entity knows (or has reason to know) that if it extends the Station Time at the pickup location to a later time, e.g. to 8:30 p.m., it will receive more customers using the service at the pickup location, then a decision by the MPS to refuse to accept these extra customers by refusing to extend the Station Time at the pickup location to 8:30 p.m. can be made using the Carrying Capacity Method and/or the Costs of Station Method to determine the end of the Station Time at the pickup location.

In the beginning of a MPS operation, a MPS entity may only have a small number of customers but the MPS entity projects that it will receive a large number of customers later, for example, three years from now. In this case, the current Customer Pass-by Distribution of a pickup location may be different from the Customer Pass-by Distribution of the pickup location at the later time. Consequently, the current Station Time at a pickup location may be different from the Station Time at the pickup location at the later time. However, the MPS entity may decide that it is to its benefit to keep the Station Time at a pickup location the same over time because changing the Station Time at a pickup location may create confusion and can be costly. Therefore, a MPS entity may determine the Station Time at a pickup location based on projected future Customer Pass-by Distribution (or Customer Arrival Distribution), even if the Station Time does not justify the costs incurred and benefits received currently. If this happens, the MPS entity is still using costs and benefits method to determine the Station Time at a pickup location. This is because the MPS entity has factored in the costs of changing Station Time and the benefits of maintaining a fixed Station Time into the determination of Station Time.

XIII) Meal Plan Program

In one embodiment of the present invention, a MPS entity can provide a meal plan program. Currently, meals may be ordered from a conventional Non-Producing Meal Delivery entity (CNMD) via a web site. The web site typically includes a number of BFPs. A buyer selects a BFP by clicking on the BFP's icon and receives a menu of the BFP. The buyer can click the items (meals) on the menu that the buyer wants to purchase and place an order. The CNMD then picks up the order and delivers the order to the buyer. Reference number 3402 or 3404 in FIG. 14 shows a typical menu of a CNMD. The menu lists meals sold by a BFP with their selling prices. Typically, menus from different BFPs are displayed one at a time. That is, a buyer clicks on the icon of one BFP and receives the BFP's menu only. If a buyer wants to review the menu of another BFP, the buyer needs to get out of the current menu and click on the icon of another BFP to receive another menu. A typical CNMD lists over 50 BFPs on its web site.

The ordering and delivering process used by a CNMD may not work for a MPS operation. In a CNMD operation, a driver's salary and delivery expenses are subsidized or reimbursed by its buyers. This is not the case in a MPS operation. In a MPS operation, a MPS entity can pay delivery expenses such as a driver's salary without subsidy and reimbursement from a buyer. In this case, a MPS may not be able to include every BFP in its service and may need to be selective in accepting a BFP to its service. For example, a MPS entity may not be able to include a BFP that stands alone in a remote location in its service because the entity needs to pay transportation costs. However, such a stand-alone restaurant can work for a CNMD operation because the buyer pays the transportation costs. Also, as has been discussed, because all orders have to reach a pickup location before a pre-determined Station Time, a MPS truck has a limited number of BFPs it can travel to and pick up orders from in one day. All of the above considerations that are issues for a MPS operation may not be issues for a CNMD. Therefore, a MPS entity needs to consider more factors than a CNMD does before including a BFP's product into its service. The MPS entity also needs to consider more factors when planning its menu. Examples of such factors are: the location of a BFP that offers to sell its food, the location of a BFP in relation to the locations of other BFPs, and the production capacity of a BFP.

A MPS entity can deal with these limitations and increase its operation efficiency by offering a meal plan program. A meal plan can cover a period of time and can be grouped into categories. Each category can be defined by certain parameters. For example, the MPS entity can classify a plan into categories according to the nutritional value of food in the plan. The categories can be, e.g., a “Rich Meal Group,” “Normal Meal Group,” or “Dietary Meal Group.” Food items in the Rich Meal Group would be for those consumers who do not have dietary restrictions. Each meal in this group can contain food with different caloric value. The Normal Meal Group contains meals with less fat and/or fewer calories. Items in the Dietary Meal Group would be for the consumers who are more careful about what they eat. The meals would contain dishes with even less fat and calories. A meal plan group can be classified by quantitative values such as calorie count of a meal or meal plan, the amount of fat (e.g., the number of fat calories) and/or type of fat in a meal or meal plan, the number of carbohydrate calories in a meal or meal plan, and/or other nutritional values. A meal plan can also be classified by different spending budgets. For example, a plan can be divided into monthly budgets of $120.00, $140.00 or $180.00. In this embodiment, all the meals in a particular meal plan can be offered to buyers at the same price.

The MPS entity can determine criteria for each group and use the criteria to determine the meals to be included in each group. A group can further be divided into sub-groups. For example, a Normal Meal Group can further be divided into sub-groups with monthly budgets of $100.00, $150.00 or $200.00.

The following is an example of the operation of meal plan with monthly budget of $150.00. Reference number 3410 of FIG. 14 is an exemplary meal plan. The plan covers a determined period of time, e.g., July 2006. Assuming the entity only operates on weekdays and July 2006 contains 22 working days, the MPS staff, when preparing a meal plan for July 2006, determines a meal (or a number of meals) for each of the 22 days. Because the monthly budget of the plan is $150.00, the MPS entity determines that the average price of the meals in the plan is $6.80 ($150.00 divided by 22=$6.80). The MPS service can use this number, i.e., $6.80, as a guide to order each day's food for the plan. The dollar value for each day's meal doesn't have to be exactly $6.80. It can be an amount around $6.80, such as $7.25 as for July 12 in FIG. 14, as long as the total price of all meals in the plan for July 2006 is $150.00.

In one embodiment, a MPS staff member can determine one or more “reference attributes” for one or more days in the plan. In this embodiment, the MPS staff fills the menu of one day, for example, only with meals that contain the reference attribute(s). For example, the MPS staff member can determine that the meals for July 12 are to be priced at $7.25. The $7.25 price is then the reference attribute for July 12. When a MPS staff member selects meals to fill the menu of July 12, he/she only selects the meals with the reference attribute of the day (i.e., a selling price of $7.25). In this way, when there are different meals for a buyer to select in a day, the buyer can select any meal for that day and the total monthly price would come out to be $150.00. Other reference attributes, such as the use of a particular ingredient in each meal, a geographic origin of one or more dishes in a meal, and/or a flavor in one or more dishes of a meal, can also be used in selecting meals for a meal plan.

In one embodiment, referred to herein as Embodiment A, a MPS staff member structures the plan by starting with determining the content of the plan. For example, the MPS staff can, in the first step, determine the number of days in the plan to be American food, Italian food, and Japanese food. The staff then plans for the number of meal(s) for each day in the plan. For example, the MPS ordering staff can decide that there would be 5 meals in the plan for July 12. The MPS staff then decides the content of these five meals. Examples of the contents are: roast beef sandwich, cheeseburger, etc. The MPS staff can also determine that the price of each meal, such as $7.50.

Once all meals for all the days in a plan have been determined, the plan, i.e. comprising a list of meals for determined delivery dates, is published to consumers to order, such as by placing the plan on a website accessible to buyers. The buyers then can place orders with the MPS entity via the website, such as by entering their contact and/or payment information and a selection of meals and/or meal plans offered by the MPS entity which the buyer would like to purchase, and then communicating that selection, such as by clicking on a button provided on the website, in order to send the information to the MPS entity. In some embodiments, the website can list dishes identified as being produced by a plurality of different food providers.

The MPS entity publishes the plan for a predetermined number of days. The MPS staff calculates the number of orders of each meal placed by the customers for each day after the plan is closed. For example, the staff calculates the total number of orders for each meal for July 12^{th} and finds that there are 150 orders for seafood pasta for that day. Typically, an order will comprise a selection of one or more meals, a delivery date for each of the meals, and a pickup location for each delivery date, and can comprise a plurality of pickup dates, each of which may include more than one pickup time on the same day.

The MPS staff then sends out production requests to all participating BFPs to see if any BFP is interested in producing these meals. The MPS staff sends out production requests to all participating BFPs for all meals in the plan. A production request contains the product requirements for a meal. A typical product requirement comprises the specification of the meal, the delivery date of the meal, the price of the meal (e.g., a maximum price), and the quantity of the meal needed. A specification defines the contents of a meal. Other details, such as whether the food is chicken or is mild or hot, can be added. Different requirements can be set for different meals for different days

Suppose a BFP, e.g. BFP A, answers the production request and offers to produce a meal according to its requirements. A MPS staff receives and reviews the offer, which usually must meet the requirements set out in the production request in order for an offer from a BFP to be accepted. If the MPS entity accepts the offer, the MPS entity and BFP A can arrange the “Order Due Time” on the day of delivery. The BFP will have all orders ready for a MPS truck to pick up at the BPF's store by the order due time.

In a meal plan, an arrangement can be made so that a BFP can produce, for each day, one meal only. Because the BFP produces only one meal in a day, the meal is produced in a relatively large quantity. In this way, the production and material procurement process is simple. The BFP can produce the meal in batches and save labor costs. Therefore, a BFP can afford to pass the savings in production costs to buyers. The BFP may do so by offering discounts to buyers or providing a meal with higher value to buyers.

The MPS entity can collect all offers from all responding BFPs and determine which ones to accept. The MPS entity can decide to accept an offer, for example, based on the value of the meal offered (a meal with a $9.00 value is more likely to be accepted compared to a meal with an $8.00 value), the reputation of the BFP (a meal provided by a famous restaurant chain is more likely to be accepted compared with that of an ordinary restaurant) or the location of a BFP. The location of a BFP can be very important in deciding if its offer is to be accepted. For example, if a BFP is located near other BFPs, the MPS entity may find it easier to pick up orders from it. On the other hand, if a BFP is located at a stand-along and distant location, it may be too costly for the MPS entity to pick up orders from it. A MPS entity can group BFPs by distance. Close-by BFPs can be grouped together and orders can be sent to these BFPs on a priority basis to save operation costs.

In Embodiment A, a MPS entity opens a meal plan for buyers to place orders before it determine the providers of the meals in the meal plan. There can be more than one meal in a meal plan for each day so that a buyer has more selection. However, too many individual meals in a plan in a day mean that the quantity of each meal produced by a BFP in a day may be reduced. This will cause a BFP to lose the advantage of batch production. To balance these two factors, the MPS entity can list a determined but limited number of meals in a meal plan so that a BFP can receive an order large enough for batch production and at the same time give its customers a better selection.

In another embodiment, referred to herein as Embodiment B, a meal plan can be operated as follows. The MPS entity can send out production requests for meals before the plan is opened to buyers to order. A MPS staff can set up requirements in the requests. For example, the requirements can be: that the meal requested is a prime rib dinner, priced at $7.50 and with a delivery date of July 12^{th}. A BFP can answer a request according to its requirements. Each order from the one or more buyers can comprise a minimum number of days during which meals are to be picked up, and the meals available to buyers on different days can be produced by different BFP's.

As an option in this embodiment, a detailed specification can be sent along with a request to produce a meal. For example, for a Prime Rib meal, the specification can include the weight of the meat, the grade of the meat, and its side dish, etc. A specification defines the contents of a meal.

In the embodiment, the MPS entity can decide to give a BFP freedom in producing an item. In doing so, the MPS entity can set up limited number of requirements. For example, the MPS can set up only one requirement, such as the price of the meal. Assuming the MPS sets the price of the meal at $7.50 and this is the only requirement for the meal, a participating BFP can answer the request with any meal item it selects to produce with a value of $7.50 or more. A value of a meal is the price a BFP normally sells for the meal. An exemplary meal can be a Roast Beef Dinner the BFP regularly sells for $8.00. In one option in the embodiment, the MPS entity can send a production request with delivery dates open. In this case, a BFP can answer the request with a delivery date the BFP selects. The MPS service can set no requirement at all. If no requirement is set, a BFP can answer a request with a delivery date the BFP selects. In these cases, a BFP is given the freedom to decide what to produce without restrictions from the MPS entity.

A BFP can achieve maximum production efficiency if it has the freedom to decide what to produce and/or when to produce it. For example, the BFP can look into its inventory and decide to produce a meal using overstocked inventory. Alternatively, the BFP can choose to produce a meal that the BFP is most capable of producing. A requirement can be very broad so that under this requirement a BFP has options to select the meal to produce. For example, a requirement can be any meal with beef. Under such a requirement, a BFP can have many options, such as a roast beef sandwich, a beef taco or a Kong-Pao beef, to select from The MPS entity can also add other detailed requirements, such as the style of the food, e.g. Italian food, the ingredients, and/or certain nutritional values.

An interested BFP answers the request with a proposal. The proposal offers to provide a meal or a number of meals. The MPS entity collects all proposals from all participating BFPs. The MPS entity may publish these proposals while the program is open so that a BFP can use this information to decide if it wants to provide a meal having a higher value to out-bid the other participating BFPs.

The MPS entity can collect all proposals after the program is closed. The MPS entity then determines which proposal to accept. The MPS entity can decide to accept a proposal based, for example, on: the value of the meal proposed (a meal with a $9.00 value is more likely to be accepted compared to a meal with $8.00 value), the reputation of the producing BFP (a meal provided by a famous restaurant chain is more likely to be accepted compared with that of an ordinary restaurant), the location of the BFP, the relative location of the BFP to other BFPs, and the production capacity of the BFP. The location of a BFP can be very important in deciding if its proposal is accepted. For example, if a BFP is located near other BFPs, the MPS entity may find it easier to pick up orders from it. On the other hand, if a BFP is located at a distance and stands alone, it may be too costly for the MPS entity to pick up orders from it. A MPS entity can group together BFPs located near each other and can accept proposals from these BFPs on a priority basis to save operation costs.

In the embodiment, meals in an accepted proposal are listed in a meal plan for buyers' selection. The MPS entity can use the meal(es) in the accepted proposals to fill the menu of the plan. Once all meals for all the days in a plan are finalized, the plan is published for buyers to order.

Preferably, meals in a meal plan cannot be changed by individual buyers. A meal plan can also be sold with a minimum number of participating days. For example, the MPS entity can require a buyer to purchase at least seven days of meals to be offered the chance to participate in a meal plan.

If multiple meals are listed in a plan for a day, a buyer can be allowed to select the meal he/she wants for each day in the plan. The MPS server can use the buyer's preferences or health information to screen the meals in the plan and construct a recommended plan for the buyer. The ASM method discussed previously can be used to construct a buyer's personal meal plan.

The MPS entity needs efficiency in picking up orders from these producing restaurants (BFPs). This is because a MPS truck may need to go to a number of places to pick up orders and there is a limited amount of time in a day a MPS truck can travel to different restaurants (BFPs) to pick up orders. In one embodiment, the MPS entity uses the following method to group BFPs to increase pickup efficiency. In this method, the MPS entity groups BFPs into groups and assigns orders to (or accepts proposals from) the BPF groups one group at a time. (a similar method is described above in Section IX). The MPS entity first determines the criteria for grouping BFPs. The MPS entity can use the “closeness” of BFPs as a criteria to group BFPs, for example. In this case, the MPS entity determines the meaning of “closeness”. “Closeness” may be defined by a distance, e.g. within ¼ miles. In this case, a group of BFPs that are located within ¼ miles to each other or with respect to a particular location are grouped together. In another example, the MPS entity may select a reference point and group all BFPs within a certain distance (e.g. ¼ mile) from the selected reference point. Alternatively, BFPs that are equally convenient to the MPS entity to pickup orders may be grouped together. For example, BFPs that are located in a shopping center or located within a determined number of blocks may be grouped in one group. It is very common to see different restaurants clustered in one location, e.g. a shopping center, to form a food court. If a cluster of restaurants, for example, containing an American restaurant, a Japanese restaurant, a French restaurant and a Chinese restaurant, is within the pickup distance of a MPS central kitchen, the MPS staff can then select American food, Japanese food and French food in a meal plan and have no problem picking up these orders. If a Mexican restaurant is too far away from the cluster, the MPS staff will not select Mexican food in the meal plan at the same time if the travel time between the cluster and the Mexican restaurant is too long and/or if the additional transportation costs are too high.

The operation of picking up orders from BFPs is limited by many constraints. For example, a MPS truck has to arrive at a BFP by Order Due Time of the BFP to pick up orders. The MPS operator needs time to load the orders produced by the BFP to the MPS truck. The MPS truck needs to travel to the next several BFPs to pick up orders. Finally, the MPS truck has to come back to a location where it is parked when not in use, such as a MPS warehouse, e.g. before Order to Warehouse (O2W) time. Because of these constraints, the MPS entity preferably plans a pickup route. A MPS truck then follows the pickup route and pick up orders only from BFPs that are included in the route. In this way, the MPS truck can pick up orders from these BFPs and go back to the MPS warehouse or other location on time. In one embodiment, the MPS entity uses the following method to achieve this goal. The MPS entity first selects a BFP (BFP₁). The MPS entity starts its pickup operation from BFP₁ The MPS entity dispatches a truck to BFP₁ to pick up orders. The truck has to arrive at BFP₁ by Order Due Time. The MPS then selects the next BFP (BFP₂) to pick up orders. The MPS entity calculates the time of traveling from BFP₁ to BFP₂, the loading time at BFP₂ and the time of traveling from BFP₂ to the warehouse. Taking all these time into consideration, if the MPS truck can still be back to the warehouse by the O2W time (Order to Warehouse time, as defined earlier), the MPS entity can group BFP₂ with BFP₁. BFP₁ and BFP₂ can be included in a pickup route. The MPS entity then selects another BFP (BFP₃) and does the same test. If the MPS truck can still be back to the MPS warehouse by O2W time with BFP₃ included in the pickup route, the MPS entity can group BFP₃ with BFP₂ and BFP₁ together. BFP₁, BFP₂ and BFP₃ can be grouped in a pickup route. If the MPS truck cannot travel back to the MPS warehouse by O2W time with BFP₃ included in the picking up route, BFP₃ cannot be grouped with BFP₂ and BFP₁ as a pickup route. The MPS entity does this test to other BFPs. If no other BFP can be grouped with BFP₁ and BFP₂ by using the above test, the MPS entity can only group BFP₁ and BFP₂ in a pickup route. The MPS entity can use this method to group other BFPs. The MPS entity preferably groups as many groups as possible. The entity may select a BFP such as BFP₁ to start order pickup operation, e.g., for one or more of the following reasons: A) the BFP is the closet BFP to the MPS warehouse or B) the BFP has the earliest Order Due Time. By using this method, the MPS entity can send a truck to all BFPs in a group to pick up all orders and go back to the MPS warehouse on time.

Once BFPs are grouped, orders are preferably passed to these grouped BFPs first. The BFPs that can't be grouped will receive orders later. Once orders are passed to BFP groups, orders can be passed one BFP group at a time. That is, orders are passed to a BFP group until the production capacity of the BFPs in the group are full. As an example, the MPS entity may decide that it will assign the production of orders to BFP Group 1 first and then to BFP Group 2 and then to Group 3, etc. Assuming that each group contains a Chinese restaurant, an American restaurant and a Mexican restaurant, and also assuming that the production capacity of each restaurant is 200 meals, if on July 12, the MPS entity needs to produce 500 Chinese meals, 400 American meals and 150 Mexican meals, then following the assignment rule, the MPS entity will assign the first 200 Chinese meals to the Chinese restaurant in group 1, the second 200 Chinese meals to the Chinese restaurant in group 2 and the last 100 Chinese meals to the Chinese restaurant in group 3. The MPS entity will assign the first 200 American meals to the American restaurant in group 1 the next 200 American meals to the American restaurant in group 2. The MPS entity will assign all the 150 Mexican meals to the Mexican restaurant in group 1.

The MPS can also establish alternative criteria to determine the priority of assigning production to BFP groups. One of the criteria is the convenience of reaching a BFP group from a MPS warehouse. For example, under this criterion, the BFP group that is the nearest to a MPS warehouse is assigned for production first. The second nearest BFP group to the warehouse is assigned for production next. In this way, the MPS entity can reach the maximum efficiency in picking up orders.

Similarly, production proposals can be accepted from, as in Embodiment B, one BFP group at a time. Production proposals are accepted from a BFP group in this embodiment until the production capacity of the BFPs in the group are full. Similar to the above example, production proposals are accepted from BFP Group 1 first and then to BFP Group 2 and then to group 3, etc.

Because it is costly for a MPS entity to pick up an order from a BFP, a MPS entity may find it necessary to establish a “minimum production order” to justify pickup costs. A “minimum production order” is the least number of units (meals) a supplier (e.g. a BFP) has to produce (or sell through MPS entity) in order for a MPS entity to pick up and justify its costs. A “minimum production order” can be determined by factors such as transportation costs incurred for traveling from a MPS warehouse to a BFP (or, transportation costs incurred for traveling from one BFP to another BFP), and the revenue the MPS entity receives out of delivering these orders. A “minimum production order” can be expressed in dollar terms. For example, the transportation cost for a truck to travel from a warehouse to a BFP is $24.00 and the MPS entity receives 30% commission from the BFP for the sales it generates for the BFP, the minimum production order can be $60.00 ($24.00/0.30=$60.00). Different BFPs can be subject to different “minimum production orders.” To simplify the process of planning of meal plans, a MPS entity may set up a uniform “minimum production order” for all participating BFPs. An offer from a BFP can be accepted only when the quantity the BFP proposes to produce is at least the minimum production quantity. A uniform minimum production order can be computed as follows. The MPS entity can determine the transportation costs associated with picking up orders from a group of BFPs. The transportation costs can include driver salaries, projected fuel costs, insurance and truck depreciation/leasing costs (which may be, for example, $900 per day). The MPS entity then determines the number of BFPs it plans to recruit for production (for example, 25 BFPs). The uniform minimum production order then is $900/25/30%=$120, where 30% is the commission rate charged to a BFP for an order generated and delivered by the MPS service.

In order to simplify the operation of picking up orders from BFPs, a MPS entity can determine a production quantity. A BFP can be required to provide a meal with a quantity which is the production quantity determined by the MPS entity. This embodiment allows the MPS entity to pick up orders from a BFP more efficiently.

The following is an option of how “production quantity” works. In the embodiment, the MPS entity provides racks to BFPs to store orders produced. The racks are preferably mobile. The MPS entity can leave an empty rack to a BFP and the BFP can load orders to the empty rack after the orders are completed. When the MPS staff picks up orders from the BFP, the MPS staff can push away the loaded rack and leave an empty rack for the BFP. In this way, the loading of a BFP's product onto a MPS truck can be facilitated. A MPS entity can use commercially available racks without the need to design and produce its own racks. A production quantity may be determined by the storage quantity of such a rack. For example, if a commercially available rack that the MPS entity decided to use can house 125 orders, the MPS entity may set the production quantity at 125 order units. The MPS entity then requires a BFP to product a meal in such a quantity. Here, all individual meals are preferably packaged in a uniform package with a uniform dimension. The advantage of the method is: it would be easier for a MPS entity to pick up orders and there would be no wasted space in a pickup truck.

A production quantity may be determined by the maximum production capacity of a BFP, the carrying capacity of a MPS pickup truck and the number of BFPs the truck can travel to within the limitations of pickup times. Assuming that the carrying capacity of a MPS truck is 450 orders and the maximum production capacity of a BPF is 200 orders, a MPS truck can be arranged to go to three BFPs to pickup orders for better efficiency. This is because if a MPS truck goes to one or two BFPs to pick up orders, a BFP would be forced to produce a quantity of orders that exceeds its production capacity. At the same time, because of the time limitations applied to a MPS truck for picking up orders, a MPS truck may not have time to go to four different BFPs to pickup orders. In this example, three BFPs is the number of BFPs a MPS truck can travel to pick up orders with the best efficiency. In this case, the production quantity for a BFP may be determined as 150 (450/3=150).

A BFP can be allowed to produce a meal in increments of the predetermined production quantity. That is, a BFP can be allowed to produce a meal in one, two or three predetermined quantity units. For example, if the production quantity is 125 orders, a BFP may be allowed to produce 250 orders for a meal. In this case, a BFP needs two racks to house the orders produced. A MPS entity may design a rack in a dimension that is conformed to the dimension of a delivering truck. Or, the MPS entity may design a truck in a dimension that is conformed to the dimension of a rack. These designs will allow racks to fit in to a delivery truck.

In one embodiment, the MPS can assign each BFP only one meal to produce in a day. In this way, a BFP can enjoy the benefit of batch production and ease of packaging.

The MPS entity can also determine the contents of the meals to be listed for each day in a meal plan. For example, if the MPS entity determines that the number of meals to be listed on July 12^{th} is three, the MPS entity can then determine these three meals in the plan to be, for example, lemon chicken, a sushi plate and seafood pasta. In Embodiment B, after the meals for all the days in the plan are determined, the meal plan is presented to buyers to purchase. The MPS can disclose the providers of the meals in the plan and the regular selling price of the meals. For example, the MPS entity can display in the plan that the lemon chicken meal of July 12^{th} is provided by BFP A with a regular selling price of $8.00. A meal provided by a BFP in a plan is preferably a meal regularly sold by the BFP. The BFP can be asked to provide the regular selling price of a meal when it submits the meal for evaluating, i.e., the selling price offered by the BFP for the meal at a restaurant or other physical location, or offered through a service other than that offered by the MPS entity. If the meal submitted is accepted by the MPS entity, the MPS entity can publish the pricing information of the meal so that a buyer can know how much he/she saves by purchasing the meal through the meal program.

Having thus described several exemplary implementations of the invention, it will be apparent that various alterations and modifications can be made without departing from the inventions or the concepts discussed herein. Such operations and modifications, though not expressly described above, are nonetheless intended and implied to be within the spirit and the scope of the inventions. Accordingly, the foregoing description is intended to be illustrative only and while the present invention has been described in regard to particular embodiments, it is recognized that additional variations of the present invention may be devised without departing from the inventive concept.

What I claim is:

1. A method for scheduling and delivering a product to a buyer, comprising:
(a) receiving an order for a product from a buyer;
(b) transmitting the order to a seller for production of the product;
(c) receiving the product from the seller;
(d) determining a plurality of pickup locations;
(e) receiving a delivery area identifier from the buyer;
(f) employing the delivery area identifier to select a pickup location for the buyer from among the plurality of pickup locations;
(g) loading the product onto a mobile pick up station;
(h) dispatching the mobile pickup station to the selected pickup location, the mobile pickup station containing the product ordered by the buyer; and
(i) stationing the mobile pick up station at the pickup location for a predetermined station time during which the buyer can pick up the order from the mobile pick up station, wherein the station time starts at a predetermined starting time and ends at a predetermined ending time, whereby the buyer can pick up the order from the mobile pick up station.

2. The method of claim 1, wherein the station time is determined by:
selecting a period of time;
determining a number of potential buyers passing by the pickup location during the selected period of time; and
determining whether the cost of stationing the mobile pick up station at the pickup location during the period of time exceeds the amount of profit that can be made by providing products to buyers during the period of time, wherein the period of time is excluded from the station time at the pickup location if the cost of stationing a mobile pick up station during the period of time exceeds the amount of profit that can be made by providing products to buyers during the period of time.

3. The method of claim 1 wherein the station time is determined by:
determining a number of potential buyers passing by the pickup location during the selected period of time; and
determining the carrying capacity of the mobile pick up station, wherein if the number of customers that are projected to arrive at the pickup location to pick up orders during the period of time is less than the carrying capacity of the mobile pick up station, then the selected period of time is included in the station time.

4. The method of claim 1 wherein the station time is determined by:
selecting a period of time;
determining a number of potential buyers passing by the pickup location during the selected period of time;
using the number of potential buyers to determine a projected number of orders for products that will be picked up during the period of time; and
determining whether the cost of stationing the mobile pick up station at the pickup location during the period of time exceeds the amount of profit that can be made by providing the orders to buyers during the period of time, wherein the period of time is excluded from the station time at the pickup location if the cost of stationing a mobile pick up station during the period of time exceeds the amount of profit that can be made by providing the orders to buyers during the period of time.

5. The method of claim 1, further comprising:
receiving from the buyer a delivery date that the buyer wants to obtain the product;
receiving from the buyer a specification of the buyer's preferred product;
using the delivery date and the specification to select the product for the buyer for the date the buyer wants to obtain the product; and
delivering the product to the buyer on the delivery date.

6. The method of claim 1, wherein the product is a perishable food product, further comprising the step of delivering the product without receiving a tip.

7. The method of claim 1, wherein the product is a perishable food product, further comprising the step of receiving compensation for the delivery of the product, wherein the compensation provided to delivery personnel is derived only from the seller of the product directly and not from the buyer.

8. The method of claim 1, wherein the product is a perishable food product and wherein a plurality of products are available to be ordered by the buyer, the plurality of products comprising a least-priced product, further comprising the step of delivering the least-priced food product.

9. The method of claim 1, further comprising the steps of:
attaching a shipping label to the order, wherein the shipping label includes information identifying the buyer;
loading the order to a cell in the mobile pick up station, the cell being identified by a cell address;
relaying the information on the shipping label and the cell address;
and retrieving the order from the mobile pick up station according to the cell address.

10. The method of claim 9, wherein the information comprises a license plate number.

11. The method of claim 9, wherein the product comprises perishable food in a container, further comprising the steps of:
placing a piece of liquid absorbing material on top of the food in the container, the material being food grade and pre-soaked with liquid; and
sealing the container with the material inside the container.

12. The method of claim 1, wherein selecting the pick up location for a buyer to use further comprises:
determining parking availability at each of a group of pickup locations;
determining a volume of the packaging of the order;
determining a pickup location from the group of pickup locations according to the parking availability of a pickup location and the package volume of the buyer's order.

13. The method of claim 1, wherein selecting the pick up location further comprises:
receiving the buyer's home address;
determining highways around the buyer's home;
identifying exits on the highways;
determining a plurality of routes that connects the exits with the buyer's home address;
selecting the shortest route from the plurality of routes;
identifying the exit with the shortest route;
identifying the area between the exit and the buyer's home address; and
selecting a pickup location within the area.

14. The method of claim 1 wherein the buyer is a member of a group identified by a group code, and wherein selecting the pick up location further comprises:
identifying the buyer's group code;
identifying other group members having the same group code;
changing the other group members' pickup locations to the buyer's pickup location;
delivering the group members' orders to the buyer's pickup location; and
authorizing the buyer to pick up the group members' orders.

15. The method of claim 1, further comprising the steps of:
selecting a plurality of pickup locations;
grouping the plurality of pickup locations according to the area of the pickup locations;
selecting a first pick up location in a group for the buyer to use;
opening a second pickup location in the group for a second buyer to use when the carrying capacity of the first pickup location is full.

16. The method of claim 1, further comprising:
selecting a plurality of food providers;
determining criteria for placing the food providers into groups;
grouping the food providers according to the criteria;
receiving an order from the buyer;
determining those food providers having the ability to produce the order;
passing the order to a food in the group; and
passing the order to a food provider not in the group only if a food provider in the group cannot produce the order.

17. A method of procuring food from one or more food providers for delivery to one or more buyers at a pickup location, comprising:
(a) providing a list of meals to the one or more buyers for a period of time;
(b) receiving one or more orders from the one or more buyers within the period of time, wherein each order comprises a selection of one or more meals, a delivery date for each of the meals, and a pickup location for each delivery date;
(c) determining a total of the orders placed by the one or more buyers for each of the meals for each delivery date;
(d) sending a request to each of the one or more food providers for an offer to fulfill some or all of the orders placed by the one or more buyers, wherein the offer specifies the orders that the food provider is willing to fulfill and a price for fulfilling said orders;
(e) receiving one or more offers;
(f) accepting one or more of the offers based on criteria including one or more of the following: the price offered by the food provider, the reputation of the food provider, the value of the food provided by the food provider, and the location of the food provider, wherein accepted offers are from a selected group of the one or more food providers;
(g) picking up meals from the selected group of one or more food providers on the delivery date;
(h) delivering the meals with a vehicle to the pickup location on the delivery date; and
(i) stationing the vehicle at the pickup location for a period of time to allow buyers to pick up ordered meals.

18. The method of claim 17, wherein the meals are provided by a single food provider.

19. The method of claim 17, wherein the request comprises one or more requirements, and wherein an offer must meet the requirements in order to be accepted.

20. The method of claim 19, wherein the one or more requirements comprises a maximum price for each meal.

21. The method of claim 17, wherein each meal in the list of meals for one or more delivery dates comprises a common reference attribute.

22. The method of claim 21, wherein the reference attribute is selected from the group consisting of a price, an ingredient, a geographic origin of the meal, and a flavor.

23. The method of claim 17, wherein the meals are grouped into groups of meals, and wherein each meal in at least one of the groups of meals is offered to the buyers at the same price.

24. The method of claim 17, wherein the meals are grouped based on criteria selected from the group consisting of number of calories, number of fat calories, number of carbohydrate calories, and price.

25. The method of claim 17, wherein the list of dishes is provided on a website and wherein one or more of the orders are placed by buyers through the website.

26. The method of claim 17, wherein steps (a) and (b) comprise providing a website, wherein the website the list of dishes from each of the food providers, the website further comprising means for selecting the one or more meals and communicating a selection of the meals.

27. The method of claim 17, wherein at least one of the one or more orders comprises a plurality of pickup dates.

28. The method of claim 27, wherein the plurality of pickup dates includes more than one pickup time on the same day.

29. A method of procuring food for delivery to one or more buyers at a pickup location, comprising:
(a) sending a request to one or more food providers for an offer to produce meals, wherein the request comprises requirements which must be fulfilled in order for the offer to be accepted, the requirements comprising an identification of the meals to be produced, a quantity of the meals to be produced, and one or more delivery dates;
(b) receiving one or more offers from the one or more food providers to produce the meals pursuant to the requirements in the request;
(c) accepting one or more of the offers based on criteria selected including one or more of the following: price, reputation of a food provider, value of the food provided by a food provider, and location of a food provider, wherein accepted offers are from a selected group of the one or more food providers;
(d) providing a list of the meals included in the accepted offers to one or more buyers for a period of time;
(e) receiving one or more orders from the one or more buyers, wherein each order comprises a selection of one or more of the meals, a quantity of each of the meals, a pickup date for each of the meals, and a pickup location for each delivery date;
(f) forwarding the orders to the selected group of food providers;
(g) picking up ordered meals from the selected group of food providers on the delivery date;
(h) delivering the meals to the pickup location by a vehicle on the delivery date; and
(i) stationing the vehicle at the pickup location for a period of time waiting for buyers to pickup orders.

30. The method of claim 29, wherein the requirements further comprise a maximum price for producing one or more of the dishes.

31. The method of claim 29, wherein the requirements further comprise a minimum quantity of the dishes to be produced by a food provider.

32. The method of claim 29, wherein each order from the one or more buyers comprises a minimum number of days during which food is to be picked up.

33. The method of claim 29, wherein the meals available to the one or more buyers on different days and are produced by different food providers.
